(19) United States
(12) Patent Application Publication
(10) Pub. No.: US 2025/0287444 A1
(43) Pub. Date: Sep. 11, 2025

(54) PROVISIONING LINK RESOURCES OF A MULTI-LINK DEVICE

(71) Applicant: QUALCOMM Incorporated, San Diego, CA (US)

(72) Inventors: Nicholas KUCHAREWSKI, San Jose, CA (US); Sandip HOMCHAUDHURI, San Jose, CA (US); John Thomas HARRSEN, San Jose, CA (US); Harinder SINGH, Saratoga, CA (US); Xiaolong HUANG, Santee, CA (US); Manish SHUKLA, Milpitas, CA (US); Jyothirmayi CHUKKAPALLI, Bangalore (IN)

(21) Appl. No.: 18/859,520

(22) PCT Filed: May 17, 2023
(86) PCT No.: PCT/US2023/022513

§ 371 Date: Oct. 23, 2024

(30) Foreign Application Priority Data
Jun. 6, 2022 (IN) 202241032285

(51) Int. Cl. H04W 76/15; H04W 28/02

(52) U.S. Cl. CPC H04W 76/15; H04W 28/0236

(57) ABSTRACT

This disclosure provides systems and methods for provisioning resources in a wireless network. In some implementations, an apparatus obtains, from a first station (STA) on a first communication link associated with an access point (AP) multi-link device (MLD), a request for association all communication links of the AP MLD, and provisions either a single communication link or multiple communication links of the AP MLD for communications with the first STA based on at least one of a latency, a level of interference, or a traffic load associated with each of the communication links of the AP MLD. The apparatus generates a frame indicating whether the single communication link or the multiple communication links of the AP MLD are provisioned to the first STA for communications with the AP MLD, and outputs the frame for transmission to the first STA.

### CROSS REFERENCES

The present Application is a 371 national stage filing of International PCT Application No. PCT/US2023/022513 by KUCHAREWSKI et al. entitled “PROVISIONING LINK RESOURCES OF A MULTI-LINK DEVICE,” filed May 17, 2023; and claims priority to Indian Patent Application No. 202241032285 by KUCHAREWSKI et al., entitled “PROVISIONING LINK RESOURCES OF A MULTI-LINK DEVICE,” filed Jun. 6, 2022, each of which is assigned to the assignee hereof, and each of which is expressly incorporated by reference in its entirety herein.

### TECHNICAL FIELD

This disclosure relates generally to wireless communication, and more specifically, to selectively provisioning the communication links of an apparatus to one or more clients associated with the apparatus.

### DESCRIPTION OF THE RELATED TECHNOLOGY

A wireless local area network (WLAN) may be formed by one or more access points (APs) that provide a shared wireless medium for use by a number of client devices such as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP in beacon frames periodically broadcasted over the wireless medium so that STAs within wireless range of the AP can associate with the AP. An AP multi-link device (MLD) may include a plurality of APs that can independently operate on a plurality of respective communication links. Each AP can establish a BSS on a respective communication link, and wireless communication devices associated with the AP MLD can transmit data to or receive data from the AP MLD on one or more of the communication links associated with the AP MLD.

Some wireless communication devices may be associated with low-latency applications having strict end-to-end latency, throughput, and timing requirements for data traffic. Example low-latency applications include, but are not limited to, real-time gaming applications, video communications, and augmented reality (AR) and virtual reality (VR) applications (collectively referred to as extended reality (XR) applications). Such low-latency applications may specify various latency, throughput, and timing requirements for wireless communication systems that provide connectivity for these applications. Thus, it is desirable to ensure that WLANs that include MHLDs are able to meet the various latency, throughput, and timing requirements of such low-latency applications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure can be implemented as an apparatus for wireless communications. The apparatus may include a processing system and an interface. In some implementations, the interface is configured to obtain, from a first station (STA) on a first communication link associated with an access point (AP) multi-link device (MLD), a request for association with the AP MLD on the first communication link and on each of one or more second communication links of the AP MLD. The processing system is configured to provision either a single communication link or multiple communication links of the AP MLD for communications between the first STA and the AP MLD based on at least one of a latency, a level of interference, or a traffic load associated with each of the first communication link and the one or more second communication links of the AP MLD. The processing system is configured to generate a first frame indicating whether the single communication link or the multiple communication links of the AP MLD are provisioned to the first STA for communications with the AP MLD. The interface is further configured to output the first frame for transmission to the first STA on the first communication link.

In various implementations, the first communication link is associated with a first AP of the AP MLD, the one or more second communication links are associated with one or more respective second APs of the AP MLD, and the first STA is associated with a STA MLD including one or more second STAs associated with the one or more respective second communication links of the AP MLD. In some instances, the first frame also indicates whether the single communication link or the multiple communication links of the AP MLD are provisioned to the one or more second STAs of the STA MLD for communications with the AP MLD. In some other instances, the first frame includes a Traffic Identifier (TID)-to-Link Mapping (T2LM) element indicating, for each TID of a plurality of TIDs, one or more communication links of the AP MLD allocated for traffic associated with the respective TID. In some aspects, the request is obtained via a multi-link association request frame or a multi-link probe request frame, and the first frame is a multi-link association response frame responsive to the multi-link association request frame or a multi-link probe response frame responsive to the multi-link probe request frame.

In some implementations, the first frame indicates that the single communication link of the AP MLD is provisioned to the first STA for communications with the AP MLD, the interface is further configured to obtain one or more TIDs associated with traffic flows transmitted to or received from the first STA, and the processing system is further configured to map the one or more TIDs to only the provisioned single communication link of the AP MLD. In some aspects, the interface is further configured to obtain a first indication of at least one of the latency, the level of interference, or the traffic load associated with the provisioned single communication link being at least equal to a respective latency threshold, interference threshold, or traffic load threshold, and the processing system is further configured to switch communications between the first STA and the AP MLD from the provisioned single communication link of the AP MLD to another single communication link of the AP MLD based on the first indication. In some instances, switching the communications includes re-mapping the one or more TIDs from the provisioned single communication link of the AP MLD to the other single communication link of the AP MLD. In some aspects, the processing system is further configured to generate a second frame including a T2LM element indicating the re-mapping of the one or more TIDs from the provisioned single communication link of the AP MLD to the other single communication link of the AP MLD, and the interface is further configured to output the second frame for transmission to the first STA on the provisioned single communication link.

In other instances, the interface is further configured to obtain a second indication of at least one of the latency, the level of interference, or the traffic load associated with the other single communication link being at least equal to the respective latency threshold, interference threshold, or traffic load threshold, and the processing system is further configured to switch communications between the first STA and the AP MLD from the other single communication link of the AP MLD to all communication links of the AP MLD based on the second indication. In some instances, switching the communications includes re-mapping the one or more TIDs from the other single communication link of the AP MLD to all of the communication links of the AP MLD. In some aspects, the processing system is further configured to generate a third frame including a T2LM element indicating the re-mapping of the one or more TIDs from the other single communication link of the AP MLD to all of the communication links of the AP MLD, and the interface is further configured to output the third frame for transmission to the first STA on the other single communication link.

In other implementations, the first frame indicates that the multiple communication links of the AP MLD are provisioned to the first STA for communications with the AP MLD, the interface is further configured to obtain one or more TIDs associated with traffic flows transmitted to or received from the first STA, and the processing system is further configured to map the one or more TIDs to only the provisioned multiple communication links of the AP MLD. In various aspects, the interface is further configured to obtain an indication of at least one of the latency, the level of interference, or the traffic load associated with one or more of the provisioned multiple communication links being at least equal to the respective latency threshold, interference threshold, or traffic load threshold, and the processing system is further configured to switch communications between the first STA and the AP MLD from the provisioned multiple communication links of the AP MLD to a single communication link of the AP MLD based on the indication. In some instances, switching the communications includes re-mapping the one or more TIDs from the provisioned multiple communication links of the AP MLD to the single communication link of the AP MLD. In some aspects, the processing system is further configured to generate a second frame including a T2LM element indicating the re-mapping of the one or more TIDs from the provisioned multiple communication links of the AP MLD to the single communication link of the AP MLD, and the interface is further configured to output the second frame for transmission to the first STA on at least one of the provisioned multiple communication links.

In various implementations, the processing system is further configured to reserve one communication link of the first communication link or the one or more second communication links of the AP MLD for latency-sensitive traffic, and to maintain the latency, the level of interference, and the traffic load associated with the reserved communication link below the respective latency threshold, interference threshold, and the traffic load threshold. In some instances, the interface is further configured to obtain an indication of at least one of the latency, the level of interference, or the traffic load associated with the reserved communication link being at least equal to the respective latency threshold, interference threshold, or traffic load threshold, and the processing system is further configured to switch communications between the AP MLD and one or more other STAs from the reserved communication link to one or more other communication links of the AP MLD based on the indication. In some aspects, the interface is further configured to obtain one or more service level agreement (SLA) parameters associated with the first STA, where the provision of either the single communication link or the multiple communication links of the AP MLD is further based on the one or more SLA parameters associated with the first STA.

Another innovative aspect of the subject matter described in this disclosure can be implemented as a method for wireless communications. In various implementations, the method may be performed by an AP MLD. In some implementations, the method includes obtaining, from a first STA on a first communication link of the AP MLD, a request for association with the AP MLD on the first communication link and on each of one or more second communication links; provisioning either a single communication link or multiple communication links of the AP MLD for communications between the first STA and the AP MLD based on at least one of a latency, a level of interference, or a traffic load associated with each of the first communication link and the one or more second communication links of the AP MLD; generating a first frame indicating whether the single communication link or the multiple communication links of the AP MLD are provisioned to the first STA for communications with the AP MLD, and outputting the first frame for transmission to the first STA on the first communication link.

In some implementations, the first communication link is associated with a first AP of the AP MLD, the one or more second communication links are associated with one or more respective second APs of the AP MLD, and the first STA is associated with a STA MLD including one or more second STAs associated with the one or more respective second communication links of the AP MLD. In some instances, the first frame further indicates whether the single communication link or the multiple communication links of the AP MLD are provisioned to the one or more second STAs of the STA MLD for communications with the AP MLD. In some other instances, the first frame includes a T2LM element indicating, for each TID of a plurality of TIDs, one or more communication links of the AP MLD allocated for traffic associated with the respective TID. In some aspects, the request is obtained via a multi-link association request frame or a multi-link probe request frame, and the first frame is a multi-link association response frame responsive to the multi-link association request frame or a multi-link probe response frame responsive to the multi-link probe request frame.

In some implementations, the first frame indicates that the single communication link of the AP MLD is provisioned to the first STA for communications with the AP MLD, and the method also includes obtaining one or more TIDs associated with traffic flows transmitted to or received from the first STA, and the mapping the one or more TIDs to only the provisioned single communication link of the AP MLD. In some aspects, the method also includes obtaining a first indication of at least one of the latency, the level of interference, or the traffic load associated with the provisioned single communication link being at least equal to a respective latency threshold, interference threshold, or traffic load threshold, and switching communications between the first STA and the AP MLD from the provisioned single communication link of the AP MLD to another single communication link of the AP MLD based on the first indication. In some instances, switching the communications includes re-mapping the one or more TIDs from the provisioned single communication link of the AP MLD to the other single communication link of the AP MILD. In some aspects, the method also includes generating a second frame including a T2LM element indicating the re-mapping of the one or more TIDs from the provisioned single communication link of the AP MILD to the other single communication link of the AP MLD, and outputting the second frame for transmission to the first STA on the provisioned single communication link.

In other instances, the method also includes obtaining a second indication of at least one of the latency, the level of interference, or the traffic load associated with the other single communication link being at least equal to the respective latency threshold, interference threshold, or traffic load threshold, and switching communications between the first STA and the AP MLD from the other single communication link of the AP MLD to all communication links of the AP MLD based on the second indication. In some aspects, switching the communications includes re-mapping the one or more TIDs from the other single communication link of the AP MLD to all of the communication links of the AP MLD, and the method also includes outputting a third frame for transmission to the first STA on the other single communication link, the third frame including a T2LM element indicating the re-mapping of the one or more TIDs from the other single communication link of the AP MLD to all of the communication links of the AP MLD.

In other implementations, the first frame indicates that the multiple communication links of the AP MLD are provisioned to the first STA for communications with the AP MLD, and the method also includes obtaining one or more TIDs associated with traffic flows transmitted to or received from the first STA, and mapping the one or more TIDs to only the provisioned multiple communication links of the AP MILD. In various aspects, the method also includes obtaining an indication of at least one of the latency, the level of interference, or the traffic load associated with one or more of the provisioned multiple communication links being at least equal to the respective latency threshold, interference threshold, or traffic load threshold, and switching communications between the first STA and the AP MLD from the provisioned multiple communication links of the AP MLD to a single communication link of the AP MLD based on the indication. In some instances, switching the communications includes re-mapping the one or more TIDs from the provisioned multiple communication links of the AP MLD to the single communication link of the AP MLD. In some aspects, the method also includes generating a second frame including a T2LM element indicating the re-mapping of the one or more TIDs from the provisioned multiple communication links of the AP MILD to the single communication link of the AP MLD, and outputting the second frame for transmission to the first STA on at least one of the provisioned multiple communication links.

In various implementations, the method also includes reserving one communication link of the first communication link or the one or more second communication links of the AP MLD for latency-sensitive traffic, and maintaining the latency, the level of interference, and the traffic load associated with the reserved communication link below the respective latency threshold, interference threshold, and the traffic load threshold. In some instances, the latency, the level of interference, and the traffic load are maintained by obtaining an indication of at least one of the latency, the level of interference, or the traffic load associated with the reserved communication link being at least equal to the respective latency threshold, interference threshold, or traffic load threshold, and switching communications between the AP MLD and one or more other STAs from the reserved communication link to one or more other communication links of the AP MLD based on the indication. In some aspects, the method also includes obtaining one or more SLA parameters associated with the first STA, where the provision of either the single communication link or the multiple communication links of the AP MLD is further based on the one or more SLA parameters associated with the first STA.

Another innovative aspect of the subject matter described in this disclosure can be implemented as an apparatus for wireless communications. The apparatus may include a processing system and an interface. In some implementations, the processing system is configured to assign each of a plurality of STAs to one of multiple communication links associated with an AP MLD based at least in part on an amount of traffic on the multiple communication links. The processing system is configured to map one or more TIDs of traffic flows associated with each of the plurality of STAs to the communication link assigned to the respective STA. The processing system is configured to generate, for each STA of the plurality of STAs, a first frame indicating the assigned communication link and the mapping for the respective STA. The interface is configured to output the first frames for transmission to the plurality of STAs on one or more of the multiple communication links.

In some implementations, the first frames include a T2LM element indicating the mappings for the respective plurality of STAs. In some instances, each of the multiple communication links is associated with a respective AP of the AP MLD and occupies one of a 2.4 GHz frequency band, a 5 GHz frequency band, a 6 GHz frequency band, or a 60 GHz frequency band. In some instances, the first frames include a T2LM element indicating the mappings for the respective plurality of STAs.

In various implementations, the interface is further configured to obtain, from each of the plurality of STAs, an indication of support for each of the multiple communication links associated with the AP MLD, where the first frames are output for transmission to the plurality of STAs based on the indications of support. In some instances, the indications of support are obtained via association request frames or probe request frames, and the first frames are multi-link association response frames responsive to the respective association request frames or multi-link probe response frames responsive to the respective probe request frames.

In some implementations, the interface is further configured to obtain a first indication of a traffic load on a first communication link of the multiple communication links being greater than a traffic load on a second communication link of the multiple communication links by at least a threshold amount, and the processing system is further configured to re-assign at least one STA from the first communication link to the second communication link based on the first indication. In some aspects, the first communication link is reserved for latency-sensitive traffic. In some instances, the processing system is further configured to maintain STAs associated with latency-sensitive traffic on the first communication link while switching communications with non-latency-sensitive STAs from the first communication link to the second communication link.

In some other implementations, the interface is further configured to obtain a first indication that a traffic load on at least one of the communication links associated with the AP MLD is at least equal to a load threshold, and the processing system is further configured to provision all of the communication links associated with the AP MLD to at least some of the STAs previously assigned to the at least one communication link based on the first indication. The processing system is further configured to re-map the one or more TIDs associated with the at least some STAs to all of the communication links associated with the AP MLD, and to generate, for each of the at least some STAs, a second frame indicating the re-mapping for the respective STA. The interface is further configured to output the second frames for transmission to the at least some STAs. In some aspects, each of the second frames may be a directed action frame indicating the re-mapping for the respective STA. In other aspects, the interface is further configured to obtain the load threshold from a network entity. In some instances, each of the at least some STAs is associated with at least one of a throughput of the respective STA being less than a first threshold or a load associated with the respective STA being at least equal to a second threshold. In other instances, each of the at least some STAs is associated with a group of STAs based on at least one of a combined throughput or a combined load of the group of STAs.

In some implementations, the interface is further configured to obtain a second indication that the traffic load on each of the communication links associated with the AP MLD is at least equal to the load threshold, and the processing system is further configured to provision all of the communication links associated with the AP MLD to each of the plurality of STAs based on the second indication. In some instances, the processing system is further configured to re-map the one or more TIDs associated with the plurality of STAs to all of the communication links of the AP MLD, and to generate, for each of the plurality of STAs, a second frame indicating the re-mapping for the respective STA. The interface is further configured to output the second frames for transmission to the respective plurality of STAs.

In various implementations, the interface is further configured to obtain an indication of a violation of one or more SLA parameters by at least one STA assigned to a reserved communication link of the multiple communication links, and the processing system is further configured to re-assign one or more other STAs from the reserved communication link to at least one other communication link of the multiple communication links based on the indication. In some aspects, the reserved communication link is associated with latency-sensitive traffic, and the one or more other STAs are not associated with latency-sensitive traffic. In some instances, the processing system is configured to re-assign the one or more other STAs by generating, for each of the one or more other STAs, a second frame indicating a T2LM for the respective other STA, and the interface is further configured to output the second frames for transmission to the one or more other STAs.

Another innovative aspect of the subject matter described in this disclosure can be implemented as a method for wireless communications. In various implementations, the method may be performed by an AP MLD. In some implementations, the method includes assigning each of a STAs to one of multiple communication links of the AP MLD based at least in part on an amount of traffic on the multiple communication links, and mapping one or more TIDs of traffic flows associated with each of the plurality of STAs to the communication link assigned to the respective STA. The method includes generating, for each STA of the plurality of STAs, a first frame indicating the assigned communication link and the mapping for the respective STA, and outputting the first frames for transmission to the plurality of STAs on one or more of the multiple communication links.

In some implementations, the first frames include a T2LM element indicating the mappings for the respective plurality of STAs. In some instances, each of the multiple communication links is associated with a respective AP of the AP MLD and occupies one of a 2.4 GHz frequency band, a 5 GHz frequency band, a 6 GHz frequency band, or a 60 GHz frequency band. In some instances, the first frames include a T2LM element indicating the mappings for the respective plurality of STAs.

In various implementations, the method includes obtaining, from each of the plurality of STAs, an indication of support for each of the multiple communication links associated with the AP MLD, where the first frames are output for transmission to the plurality of STAs based on the indications of support. In some instances, the indications of support are obtained via association request frames or probe request frames, and the first frames are multi-link association response frames responsive to the respective association request frames or multi-link probe response frames responsive to the respective probe request frames.

In some implementations, the method also includes obtaining a first indication of a traffic load on a first communication link of the multiple communication links being greater than a traffic load on a second communication link of the multiple communication links by at least a threshold amount, and re-assigning at least one STA from the first communication link to the second communication link based on the first indication. In some aspects, the first communication link is reserved for latency-sensitive traffic. In some instances, the method also includes maintaining STAs associated with latency-sensitive traffic on the first communication link while switching communications with non-latency-sensitive STAs from the first communication link to the second communication link.

In some other implementations, the method also includes obtaining a first indication that a traffic load on at least one of the communication links associated with the AP MILD is at least equal to a load threshold, and provisioning all of the communication links associated with the AP MLD to at least some of the STAs previously assigned to the at least one communication link based on the first indication. In some instances, the method includes re-mapping the one or more TIDs associated with the at least some STAs to all of the communication links associated with the AP MLD. The method includes generating, for each of the at least some STAs, a second frame indicating the re-mapping for the respective STA. The method includes outputting the second frames for transmission to the at least some STAs. In some aspects, each of the second frames may be a directed action frame indicating the re-mapping for the respective STA. In other aspects, the method also includes obtaining the load threshold from a network entity. In some instances, each of the at least some STAs is associated with at least one of a throughput of the respective STA being less than a first threshold or a load associated with the respective STA being at least equal to a second threshold. In other instances, each of the at least some STAs is associated with a group of STAs based on at least one of a combined throughput or a combined load of the group of STAs.

In some implementations, the method also includes obtaining a second indication that the traffic load on each of the communication links associated with the AP MLD is at least equal to the load threshold, and provisioning all of the communication links associated with the AP MLD to each of the plurality of STAs based on the second indication. In some instances, the method includes re-mapping the one or more TIDs associated with the plurality of STAs to all of the communication links of the AP MLD. The method includes generating, for each of the plurality of STAs, a second frame indicating the re-mapping for the respective STA. The method includes outputting the second frames for transmission to the respective plurality of STAs.

In various implementations, the method also includes obtaining an indication of a violation of one or more SLA parameters by at least one STA assigned to a reserved communication link of the multiple communication links, and re-assigning one or more other STAs from the reserved communication link to at least one other communication link of the multiple communication links based on the indication. In some aspects, the reserved communication link is associated with latency-sensitive traffic, and the one or more other STAs are not associated with latency-sensitive traffic. In some instances, the method also includes generating, for each of the one or more other STAs, a second frame indicating a T2LM for the respective other STA, and outputting the second frames for transmission to the one or more other STAs.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A shows an example protocol data unit (PDU) usable for communications between an access point (AP) and one or more wireless stations (STAs).

FIG. 2B shows an example field in the PDU of FIG. 2A.

FIG. 3 shows an example physical layer convergence protocol (PLCP) protocol data unit (PPDU) usable for communications between an AP and a number of STAs.

FIG. 4 shows a block diagram of an example wireless communication device.

FIG. 5A shows a block diagram of an example access point (AP).

FIG. 5B shows a block diagram of an example station (STA).

FIG. 6 shows an example communication system that includes an access point (AP) multi-link device (MLD) and a non-AP MLD, according to some implementations.

FIG. 7 shows a block diagram of another example wireless communication device, according to some implementations.

FIG. 8 shows a block diagram of an example resource manager suitable for use in wireless communication devices disclosed herein.

FIG. 9 shows a block diagram of an example link telemetry device suitable for use in wireless communication devices disclosed herein.

FIG. 10A shows a sequence diagram depicting an example wireless communication that supports selectively provisioning the communication links associated with an AP MLD to one or more STAs, according to some implementations.

FIG. 10B shows a sequence diagram depicting another example wireless communication that supports selectively provisioning the communication links associated with an AP MLD to one or more STAs, according to some implementations.

FIG. 11 shows a sequence diagram depicting example wireless communications that support selectively assigning one or more STAs to the communication links associated with an AP MLD, according to some implementations.

FIGS. 12-22 show flowcharts illustrating example operations for wireless communications that support selectively provisioning the communication links of an AP MLD to one or more STAs, according to some implementations.

FIGS. 23-30 show flowcharts illustrating example operations for wireless communications that support selectively assigning one or more STAs to the communication links associated with an AP MLD, according to some implementations.

FIG. 31 shows a conceptual data flow diagram illustrating the data flow between different means/components in an example apparatus.

FIG. 32 shows a diagram illustrating an example of a hardware implementation for an apparatus employing a processing system.

FIG. 33A shows an example Multi-Link element usable for multi-link communications.

FIG. 33B shows an example Multi-Link Control field of the Multi-Link element of FIG. 33A.

FIG. 33C shows an example Common Info field of the Multi-Link element of FIG. 33A.

FIG. 33D shows an example MLD Capabilities subfield of the Common Info field of FIG. 33C.

FIG. 33E shows an example Per-STA Profile subelement of the Link Info field of the Multi-Link element of FIG. 33A.

FIG. 33F shows an example STA Control field of the Per-STA Profile subelement of FIG. 33E.

FIG. 33G shows an example STA Info field of the Per-STA Profile subelement of FIG. 33E.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Long Term Evolution (LTE), 3G, 4G or 5G (New Radio (NR)) standards promulgated by the 3rd Generation Partnership Project (3GPP), the Institute of Electrical and Electronics Engineers (IEEE) 802.11 standards, the IEEE 802.15 standards, or the Bluetooth® standards as defined by the Bluetooth Special Interest Group (SIG), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless wide area network (WWAN), a wireless personal area network (WPAN), a wireless local area network (WLAN), or an internet of things (IOT) network.

Various aspects of the subject matter disclosed herein relate generally to resource allocation in a wireless network, and more particularly, to selecting either a single-link operation mode or a multi-link operation mode for communicating with one or more STAs associated with an AP MLD based at least in part on link metrics obtained for the communication links of the AP MLD. The link metrics may include (but are not limited to) one or more of latencies, interference levels, traffic loads, or congestion associated with the respective communication links, among other examples. In some implementations, the AP MLD may receive a request for association on all communication links from a respective STA, and may determine or obtain the link metrics for each of the communication links of the AP MLD. In some instances, the AP MLD may provision a pair of communication links to the respective STA when the level of congestion on each of the communication links is less than a first threshold, or may provision a single communication link to the respective STA for communicating with the AP MLD when the level of congestion on each of the communication links is at least equal to the first threshold. In some aspects, the AP MLD may provision all of the communication links to the respective STA for communicating with the AP MLD when the level of congestion on each of the communication links is at least equal to a second threshold that is greater than the first threshold. The AP MLD may map the Traffic Identifiers (TIDs) of traffic flows associated with the respective STA to the provisioned communication link or links, and may determine or obtain a TID-to-Link Mapping (T2LM) element indicating, for the TIDs of the traffic flows associated with the respective STA, which of the communication links can be used for communicating the traffic flows associated with the respective STA. The AP MLD may send a frame including the T2LM element to the respective STA, and the respective STA may use the T2LM element to determine which communication link (or links) are to be used for communicating traffic flows associated with the respective STA.

In some implementations, the AP MLD may continuously or periodically monitor the link metrics of the communication links to determine whether lower latencies, lower interference levels, or lower traffic loads may be provided by another one or more communication links of the AP MLD. For example, when the respective STA is communicating with the AP MLD on first and second communication links, the AP MLD may obtain a first indication that congestion on the first and second communication links is at least equal to the first threshold, and may re-assign the respective STA from the first and second communication links to a single communication link based on the first indication. In this way, aspects of the present disclosure may enable single-link operation for the respective STA when latencies and throughput associated with the single communication link are similar to the respective latencies and throughput achieved by using both of the first and second communication links of the AP MLD. The AP MLD may subsequently obtain a second indication that congestion on the single communication link is at least equal to the second threshold, and may re-assign the respective STA from the single communication link to all communication links of the AP MLD based on the second indication. In this way, aspects of the present disclosure may enable multi-link operation for the respective STA when latencies and throughput associated with using all of the communication links are lower and higher, respectively, than the latencies and throughput achieved by using the single communication link of the AP MLD.

The 802.11be amendments to the IEEE 802.11 family of wireless communication standards allow non-AP STAs to request association with an AP MLD on all communication links of the AP MLD. As such, when an AP MLD receives a probe request or association request from a STA indicating support for all of the communication links, the AP MLD may automatically associate with the STA on all of the communication links associated with the AP MLD. In this way, the AP MLD may reduce latencies and increase throughput of data transmissions to or from the STA by allowing queued packets of traffic flows associated with the STA to be transmitted on the first available communication link of the AP MLD. However, automatically provisioning all of the communication links to the STA for communicating with the AP MLD may not always provide the lowest latency or the highest throughput for traffic associated with the STA.

Aspects of the present disclosure recognize that randomly transmitting packets of a traffic flow to an associated STA on multiple communication links may not always be necessary to meet the latency and throughput requirements associated with the traffic flow. To the contrary, provisioning multiple communication links of the AP MLD to an associated STA may, in some instances, crowd the wireless medium and increase network congestion. Specifically, aspects of the subject matter disclosed herein may achieve similar latencies and throughput using a single communication link of the AP MLD, rather than using multiple communication links of the AP MLD, when congestion on the multiple communication links is at least equal to the first threshold.

Aspects of the present disclosure also recognize that when congestion on individual communication links of the AP MLD is at least equal to the second threshold, or when OBSS interference levels on the communication links is at least equal to an interference threshold, none of the communication links of the AP MLD may, when provisioned as a single communication link to a respective STA, be able to provide lower latencies or higher throughput than the respective latencies and throughput achieved by using all of the communication links associated with the AP MLD. As such, aspects of the subject matter disclosed herein may achieve lower latencies and higher throughput using all of the communication links of the AP MLD, rather than a single communication link of the AP MLD, when congestion on the individual communication links is at least equal to the second threshold or when OBSS interference levels on the communication links is at least equal to the interference threshold.

Particular implementations of the subject matter described in this disclosure can be implemented to realize one or more of the following potential advantages. By re-assigning a respective STA from a multiple communication links (such as a pair of communication links) to a single communication link when congestion on the communication links is at least equal to the first threshold or when OBSS interference levels are at least equal to the interference threshold, aspects of the subject matter disclosed herein may reduce traffic and congestion on the non-assigned communication links while achieving similar latencies and throughput using only the single communication link. In addition, when the respective STA is provisioned a single communication link for communicating with the AP MLD, power consumption of the respective STA may be reduced, thereby extending battery life of the respective STA, because the respective STA may no longer need to listen to each of multiple communication links of the AP MLD for indications of queued DL data. Also, the ability to dynamically re-assign STAs among the communication links associated with the AP MLD may allow the AP MLD to reserve one of the communication links for certain traffic or for certain users. For example, in some implementations, the AP MLD may establish a premium communication link that can be reserved for latency-sensitive traffic and/or for STAs associated with latency-sensitive traffic.

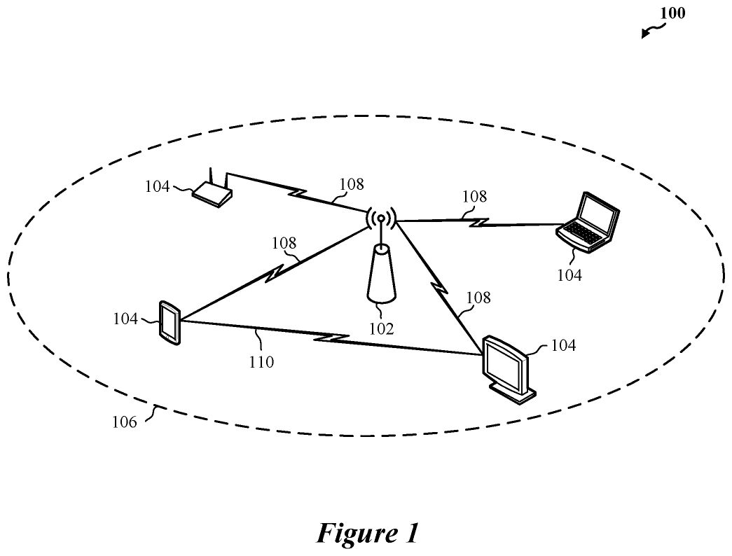

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba, and 802.11be). The WLAN 100 may include numerous wireless communication devices such as an access point (AP) 102 and multiple stations (STAs) 104. While only one AP 102 is shown, the WLAN 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5.0 GHz, 6.0 GHz, or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba, and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5.0 GHz band, the 60 GHz band, the 3.6 GHz band, and the 900 MHz band. Some implementations of the APs 102 and STAs 104 described herein also may communicate in other frequency bands, such as the 6.0 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, and 802.11ax standard amendments may be transmitted over the 2.4 and 5.0 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160, or 320 MHz by bonding together multiple 20 MHz channels.

Each PPDU is a composite structure that includes a PHY preamble and a payload in the form of a PLCP service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

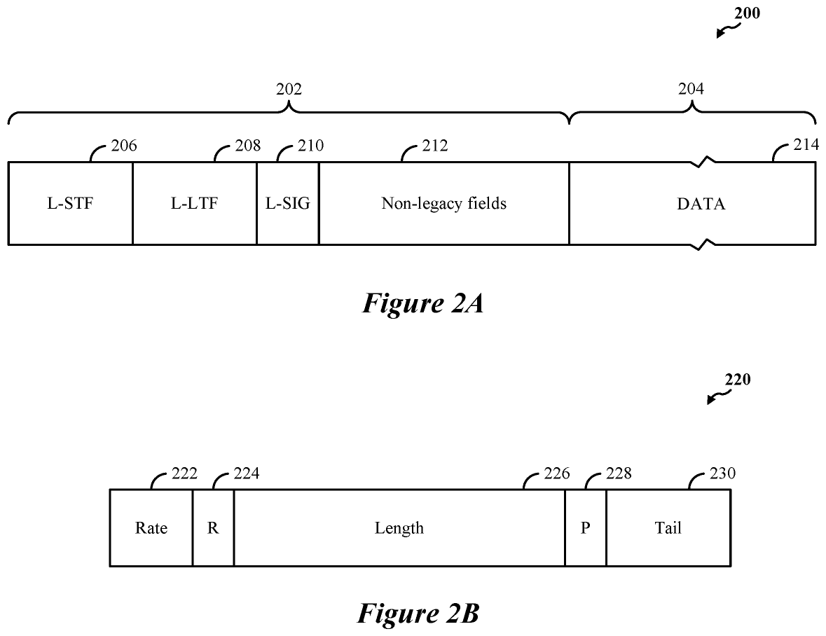

FIG. 2A shows an example protocol data unit (PDU) 200 usable for wireless communication between an AP 102 and one or more STAs 104. For example, the PDU 200 can be configured as a PPDU. As shown, the PDU 200 includes a PHY preamble 202 and a payload 204. For example, the preamble 202 may include a legacy portion that itself includes a legacy short training field (L-STF) 206, which may consist of two BPSK symbols, a legacy long training field (L-LTF) 208, which may consist of two BPSK symbols, and a legacy signal field (L-SIG) 210, which may consist of two BPSK symbols. The legacy portion of the preamble 202 may be configured according to the IEEE 802.11a wireless communication protocol standard. The preamble 202 also may include a non-legacy portion including one or more non-legacy fields 212, for example, conforming to an IEEE wireless communication protocol such as the IEEE 802.11ac, 802.11ax, 802.11be or later wireless communication protocol protocols.

The L-STF 206 generally enables a receiving device to perform automatic gain control (AGC) and coarse timing and frequency estimation. The L-LTF 208 generally enables a receiving device to perform fine timing and frequency estimation and also to perform an initial estimate of the wireless channel. The L-SIG 210 generally enables a receiving device to determine a duration of the PDU and to use the determined duration to avoid transmitting on top of the PDU. For example, the L-STF 206, the L-LTF 208 and the L-SIG 210 may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of medium access control (MAC) protocol data units (MPDUs) or an aggregated MPDU (A-MPDU).

FIG. 2B shows an example L-SIG 210 in the PDU 200 of FIG. 2A. The L-SIG 210 includes a data rate field 222, a reserved bit 224, a length field 226, a parity bit 228, and a tail field 230. The data rate field 222 indicates a data rate (note that the data rate indicated in the data rate field 222 may not be the actual data rate of the data carried in the payload 204). The length field 226 indicates a length of the packet in units of, for example, symbols or bytes. The parity bit 228 may be used to detect bit errors. The tail field 230 includes tail bits that may be used by the receiving device to terminate operation of a decoder (for example, a Viterbi decoder). The receiving device may utilize the data rate and the length indicated in the data rate field 222 and the length field 226 to determine a duration of the packet in units of, for example, microseconds (μs) or other time units.

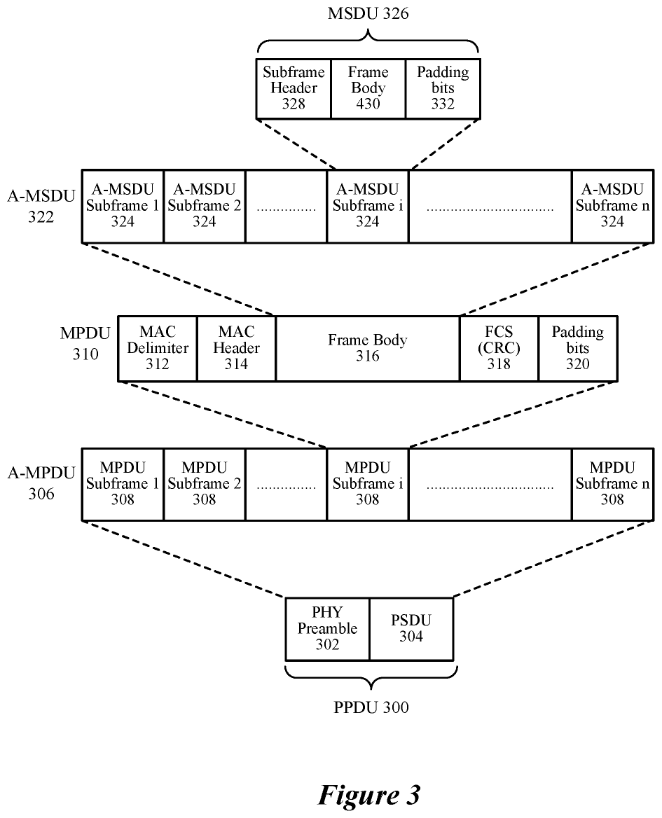

FIG. 3 shows an example PPDU 300 usable for communications between an AP 102 and a number of STAs 104. As discussed, each PPDU 300 includes a PHY preamble 302 and a PSDU 304. Each PSDU 304 may carry one or more MAC protocol data units (MPDUs), for example, such as an aggregated MPDU (A-MPDU) 306 that includes multiple MPDU subframes 308. Each MPDU subframe 308 may include a MAC delimiter 312 and a MAC header 314 prior to the accompanying frame body 316, which includes the data portion or “payload” of the MPDU subframe 308. The frame body 316 may carry one or more MAC service data units (MSDUs), for example, such as an aggregated MSDU (A-MSDU) 322 that includes multiple MSDU subframes 324. Each MSDU subframe 324 contains a corresponding MSDU 326 including a subframe header 328, a frame body 330, and one or more padding bits 332.

With reference to the A-MPDU subframe 306, the MAC header 314 may include a number of fields containing information that defines or indicates characteristics or attributes of data encapsulated within the frame body 316. The MAC header 314 also includes a number of fields indicating addresses for the data encapsulated within the frame body 316. For example, the MAC header 314 may include a combination of a source address, a transmitter address, a receiver address, or a destination address. The MAC header 314 may include a frame control field containing control information. The frame control field specifies the frame type, for example, a data frame, a control frame, or a management frame. The MAC header 314 may further include a duration field indicating a duration extending from the end of the PPDU until the end of an acknowledgment (ACK) of the last PPDU to be transmitted by the wireless communication device (for example, a block ACK (BA) in the case of an A-MPDU). The use of the duration field serves to reserve the wireless medium for the indicated duration, thus establishing the NAV. Each A-MPDU subframe 408 may also include a frame check sequence (FCS) field 418 for error detection. For example, the FCS field 418 may include a cyclic redundancy check (CRC), and may be followed by one or more padding bits 420.

As discussed, APs 102 and STAs 104 can support multi-user (MU) communications. That is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and partial bandwidth (BW) MU-MIMO techniques.

In partial BW MU-MIMO schemes, the available frequency spectrum of the wireless channel may be divided into multiple resource units (RUs) each including a number of different frequency subcarriers (“tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs may also be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL partial BW MU-MIMO or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

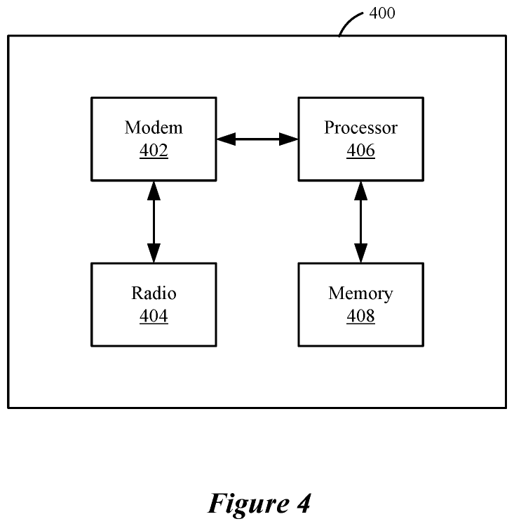

FIG. 4 shows a block diagram of an example wireless communication device 400. In some implementations, the wireless communication device 400 can be an example of a device for use in a STA such as one of the STAs 104 described with reference to FIG. 1. In some implementations, the wireless communication device 400 can be an example of a device for use in an AP such as the AP 102 described with reference to FIG. 1. The wireless communication device 400 is capable of transmitting (or outputting for transmission) and receiving wireless communications (for example, in the form of wireless packets). For example, the wireless communication device 400 can be configured to transmit and receive packets in the form of physical layer convergence protocol (PLCP) protocol data units (PPDUs) and medium access control (MAC) protocol data units (MPDUs) conforming to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba, and 802.11be.

The wireless communication device 400 can be, or can include, a chip, system on chip (SoC), chipset, package, or device that includes one or more modems 402, for example, a Wi-Fi (IEEE 802.11 compliant) modem. In some implementations, the one or more modems 402 (collectively “the modem 402”) additionally include a WWAN modem (for example, a 3GPP 4G LTE or 5G compliant modem). In some implementations, the wireless communication device 400 also includes one or more radios 404 (collectively “the radio 404”). In some implementations, the wireless communication device 400 further includes one or more processors, processing blocks or processing elements (collectively “the processor 406”), and one or more memory blocks or elements (collectively “the memory 408”).

The modem 402 can include an intelligent hardware block or device such as, for example, an application-specific integrated circuit (ASIC) among other possibilities. The modem 402 is configured to implement a PHY layer. For example, the modem 402 is configured to modulate packets and to output the modulated packets to the radio 404 for transmission over the wireless medium. The modem 402 is similarly configured to obtain modulated packets received by the radio 404 and to demodulate the packets to provide demodulated packets. In addition to a modulator and a demodulator, the modem 402 may further include digital signal processing (DSP) circuitry, automatic gain control (AGC), a coder, a decoder, a multiplexer, and a demultiplexer. For example, while in a transmission mode, data obtained from the processor 406 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and the radio 404. In implementations involving beamforming, the modulated symbols in the respective spatial streams are precoded via a steering matrix prior to their provision to the IFFT block.

While in a reception mode, digital signals received from the radio 404 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 406) for processing, evaluation, or interpretation.

The radio 404 includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may in turn be coupled to one or more antennas. For example, in some implementations, the wireless communication device 400 can include, or be coupled with, multiple transmit antennas (each with a corresponding transmit chain) and multiple receive antennas (each with a corresponding receive chain). The symbols output from the modem 402 are provided to the radio 404, which then transmits the symbols via the coupled antennas. Similarly, symbols received via the antennas are obtained by the radio 404, which then provides the symbols to the modem 402.

The processor 406 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 406 processes information received through the radio 404 and the modem 402, and processes information to be output through the modem 402 and the radio 404 for transmission through the wireless medium. For example, the processor 406 may implement a control plane and MAC layer configured to perform various operations related to the generation and transmission of MPDUs, frames, or packets. The MAC layer is configured to perform or facilitate the coding and decoding of frames, spatial multiplexing, space-time block coding (STBC), beamforming, and OFDMA resource allocation, among other operations or techniques. In some implementations, the processor 406 may control the modem 402 to cause the modem to perform various operations described herein.

The memory 408 can include tangible storage media such as random-access memory (RAM) or read-only memory (ROM), or combinations thereof. The memory 408 also can store non-transitory processor- or computer-executable software (SW) code containing instructions that, when executed by the processor 406, cause the processor to perform various operations described herein for wireless communication, including the generation, transmission, reception, and interpretation of MPDUs, frames or packets. For example, various functions of components disclosed herein, or various blocks or steps of a method, operation, process, or algorithm disclosed herein, can be implemented as one or more modules of one or more computer programs.

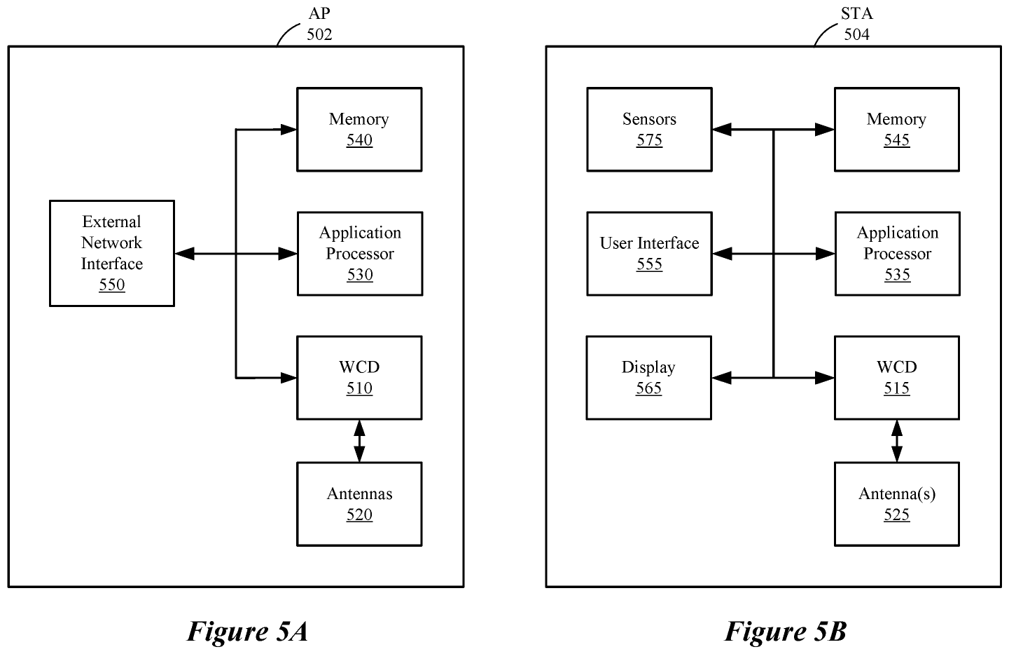

FIG. 5A shows a block diagram of an example AP 502. For example, the AP 502 can be an example implementation of the AP 102 described with reference to FIG. 1. The AP 502 includes a wireless communication device (WCD) 510. For example, the wireless communication device 510 may be an example implementation of the wireless communication device 400 described with reference to FIG. 4. The AP 502 also includes multiple antennas 520 coupled with the wireless communication device 510 to transmit and receive wireless communications. In some implementations, the AP 502 additionally includes an application processor 530 coupled with the wireless communication device 510, and a memory 540 coupled with the application processor 530. The AP 502 further includes at least one external network interface 550 that enables the AP 502 to communicate with a core network or backhaul network to gain access to external networks including the Internet. For example, the external network interface 550 may include one or both of a wired (for example, Ethernet) network interface and a wireless network interface (such as a WWAN interface). Ones of the aforementioned components can communicate with other ones of the components directly or indirectly, over at least one bus. The AP 502 further includes a housing that encompasses the wireless communication device 510, the application processor 530, the memory 540, and at least portions of the antennas 520 and external network interface 550.

FIG. 5B shows a block diagram of an example STA 504. For example, the STA 504 can be an example implementation of the STA 104 described with reference to FIG. 1. The STA 504 includes a wireless communication device 515. For example, the wireless communication device 515 may be an example implementation of the wireless communication device 400 described with reference to FIG. 4. The STA 504 also includes one or more antennas 525 coupled with the wireless communication device 515 to transmit and receive wireless communications. The STA 504 additionally includes an application processor 535 coupled with the wireless communication device 515, and a memory 545 coupled with the application processor 535. In some implementations, the STA 504 further includes a user interface (UI) 555 (such as a touchscreen or keypad) and a display 565, which may be integrated with the UI 555 to form a touchscreen display. In some implementations, the STA 504 may further include one or more sensors 575 such as, for example, one or more inertial sensors, accelerometers, temperature sensors, pressure sensors, or altitude sensors. Ones of the aforementioned components can communicate with other ones of the components directly or indirectly, over at least one bus. The STA 504 further includes a housing that encompasses the wireless communication device 515, the application processor 535, the memory 545, and at least portions of the antennas 525, UI 555, and display 565.

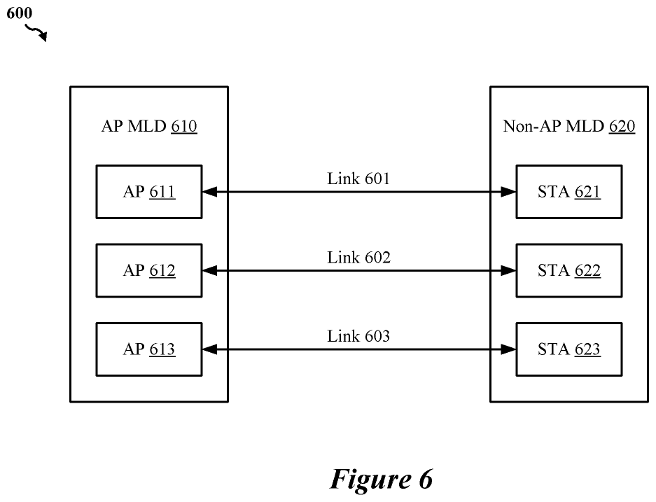

FIG. 6 shows an example communication system 600 that includes an AP MLD 610 and a non-AP MLD 620. In some implementations, the AP MLD 610 may be one example of any of the APs 102 of FIG. 1, the wireless communication device 400 of FIG. 4, or the AP 502 of FIG. 5A. The non-AP MLD 620 may be one example of any of the STAs 104 FIG. 1, the wireless communication device 400 of FIG. 4, or the STA 504 of FIG. 5B.

The AP MLD 610 includes multiple APs 611-613 associated with (or operating on) respective communication links 601-603. In the example of FIG. 6, the AP MLD 610 is shown to include 3 APs 611-613. In other implementations, the AP MLD 610 may include fewer or more APs than those depicted in FIG. 6. Although the APs 611-613 may share a common association context (through the AP MLD 610), each of the APs 611-613 may establish a respective BSS on the AP's associated communication link. The APs 611-613 also may establish their respective communication links 601-603 on different frequency bands. For example, the AP 611 may operate on the 2.4 GHz frequency band, the AP 612 may operate on the 5 GHz frequency band, and the AP 613 may operate on the 6 GHz frequency band.

The non-AP MLD 620 includes multiple STAs 621-623 that may be configured to communicate on the communication links 601-603, respectively. Thus, the STA 621 may operate on the 2.4 GHz frequency band, the STA 622 may operate on the 5 GHz frequency band, and the STA 623 may operate on the 6 GHz frequency band. In the example of FIG. 6, the non-AP MLD 620 is shown to include only 3 STAs. However, in some implementations, the non-AP MLD 620 may include fewer or more STAs than those depicted in FIG. 6. The IEEE 802.11be amendment of the IEEE 802.11 standard defines several modes in which a non-AP MLD may operate. The various operating modes depend on the number of wireless radios associated with the non-AP MILD and the non-AP MLD's ability to communicate (such as by transmitting or receiving) concurrently on multiple communication links.

In some implementations, the non-AP MLD 620 may include a single radio or may otherwise be capable of communicating on only one link at a time. In such implementations, the non-AP MLD 620 may operate in a multi-link single-radio (MLSR) mode or an enhanced MLSR (EMLSR) mode. A non-AP MLD operating in the EMLSR mode can listen for specific types of communications (such as buffer status report poll (BSRP) frames or multi-user request-to-send (MU-RTS) frames) on multiple communication links, concurrently, but can only transmit or receive on one communication link at any given time. For example, the STAs 621 and 622 may concurrently listen on their respective links 601 and 602 during a listen interval. However, if the STA 621 detects a BSRP frame on link 601, the non-AP MLD 620 subsequently tunes each of the non-AP MLD's antennas (including the antenna used by the STA 622 during the listen interval) to operate on link 601. By contrast, a non-AP MLD operating in the MLSR mode can only listen to, and transmit or receive on, one communication link at any given time. For example, the STA 621 must be in a power save mode at times during which the STA 622 is active.

In some other implementations, the non-AP MLD 620 may include multiple radios and may be capable of concurrent communications on each of the links 601-603. In such implementations, the non-AP MLD 620 may operate in a multi-link multi-radio (MLMR) simultaneous transmit and receive (STR) mode or a multi-link multi-radio non-STR (NSTR) mode. A non-AP MLD operating in the MLMR STR mode can simultaneously (or concurrently) transmit and receive on multiple communication links. For example, the STA 621 may transmit or receive on link 601 while the STA 622 concurrently transmits or receives on link 602, asynchronously. By contrast, a non-AP MLD operating in the MLMR NSTR mode can simultaneously transmit and receive on multiple communication links only if such communications are synchronous. For example, the STAs 622 and 623 may concurrently transmit on links 602 and 603 and may concurrently receive on links 602 and 603. However, the STA 622 cannot be transmitting on link 602 while the STA 623 is receiving on link 603.

Still further, a non-AP MLD may include multiple radios but may be capable of concurrent communications on only a subset of the links. In such implementations, the non-AP MLD 620 may operate in an enhanced MLMR (EMLMR) mode or a hybrid EMLSR mode. A non-AP MLD operating in the EMLMR mode supports MLMR STR operation between certain pairs of communication links. For example, the STAs 621 and 622 may concurrently communicate on their respective links 601 and 602 in accordance with the MLMR STR mode of operation.

As discussed, various aspects of the subject matter disclosed herein relate generally to transmission modes used for transmitting multiple traffic flows over a wireless medium, and more particularly, to selecting or adjusting the transmission modes based on feedback information obtained from one or more wireless networks, one or more attributes of the traffic flows, one or more SLA parameters of the traffic flows, or any combination thereof.

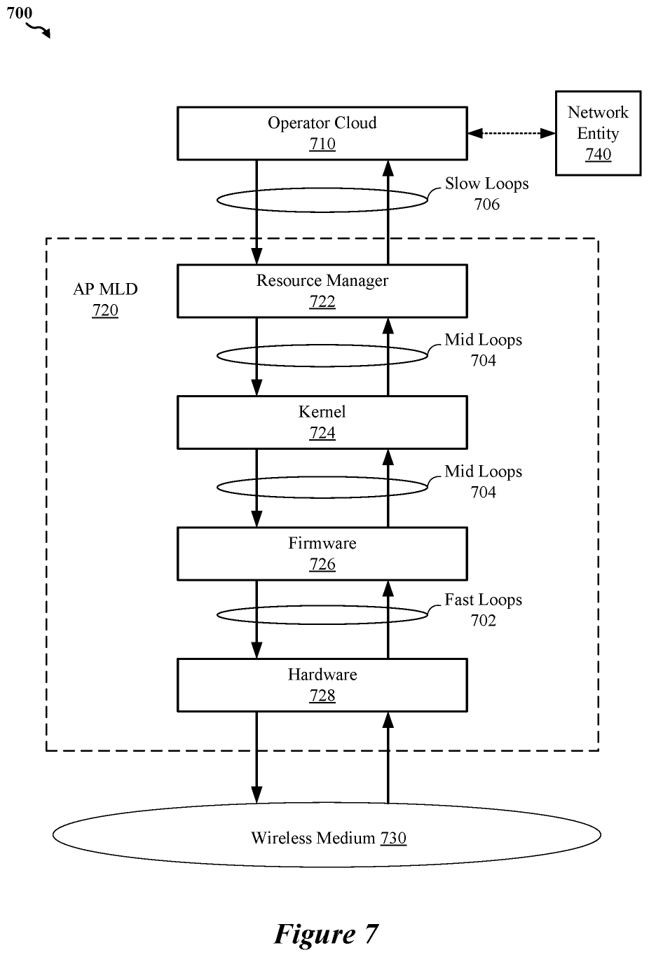

FIG. 7 shows a system 700 of tiered control loops for wireless communication according to some implementations. The example system 700 includes an operator cloud 710 and an AP MLD 720. In some implementations, the AP MLD 720 may be one example of the AP MLD 610 of FIG. 6, and each AP of the AP MLD 720 may be one example of the AP 102 of FIG. 1, the wireless communication device 400 of FIG. 4, or the AP 502 of FIG. 5A. The operator cloud 710 may represent a backhaul network communicatively coupled to the AP MLD 720 via an external network interface such as, for example, the external network interface 650 of FIG. 6A. Although not shown for simplicity, the operator cloud 710 may include a network controller or any combination of hardware or software configured to control or manage various operations of the AP MLD 720.

In some implementations, a network entity 740 may be able to communicate with the AP MLD 720 via the operator cloud 710. The network entity 740 may represent any person, group, company, or other organization that may be interested in increasing performance and reliability of the communication links associated with the AP MLD 720. In some instances, the network entity 740 may provide or configure various setting and thresholds (such as a latency threshold, an interference threshold, or a traffic load threshold, among other examples) associated with selecting a multi-link communication mode or a single-link communication mode for one or more associated STAs. In some aspects, the network entity 740 may dynamically adjust one or more of the various settings and thresholds associated with provisioning communication links to the STAs or re-assigning one or more of the STAs from one communication link (or group of communication links) to another communication link (or group of communication links). In this way, the network entity 740 can dynamically adjust or change the link provisioning mechanisms described herein via an over-the-air (OTA) update.

The AP MLD 720 is shown to include a resource manager 722, a kernel 724, a firmware component 726, and a hardware component 728. The firmware component 726 and hardware component 728 represent various components of a wireless communication device such as, for example, the wireless communication device 400 of FIG. 4. With reference to FIG. 4, the hardware component 728 may include one or more components of the modem 402 or the radio 404, and the firmware component 726 may include one or more components of the processor 406 or the memory 408. In some instances, the hardware component 728 may implement various PHY and MAC layer functionalities associated with transmitting packets over a wireless medium 730.

The resource manager 722 represents software executed by a host processor such as, for example, the application processor 530 of FIG. 5A. In some instances, the resource manager 722 may include instructions stored in memory 540 that can be executed by the application processor 530 to control various operations of the AP MLD 720. For example, the resource manager 722 may obtain link metrics of the communication links of the AP MLD 720 and/or SLAs parameters for one or more associated STAs from the operator cloud 710. In some instances, the resource manager 722 can use one or more of the link metrics or SLA parameters to provision either a single communication link or multiple communication links to the STA for communicating with the AP MLD 720. In other instances, the resource manager 722 can use one or more of the link metrics or SLA parameters to assign the STA to a single communication link, and subsequently re-assign the STA from the single communication link either to another single communication link or to multiple communication links associated with the AP MLD 720. In some other instances, the resource manager 722 can use one or more of the link metrics or SLA parameters to assign the STA to a pair of communication links, and subsequently re-assign the STA from the pair of communication links to a single communication link associated with the AP MLD 720.

In various implementations, the resource manager 722 may provision single communication links to STAs during association and authentication procedures, and maintain the STAs on their respective provisioned single communication links for as long as possible. That is, rather than automatically provisioning all of the communication links for which a STA indicates support, the resource manager 722 may use load balancing techniques described herein to dynamically re-assign one or more STAs between communication links to achieve similar link metrics for each of the communication links. In this way, the resource manager 722 may increase the length of time during which the STAs communicate with the AP MLD 720 in a single-link operation mode.

In some implementations, the resource manager 722 monitors or obtains the link metrics for the communication links at certain times or intervals, and uses one or more of the link metrics to determine whether any of the communication links violate one or more of a latency threshold, an interference threshold, or a traffic load threshold. In some aspects, the resource manager 722 monitors or obtains the link metrics at intervals of between 5 and 10 seconds. For example, after provisioning a first communication link to a first STA, the resource manager 722 may receive or obtain a first indication that at least one of the latency, the interference level, or the traffic load associated with the first communication link is at least equal to the respective latency threshold, interference threshold, or traffic load threshold. In some instances, the resource manager 722 may switch communications with the first STA from the first communication link to another single communication link based on the first indication. The resource manager 722 may subsequently receive or obtain a second indication that at least one of the latency, the interference level, or the traffic load associated with the other single communication link is at least equal to the respective latency threshold, interference threshold, or traffic load threshold. In some aspects, the resource manager 722 may switch communications with the first STA to another single communication link based on the second indication. In other aspects, the resource manager 722 may switch communications with the first STA to multiple communication links, or all of the communication links, based on the second indication.

In some other implementations, the resource manager 722 may obtain the MAC address or the device ID of a STA requesting associated with the AP MLD 720, and determine one or more types of traffic flows most recently or most frequently associated with the STA. In some instances, the resource manager 722 may consider the most recent or most frequent types of traffic flows when provisioning either a single communication link or multiple communication links to the STA. For example, if a particular STA is historically associated with latency-sensitive traffic, the resource manager 722 may provision higher-capacity or lower-latency communication links to the particular STA than the communication links provisioned to non-latency sensitive STAs.

In various aspects, the resource manager 722 may provide multi-link operation (MLO) mode indications, link provisioning information, and/or STA link assignments to the firmware component 726. In some implementations, the resource manager 722 provides an indication of a single-link operation mode or a multi-link operation mode for a given STA to the firmware 726 and/or hardware 728. The firmware 726 and/or hardware 728 may use the indication to provision either a single communication link or multiple communication links to the given STA for communicating with the AP MLD 720.

The kernel 724 may facilitate interactions between hardware and software components of the AP MLD 720. For example, the kernel 724 may control various hardware resources of the AP MLD 720 via device drivers, may arbitrate conflicts between hardware resources, and may optimize the utilization of shared resources (such as processor execution cycles, cache memory allocations, file systems, and network sockets). Although not shown in FIG. 7 for simplicity, the kernel 724 may include a host driver, one or more application programming interfaces (APIs), and a MAC Sublayer Management Entity (MLME). In some other aspects, one or more of the host driver, the APIs, or the MHLME can be implemented in the resource manager 722.

In some implementations, the system 700 may provide hierarchical levels of control for various aspects of wireless communication by the AP MLD 720. For example, the hardware component 728 may implement one or more “fast” control loops 702 based on feedback provided by the firmware component 726 and/or indications provided by the resource manager 722. The fast control loops 702 may control various link provisioning, STA link assignments, and Multi-link Operation (MHLO) mode decisions that require fast convergence. Examples of fast control loops 702 may include just-in-time (JIT) scheduling, smart enhanced distributed channel access (EDCA) adjustments, lazy or aggressive rate control, switching between single-link operation mode and multi-link operation mode, STA grouping, and pausing or unpausing of traffic identifiers (TIDs), among other examples. For example, when implementing a fast control loop 702 associated with a single-link operation mode, the hardware component 728 may receive, from the resource manager 722, an indication that a single communication link is provisioned to a respective STA (or group of STAs). In response thereto, the hardware component 728 may select a single-link operation mode for communicating with the respective STA (or group of STAs). For another example, when implementing a fast control loop 702 associated with a multi-link operation mode, the hardware component 728 may receive, from the resource manager 722, an indication that multiple communication links are provisioned to a respective STA (or group of STAs). In response thereto, the hardware component 728 may select a multi-link operation mode for communicating with the respective STA (or group of STAs).

The resource manager 722 and kernel 724 may implement one or more “mid” control loops 704 that determine whether a respective STA is to be provisioned a single communication link of the AP MILD 720 or multiple communication links of the AP MLD 720 based at least in part on the link metrics associated with the communication links of the AP MLD 720. In some instances, the mid control loops 704 may control various link provisioning, STA link assignments, and MLO mode decisions with slower convergence requirements than those associated with the fast control loops 702. Examples of mid control loops 704 may include MLO link provisioning, STA link assignments (and re-assignments), activating or deactivating communication links of the AP MLD 720, enabling or disabling MU communications, enabling or disabling fast rate control, configuring rate control loop constants, configuring maximum data rates, enabling or disabling energy-efficient operation, and configuring uplink (UL) or downlink (DL) throttling limits, among other examples. For example, when implementing a mid-control loop 704 associated with wireless communications, the resource manager 722 may indicate whether a respective STA is to be provisioned a single communication link or multiple communication links for communicating with the AP MLD 720. In this way, the mid control loops 704 may provide a dynamic range of execution for the fast control loops 702.

The operator cloud 710 may implement one or more “slow” control loops 706 to obtain link metrics, SLA parameters, and other attributes or characteristics of the communication links and/or STAs associated with the AP MLD 720. In some instances, the slow control loops 706 may control various link provisioning, STA link assignments, and MLO mode decisions with slower convergence requirements than those associated with the mid control loops 704. Examples of slow control loops 706 may include setting thresholds for obtaining or otherwise determining link congestion thresholds, link latency thresholds, link throughput thresholds, traffic load thresholds, and other thresholds that can be used for provisioning links to one or more STAs in a manner that achieves an optimal utilization of wireless resources associated with the communication links of the AP MLD 720. For example, when implementing a slow control loop 706 associated with wireless communications, the operator cloud 710 may provide the link metrics of the communication links of the AP MLD 720 as feedback to the resource manager 722. For another example, when implementing a slow control loop 706 associated with wireless communications, the operator cloud 710 may provide or adjust one or more of the link congestion thresholds, link latency thresholds, link traffic load thresholds, interference thresholds, or other thresholds as feedback to the resource manager 722. In this way, the slow control loops 706 may configure and/or manage one or more decision thresholds for the mid control loops 704.

In some implementations, the fast control loops 702 may be configured to make MLO mode decisions for some aspects of wireless communications that require responses between approximately 1 and 100 milliseconds, the mid control loops 704 may be configured to make MLO mode decisions for other aspects of wireless communications that require responses between approximately 1 and 5 seconds, and the slow control loops 706 may be configured to make MLO mode decisions for some other aspects of wireless communications that require responses between approximately 10 and 60 seconds.

In various implementations, the operator cloud 710 may monitor the interference levels, channel delay spread values (or other indicators of multipath), throughput levels, latencies, and traffic load on each of the communication links associated with the AP MLD 720, and may provide the resulting monitored information as feedback to the resource manager 722. In some instances, the operator cloud 710 may also monitor the number of active STAs, the number or percentage of active STAs that support multi-link communications, one or more service class parameters, and SLA parameters of STAs associated with the AP MLD 720, and may provide the resulting monitored information as feedback to the resource manager 722. In some implementations, the resource manager 722 may consider one or more of the SLA parameters for a respective STA when determining whether to provision a single communication link or multiple communication links to the respective STA. In some other implementations, the resource manager 722 may consider one or more of the SLA parameters for a respective STA when determining whether to switch communications with the respective STA from one communication link (or group of communication links) to another communication link (or group of communication links). In some aspects, the SLA parameters may specify a minimum data rate for one or more associated traffic flows, a delay bound for one or more associated traffic flows, a service interval for one or more associated traffic flows, a burst size for one or more associated traffic flows, a burst interval for one or more associated traffic flows, and throughput requirements for one or more associated traffic flows, among other examples.

In some implementations, the resource manager 722 may reserve one of the communication links associated with the AP MLD 720 for certain traffic flows or certain STAs. For example, in some instances, the resource manager 722 may reserve a selected communication link of the AP MLD 720 for latency-sensitive traffic, and may maintain latencies, throughput, and traffic loads on the reserved communication link at or within configurable thresholds or ranges. In this way, the resource manager 722 may ensure that STAs associated with the AP MLD 720 are able to meet the have strict timing, throughput, and latency requirements associated with latency-sensitive traffic flows.

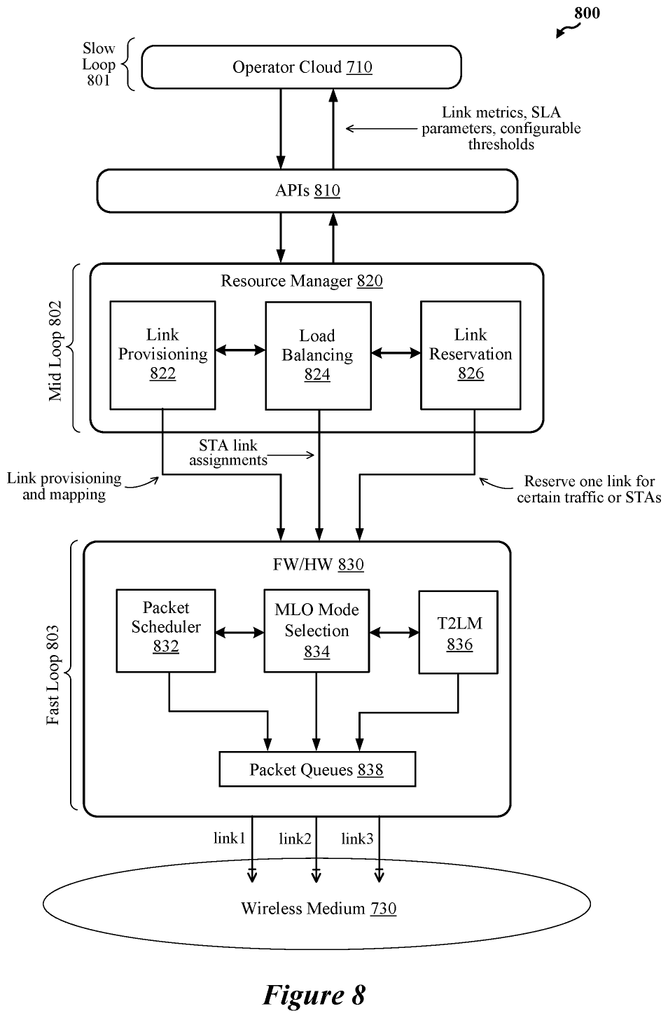

FIG. 8 shows a block diagram of an apparatus 800 associated with a slow control loop 801, a mid-control loop 802, and a fast control loop 803 of wireless device, according to some implementations. In some implementations, the apparatus 800 may be an AP MLD such as the AP MLD 610 of FIG. 6 or the AP MLD 720 of FIG. 7. In various aspects, the slow control loop 801 may be associated with one or more application programming interfaces (APIs) 810 of the apparatus 800, and in some instances, may also be associated with the operator cloud 710 described with reference to FIG. 7. The mid control loop 802 may be associated with a resource manager 820 of the apparatus 800, and the fast control loop 803 may be associated with a firmware and hardware (FW/HW) component 830 of the apparatus 800.

The APIs 810 may provide an interface through which the resource manager 820 can obtain link metrics and SLA parameters from the network entity 740 described with reference to FIG. 7. The APIs 810 may also provide an interface through which the resource manager 820 may obtain one or more thresholds associated with link provisioning decisions and STA link assignment decisions pertaining to the apparatus 800. In some aspects, the APIs 810 may be one example of the APIs described with reference to FIG. 6. For example, the APIs 810 may include an MLME API, an MU API, a resource manager telemetry API, a T2LM API, and one or more provisioning APIs, among other examples. In some instances, the one or more provisioning APIs may be used either independent of, or in conjunction with, the resource manager 820 to select or adjust one or more of the thresholds used for link provisioning and STA link assignment decisions. In other instances, the one or more provisioning APIs may be used either independent of, or in conjunction with, the resource manager 820 to provide indications of whether one or more respective STAs are to be provisioned a single communication link or provisioned multiple communication links for communicating with an AP MLD.

In some implementations, the provisioning APIs may be instructed by the resource manager 820 to configure various aspects of the firmware and hardware component 830 based on the mid control loop 802. For example, the resource manager 820 may instruct the provisioning APIs to select or adjust the MLO mode (e.g., between the single-link operation mode and the multi-link operation mode) used by a respective STA for communicating with the AP MLD, to determine which communication link is provisioned to a STA when in the single-link operation mode, to determine which pair or group of communication link is provisioned to the STA when in the multi-link operation mode, or to select a multi-link profile for one or more associated STAs. Example multi-link operation profiles may include an enhanced multi-link multi-radio (EMLMR) profile, an enhanced multi-link single-radio (EM-LSR) profile, a non-simultaneous transmit and receive (NSTR) profile, among other examples. The multi-link profile may be used by the resource manager 820 during link provisioning to determine whether multiple communication links can be provisioning to a particular STA for communicating with the AP MLD 720. In some instances, the resource manager 820 may also instruct the provisioning APIs to indicate either the single-link operation mode or the multi-link operation mode for DL packets queued for delivery in the AP MLD.

The resource manager 820, which may be one example of the resource manager 722 of FIG. 7, is shown to include a link provisioning component 822, a load balancing component 824, and a link reservation component 826, among other components. The link provisioning component 822 may be responsible for provisioning communication links to STAs associated with the AP MLD. In some implementations, the link provisioning component 822 may provision a pair of communication links to a respective STA for communicating with the AP MLD when the congestion or traffic load on the pair of communication links is less than a first threshold, and may provision a single communication link to the respective STA for communicating with the AP MLD when the congestion or traffic load on the pair of communication links is at least equal to the first threshold. As discussed, when congestion on the pair of communication links is at least equal to the first threshold, one of the pair of communication links is typically able to achieve latencies and throughput similar to the respective latencies and throughput achieved using both of the communication links. As such, by provisioning single communication links to the STAs when the congestion or traffic load is at least equal to the first threshold, the link provisioning component 822 may achieve latencies and throughput similar to those achieved with multiple communication links without provisioning the other communication link of the pair. In some aspects, the link provisioning component 822 may maintain the STAs on their respective provisioned single communication links for as long as possible. In this way, aspects of the subject matter disclosed herein may not only conserve wireless resources associated with the AP MLD, but also may reduce power consumption of STAs that are provisioned a single communication link.

In some instances, the link provisioning component 822 may provision all of the communication links to a respective STA when the congestion or traffic load is at least equal to a second threshold greater than the first threshold, or when the level of OBSS interference on the communication links is at least equal to an interference threshold. As discussed, when the respective STA is provisioned on all communication links of the AP MILD, link diversity between the communication links may reduce latencies and packet error rates (PERs) associated with transmissions to the respective STA to levels that are less than the respective latencies and PERs achieved by either a single communication link or a pair of communication links of the AP MLD. In this way, the link provisioning component 822 may reduce latencies and/or increase throughput (as compared to conventional approaches) when the congestion or traffic load on the communication links is at least equal to the second threshold or when the level of OBSS interference on the communication links is at least equal to the interference threshold.

The load balancing component 824 may implement load balancing between the communication links of the AP MLD by dynamically re-assigning one or more associated STAs among the various communication links of the AP MLD based on changes in one or more of the latencies, interference levels, or traffic loads associated with the various communication links. For example, in some instances, when at least one of the latency, interference level, or traffic load associated with a single communication link provisioned to a STA is at least equal to the respective latency threshold, interference threshold, or traffic load threshold, the load balancing component 824 may re-assign the STA to another single communication link of the AP MHLD. When at least one of the latency, interference level, or traffic load associated with the other single communication link is at least equal to the respective latency threshold, interference threshold, or traffic load threshold, the load balancing component 824 may re-assign the STA to yet another single communication link until either all of the communication links have been provisioned to the STA or until the level of OBSS interference is at least equal to the interference threshold.

In other instances, when at least one of the latency, interference level, or traffic load associated with multiple communication links provisioned to a STA is at least equal to the respective latency threshold, interference threshold, or traffic load threshold, the load balancing component 824 may re-assign the STA to a single communication link of the AP MLD. In some other instances, when at least one of the latency, the interference level, or the traffic load on the reserved communication link is at least equal to the respective latency threshold, interference threshold, or traffic load threshold, the load balancing component 824 may maintain at least some STAs associated with latency-sensitive traffic on the reserved link while re-assigning one or more other STAs (that are not associated with latency-sensitive traffic) from the reserved communication link to one or more other communication links of the AP MLD.

The load balancing component 824 may seamlessly switch STAs that support multi-link operation from one communication link to another communication link based on the multi-link profile, for example, without disassociating from the STAs and then re-associating with the STAs. The load balancing component 824 may switch “legacy” STAs that do not support multi-link operation from a first communication link to a second communication link by disassociating from the legacy STAs on the first communication link, and then re-associating with the legacy STAs on the second communication link. In some aspects, the load balancing component 824 may send messages compliant with the 802.11AR standard to provide information associated with the STA link re-assignments to the legacy STAs.

The link reservation component 826 may be responsible for establishing one of the communication links of the AP MLD as a reserved link. In some instances, the reserved link may be for latency-sensitive traffic, and may occupy one or more wireless channels in the 6 GHz frequency band (although in other implementations, the reserved link may be in another suitable frequency band).

In various implementations, one or more of the link provisioning component 822, the load balancing component 824, or the link reservation component 826 can obtain, from the firmware and hardware component 830 (or other components of the fast loop 803), indications of traffic loads on each of the communication links associated with the AP MLD.

The firmware and hardware component 830, which may be an example of the firmware component 726 and the hardware component 728 described with reference to FIG. 7, is shown to include a packet scheduler 832, an MLO mode selection component 834, a TID-to-Link Mapping (T2LM) component 836, and packet queues 838. The packet scheduler 832 may obtain feedback information and link indications from the resource manager 820 based on the mid control loop 802, and use the feedback information and link indications to schedule the transmission of packets associated with different traffic flows to their intended STAs using one or more of the communication links associated with the AP MHLD. For example, in some instances, the packet scheduler 832 may use the indication of a single-link operation mode or a multi-link operation mode when determining on which of the communication links of the AP MLD a respective packet may be transmitted.

The MLO mode component 834 may use the single-link and multi-link operation mode indications provided by the resource manager 820 to enable either single-link communications or multi-link communications for one or more respective STAs. In some instances, the MLO mode component 834 can configure various MAC and PHY components of the AP MLD to implement single-link communications or multi-link communications with each of the respective STAs.

The T2LM component 836 may be responsible for mapping the TIDs of a traffic flow associated with a respective STA to the one or more communication links provisioned to the respective STA for communicating with the AP MLD. Specifically, the T2LM component 836 may be responsible for re-mapping the TIDs of traffic flows associated with STAs that are re-assigned communication links. For example, when the link provisioning component 822 switches communications with a respective STA from a first communication link to a second communication link, the T2LM component 836 may re-map the TIDs of all traffic flows associated with the respective STA from the first communication link to the second communication link. For another example, when the link provisioning component 822 switches communications with a respective STA from a single communication link to multiple communication links of the AP MLD, the T2LM component 836 may re-map the TIDs of all traffic flows associated with the respective STA from the single communication link to each of the multiple communication links.

In some implementations, the T2LM component 836 may also be responsible for (or at least assist with) the creation or formatting of T2LM elements transmitted to STAs after link provisioning or STA link re-assignment procedures described herein. As discussed, when there is a change in communication links used by a respective STA, the TIDs of traffic flows associated with the respective STA are re-mapped from the previous communication link or links to the new communication link or links. As such, in some aspects, the T2LM component 836 may update the TID mappings included in T2LM elements transmitted to the STAs.

The packet queues 838 may be responsible for queuing DL packets for delivery to one or more associated STAs on one or more communication links of the AP MLD. In some instances, the packet queues 838 may be implemented as part of the firmware 726 of FIG. 7. In some other instances, the packet queues 838 may be implemented as part of the hardware 728 of FIG. 7. The packet queues 838 may include any suitable number of individual queues or FIFO memories, and may be assigned to different access categories or TIDs. Although not shown for simplicity, the packet queues 838 may be associated with one or more channel access mechanisms that can implement EDCA or other channel access techniques. In some implementations, the packet queues 838 may obtain T2LM information and the MLO mode indicated for a respective traffic flow, and ensure that queued packets associated with the respective traffic flow are transmitted to the destination STA on only the communication link or links provisioned to the destination STA. For example, when all of the communication links are provisioned to a respective STA, queued packets belonging to traffic flows associated with the respective STA may be transmitted to the respective STA on any of the communication links of the AP MLD. As such, these queued packets may be randomly output for transmission on the first available communication link. For another example, when a single communication link is provisioned to a respective STA, queued packets belonging to traffic flows associated with the respective STA may be transmitted to the respective STA on only the single communication link provisioned to the respective STA. As such, these queued packets may not be randomly output for transmission on the first available communication link.

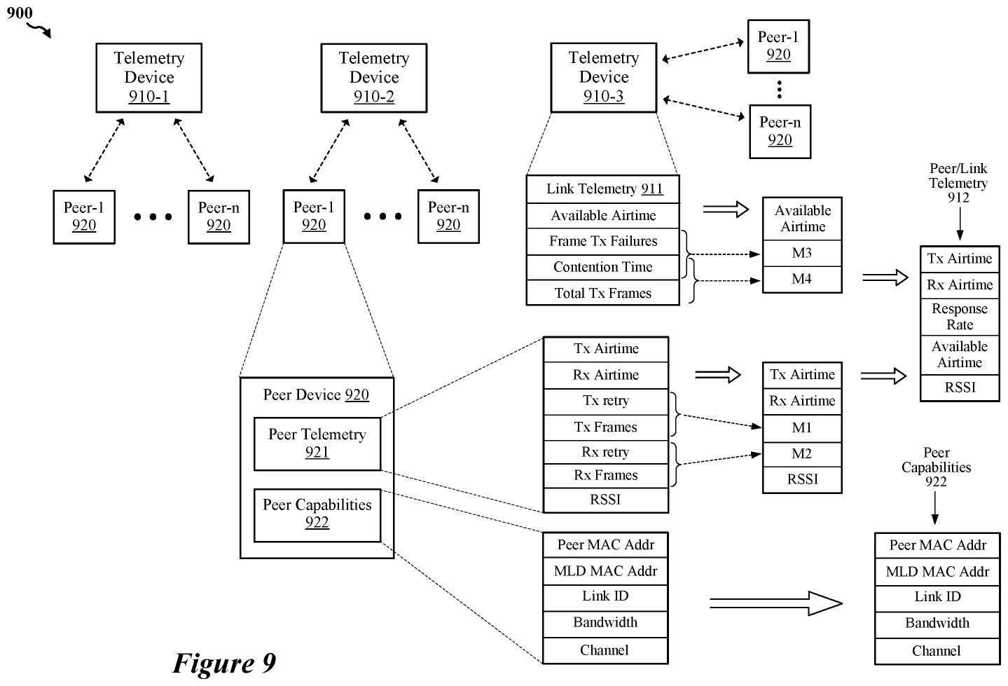

FIG. 9 shows a block diagram of an example link telemetry device 900 suitable for use in wireless communication devices disclosed herein. In some implementations, the link telemetry device 900 may be associated with the fast loop 803 described with reference to FIG. 8. For example, in some instances, the link telemetry device 900 may be included or implemented within firmware/hardware component 830 described with reference to FIG. 8 and within the firmware 726 and/or hardware 728 described with reference to FIG. 7. The link telemetry device 900 is shown to include three telemetry devices 910-1, 910-2, and 910-3 associated with three respective communication links of an AP MLD. Each of the telemetry devices 910-1, 910-2, and 910-3 may be associated with a plurality of peer devices 920 operating on the respective communication link. For example, in some instances, telemetry device 910-1 may be associated with a first communication link occupying one or more channels in the 2.4 GHz frequency band, telemetry device 910-2 may be associated with a second communication link occupying one or more channels in the 5 GHz frequency band, and telemetry device 910-3 may be associated with a third communication link occupying one or more channels in the 6 GHz frequency band. As such, in some aspects, peer devices 920 associated with telemetry device 910-1 may operate on the first communication link in the 2.4 GHz frequency band, peer devices 920 associated with telemetry device 910-2 may operate on the second communication link in the 5 GHz frequency band, and peer devices 920 associated with telemetry device 910-3 may operate on the third communication link in the 6 GHz frequency band. In various aspects, peer devices 920 that are capable of multi-link operation, such as a non-AP MLD, may be associated with more than one of the telemetry devices 910-1, 910-2, and 910-3.

Each peer device 920 may be associated with one or more peer-level metrics such as (but not limited to) peer telemetry 921 and peer capabilities 922. The peer capabilities 922 may include a peer MAC address, a MLD MAC address, a link identifier (ID), a per-link MAC address, a bandwidth, and an operating channel. The peer MAC address is the MAC address of a respective peer device 920, and the MLD MAC address is the MAC address of the corresponding AP MILD. The link ID is a value that uniquely identifies the communication link on which the respective peer device 920 operates, and the per-link MAC address is the MAC address assigned to the respective communication link. The bandwidth indicates the current bandwidth configuration of the respective peer device 920, and the operating channel indicates the wireless channel currently used by the respective peer device 920. In some instances, the peer capabilities 922 may be stored in the host controller described with reference to FIG. 8, and the host controller may provide the peer capabilities 922 to the resource manager 820 of FIG. 8 after each association procedure and/or after each change in the T2LM for a corresponding peer device 920.

The peer telemetry 921 may include a Tx Airtime value, an Rx Airtime value, a Tx Retry value, a Tx Frames value, an Rx Retry value, an Rx Frames value, and an RSSI value, among other examples. The Tx Airtime value indicates the percentage or portion of a time period that the respective peer device 920 spent transmitting UL data to the AP MLD. The Rx Airtime value indicates a percentage or portion of the time period that the respective peer device 920 spent receiving DL data from the AP MILD. In some instances, the Tx Airtime value and the Rx Airtime value may be determined or obtained by the host controller described with reference to FIG. 7. In some aspects, the Tx Airtime value may be referred to as the Transmission Airtime Consumption Percentage, and the Rx Airtime value may be referred to as the Reception Airtime Consumption Percentage.

The Tx Retry value indicates the number of frame transmission failures associated with the respective peer device 920 during the time period, and the Tx Frames value indicates the total number of frames transmitted by the respective peer device 920 during the time period. The Rx Retry value indicates the number of frame reception failures associated with the respective peer device 920 during the time period, and the Rx Frames value indicates the total number of frames received by the respective peer device 920 during the time period. The RSSI value indicates an average RSSI value of frames received from the respective peer device 920 during the time period. In some aspects, the RSSI values may be determined or obtained by the host controller described with reference to FIG. 7.

In some instances, the peer telemetry 921 may also include an M1 value and an M2 value, where the M1 value indicates the ratio of the Tx Retry value over the Tx Frames value, and the M2 value indicates the ratio of the Rx Retry value over the Rx Frames value. As such, the M1 value may indicate the percentage of frames transmitted by the respective peer device 920 that resulted in transmission failure, and the M2 value may indicate the percentage of frames sent to the respective peer device 920 that resulted in reception failure. In this way, the M1 value may be used to monitor UL transmissions from the respective peer device 920 during the time period, and the M2 value may be used to monitor DL transmissions from the respective peer device 920 during the time period.

In various implementations, each of the telemetry devices 910-1, 910-2, and 910-3 may be associated with a corresponding link telemetry 911 that includes an Available Airtime value, a Contention Time value, a Tx Frame Failure value, and a Total Tx Frames value for a respective communication link of the AP MLD. The Available Airtime value indicates the percentage of a period of time that the respective communication link is available for transmissions to or from the AP MLD. In some instances, the period of time may have a duration of approximately five seconds (other durations may be used in other instances). In various aspects, the Available Airtime value may also be an indication of the percentage of the period of time that OBSS interference rendered the respective communication link busy (and therefore not available to corresponding peer devices 920). The Contention Time value indicates the medium or average amount of time that packets queued for transmission waited for access to the respective communication link during the time period. The Tx Frame Failure value indicates the number of frame transmission failures on the respective communication link during the time period, and the Total Tx Frames value indicates the total number of frames transmitted on the respective communication link during the time period.

In some instances, the link telemetry 911 may also include an M3 value indicating the sum of the Contention Time values across all access categories for the respective communication link, and an M4 value indicating the ratio of the Tx Frame Failure value over the Total Tx Frames value for the respective communication link. As such, the M3 value may indicate the average amount of time that queued packets waited for link access across all access categories during the time period, and the M4 value may indicate the percentage of frames transmitted on the respective communication link that resulted in transmission failure during the time period. In this way, the M3 value may be used to monitor DL transmissions on the respective communication link during the time period, and the M4 value may be used to monitor UL transmissions on the respective communication link during the time period.

In various implementations, the peer devices 920-1, 920-2, and 920-3 may provide their respective Available Airtime, M3, and M4 values to the fast loop 803 described with reference to FIG. 8. In some instances, the host controller described with reference to FIG. 8 may aggregate the Available Airtime, M3, and M4 values received from respective peer devices 920-1, 920-2, and 920-3, along with the Tx Airtime, Rx Airtime, M1, M2, and RSSI values, to form per-link peer telemetry 912. As shown in FIG. 9, the per-link peer telemetry 912 includes the Tx Airtime value, the Rx Airtime value, a Response Rate value, the Available Airtime value, and the RSSI value. In some instances, the host controller may use the values of M1-M4 to determine or obtain the Response Rate value, which may indicate the average response time of the peer devices 920-1, 920-2, and 920-3. In various aspects, the AP MLD 720 of FIG. 7 or the apparatus 800 of FIG. 8 may use the per-link peer telemetry 912 when provisioning communication links to peer devices 920-1, 920-2, and 920-3 and/or when re-assigning the peer devices 920-1, 920-2, and 920-3 among the communication links associated with the AP MLD 720 of FIG. 7 or the apparatus 800 of FIG. 8.

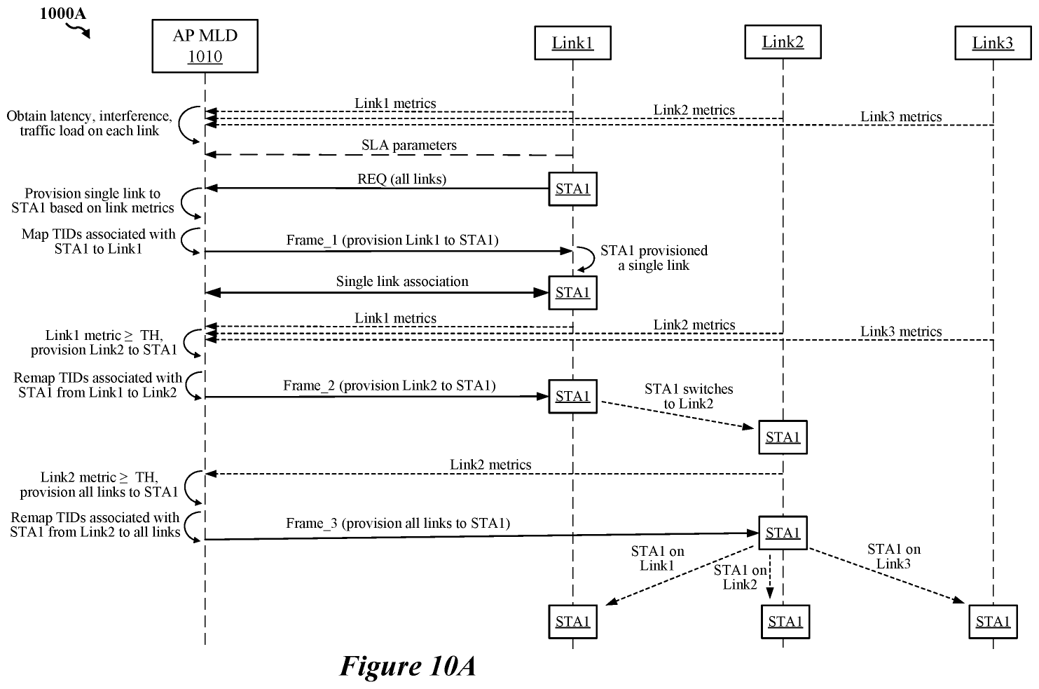

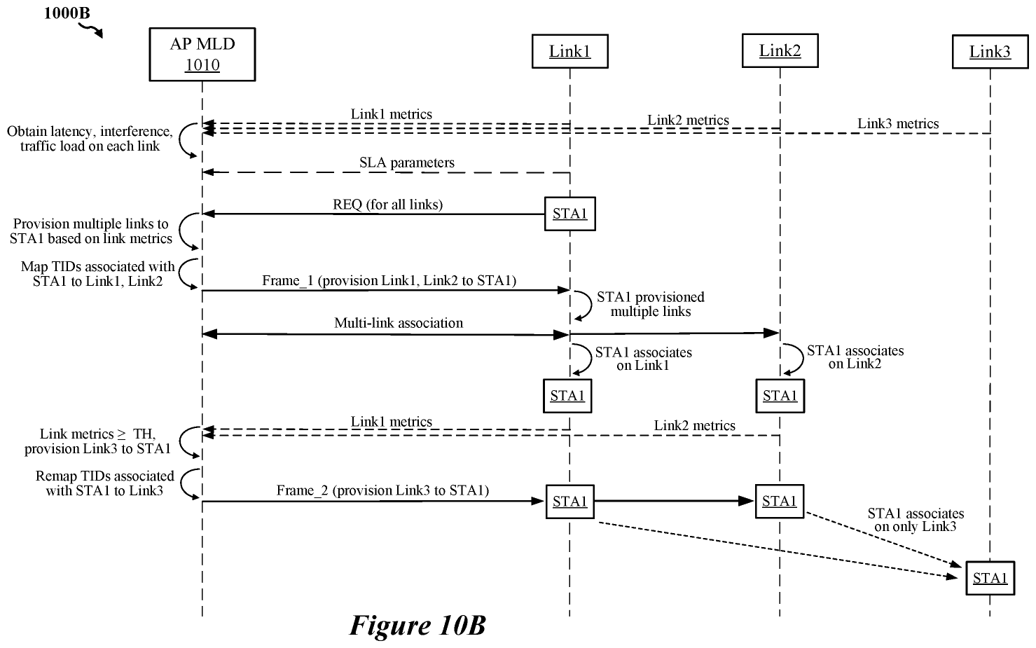

FIG. 10A shows a sequence diagram depicting an example wireless communication 1000A that supports selective provisioning of the communication links of an AP MLD to one or more associated STAs, according to some implementations. The wireless communication 1000A may be performed between an AP MLD 1010 and at least a first station (STA1). The AP MLD 1010 may be any wireless device capable of multi-link operation. In some instances, the AP MLD 1010 may be one example of the AP MLD 610 of FIG. 6 or the AP MLD 720 of FIG. 7. STA1 may be any suitable wireless station, client device, user equipment (UE), or apparatus that implements the STA. In some instances, STA1 may be an example of one of the STAs 104 of FIG. 1, the wireless communication device 400 of FIG. 4, or the STA 504 of FIG. 5B. In some other instances, STA1 may be an example of the non-AP MILD 620 of FIG. 6. For example, in some aspects, STA1 may be included in a non-AP MLD that also includes one or more other STAs that may also be associated with one or more communication links of the AP MLD 1010. Although the example of FIG. 10A shows one station STA1 in communication with the AP MLD 1010, in other implementations, the AP MLD 1010 may communicate with other numbers of STAs.

In the example of FIG. 10A, the AP MLD 1010 is associated with a first communication link (Link1), a second communication link (Link2), and a third communication link (Link3). In some instances, Link1 may be one or more wireless channels in the 2.4 GHz frequency band, Link2 may be one or more wireless channels in the 5 GHz frequency band, and Link3 may be one or more wireless channels in the 6 GHz frequency band. In other implementations, Link1-Link3 may be associated with other suitable frequency bands. In some other instances, the AP MLD 1010 may be associated with other numbers of communication links (not shown for simplicity).

In various implementations, the AP MLD 1010 may obtain one or more link metrics for each of Link1-Link3. The link metrics for a respective communication link may include latencies, interference levels, or traffic loads, among other examples. In some instances, the AP MLD 1010 may obtain link metrics from STAs (or other client devices) operating on one or more of Link1-Link3. In other instances, the AP MLD 1010 may obtain the link metrics from the operator cloud 710 described with reference to FIGS. 7-8. In some aspects, the AP MLD 1010 may use one or more of the obtained link metrics when provisioning communication links to STA1.

The AP MLD 1010 may also obtain one or more SLA parameters associated with traffic flows on Link1-Link3. For example, in some instances, the AP MLD 1010 may obtain the SLA parameters for STA1 based on a service level agreement (SLA) or QoS agreement. The SLA parameters may include a minimum data rate, a maximum delay bound, a service interval, a burst size, or a throughput requirement, among other examples. In some aspects, the AP MLD 1010 may use one or more of the SLA parameters associated with STA1 when provisioning communication links to STA1 for communicating with the AP MLD 1010.

In the example of FIG. 10A, STA1 sends a request (REQ) for association to the AP MLD 1010 on Link1. The request may indicate whether STA1 supports operation on each of Link1-Link3, and may indicate whether STA1 operates as an EMLMR device or an EMLSR device (or as an NSTR device). In some aspects, the request may be included in a multi-link association request frame or a multi-link probe request frame. The multi-link association request frames and multi-link probe request frames may include MLD capabilities, operating channels, operating parameters, and other multi-link information pertaining to STA1. In the example of FIG. 10A, STA1 requests association with the AP MLD 1010 on all of Link1-Link3.

The AP MLD 1010 receives the request, may determine which of Link1-Link3 are supported by STA1, and may exclude communication links not supported by STA1 from link provisioning. For example, if STA1 does not support operation on the 6 GHz frequency band, then the AP MLD 1010 may not provision Link3 to STA1, thereby leaving Link1 and Link2 as candidates for provisioning communication links to STA1. For another example, if STA1 supports operation on all of Link1-Link3, the AP MLD 1010 may provision any (or all) of Link1-Link3 to STA1 for communicating with the AP MLD 1010.

In various implementations, the AP MLD 1010 uses at least one of the latency, the interference level, or the traffic load associated with each of Link1-Link3 to determine whether to provision a single communication link or multiple communication links to STA1 for communicating with the AP MLD 1010. For example, if the latencies and interference levels on Link2 and Link3 are at least equal to respective latency and interference thresholds, and the latencies and interference levels on Link1 are less than the respective latency and interference thresholds, the AP MLD 1010 may provision only Link1 to STA1 for communicating with the AP MLD 1010. In this way, the AP MLD 1010 may steer STA1 to the communication link associated with the lowest latency or least amount of interference (or lowest traffic load). For another example, if the latencies and interference levels on each of Link1-Link3 are greater than the respective latency and interference thresholds (thereby indicating relatively poor channel quality or relatively high latencies), the AP MLD 1010 may provision all of Link1-Link3 to STA1 for communicating with the AP MLD 1010. By allowing STA1 to use any one or more of Link1-Link3 to communicate with the AP MLD 1010 when each of Link1-Link3 is associated with relatively poor channel quality or relatively high latencies, aspects of the present disclosure may increase the likelihood of STA1 meeting certain latency and throughput requirements. In some aspects, the AP MLD 1010 may also use one or more of the SLA parameters associated with STA1 to determine whether to provision the single communication link or multiple communication links to STA1 for communicating with the AP MLD 1010.

In some implementations, one or more of the latency threshold, the interference threshold, or the traffic load threshold may be obtained from a network entity, for example, via the cloud operator 710 of FIGS. 7-8. In some instances, the network entity may dynamically adjust or re-configure one or more of the latency threshold, the interference threshold, or the traffic load threshold. In this way, the network entity can dynamically adjust the conditions (or parameters) under which the AP MLD 1110 provisions either a single communication link or multiple communication links to STA1.

In the example of FIG. 10A, the AP MLD 1010 provisions Link1 as the single communication link to STA1 based on at least one of the link metrics. The AP MLD 1010 may determine or obtain the TIDs of traffic flows associated with STA1, and map the TIDs of the traffic flows to Link1. The AP MLD 1010 may also determine or obtain the TIDs of traffic flows associated with one or more other STAs, and may map the TIDs of the traffic flows to the respective communication links. In some instances, the AP MLD 1010 may generate a Traffic Identifier (TID)-to-Link Mapping (T2LM) element indicating, for each of a plurality of TIDs, one or more communication links on which traffic flows of the respective TID can be transmitted.

Specifically, the AP MLD 1010 generates a first frame indicating that a single communication link (Link1) is provisioned to STA1. The first frame may include a T2LM element indicating that the TIDs of traffic flows associated with STA1 are mapped to Link1. In some aspects, the T2LM element may also indicate the specific communication links to which each of a plurality of TIDs associated with other traffic flows are mapped. In some instances, the first frame may be a multi-link association response frame responsive to an association request frame obtained from STA1, or may be a multi-link probe response frame responsive to a probe request frame obtained from STA1. The multi-link association response frame and the multi-link probe response frame may include MLD capabilities, operating channels, operating parameters, and other discovery information for establishing multi-link operation with the AP MLD 1010. In some aspects, the first frame may be a directed action frame indicating the TID mappings for STA1.

The AP MLD 1010 transmits the first frame to STA1 on Link1. STA1 receives the first frame, decodes the T2LM element included in the first frame, and determines that the TIDs of traffic flows associated with STA1 are mapped to Link1 (thereby provisioning Link1 to STA1 for communications with the AP MLD 1010). In various aspects, STA1 may use discovery information, MLD capabilities, MLD parameters, and other multi-link information included in the first frame to associate and authenticate with the AP MLD 1010 on Link1. Thereafter, STA1 may communicate with the AP MLD 1010 on Link1.

In the example of FIG. 10A, the AP MLD 1010 obtains a first indication of at least one of the latency, interference level, or traffic load associated with Link1 being at least equal to the respective latency threshold, interference threshold, or traffic load threshold. In various aspects, the first indication may signal that Link1 is associated with greater latencies and lower throughput than Link2 or Link3. As such, in some instances, the AP MLD 1010 may switch communications with STA1 from Link1 to one of Link2 or Link3, for example, to reduce latencies and increase throughput associated with the transmission of traffic flows to or from STA1.

In the example of FIG. 10A, the AP MLD 1010 switches communications with STA1 from Link1 to Link2 based on the first indication. Specifically, the AP MLD 1010 re-maps the TIDs of traffic flows associated with STA1 from Link1 to Link2, and updates the T2LM element. In some instances, the AP MLD 1010 generates a second frame that includes the updated T2LM element, and transmits the second frame to STA1 on Link1. In some aspects, the second frame may be a directed action frame indicating the TID re-mappings for STA1.

STA1 receives the second frame, decodes the T2LM element included in the second frame, and determines that the TIDs of traffic flows associated with STA1 are re-mapped to Link2 (thereby provisioning Link2 to STA1 for communications with the AP MLD 1010). As such, STA1 switches operation from Link1 to Link2, and thereafter STA1 may communicate with the AP MLD 1010 on Link2.

In the example of FIG. 10A, the AP MLD 1010 obtains a second indication of at least one of the latency, interference level, or traffic load associated with Link2 being at least equal to the respective latency threshold, interference threshold, or traffic load threshold. In various aspects, the second indication may signal that Link2 is not associated with lower latencies or greater throughput than Link1, and that enabling multi-link communication with STA1 may result in lower latencies and/or greater throughput than single-link communication with STA1. As such, in some instances, the AP MLD 1010 may provision all of the communication links (Link1-Link3) to STA1 based on the second indication.

Specifically, the AP MLD 1010 re-maps the TIDs of traffic flows associated with STA1 from Link1 to each of Link1-Link3, and updates the T2LM element with the new TID mappings. In some instances, the AP MLD 1010 generates a third frame that includes the updated T2LM element, and transmits the third frame to STA1 on Link2. STA1 receives the third frame, decodes the T2LM element included in the third frame, and switches its association with the AP MLD 1010 from Link1 to all of Link1-Link3 without disassociating from or reassociating with the AP MLD 1010.

Thus, rather than provisioning another single link to STA1 based on the second indication, the AP MLD 1010 may reduce latencies and/or increase throughput associated with traffic flows transmitted to or from STA1 by enabling STA1 to operate on any one or more of Link1-Link3. For example, when multi-link communication is enabled for STA1, DL packets queued in the AP MLD 1010 can be transmitted to STA1 on the first available communication link associated with the AP MLD 1010. Similarly, UL packets queued in STA1 can be transmitted to the AP MLD 1010 on the first available communication link.

In some implementations, the AP MLD 1010 may reserve one of Link1-Link3 for latency-sensitive traffic. For example, in some instances, the AP MLD 1010 reserves Link3, which occupies one or more wireless channels in the 6 GHz frequency band, for latency-sensitive traffic. In some aspects, the AP MLD 1010 maintains latencies, interference levels, and traffic loads associated with the reserved Link3 below the respective latency threshold, interference threshold, and traffic load threshold. In some other aspects, the AP MLD 1010 ensures that at least a certain capacity or bandwidth of Link3 remains available for latency-sensitive traffic. In this way, the AP MLD 1010 may advertise Link3 as a premium or pristine communication link on which latency-sensitive traffic can be transmitted without violating the strict end-to-end latency and throughput requirements associated with such latency-sensitive traffic.

In some instances, the AP MLD 1010 may obtain an indication of at least one of the latency, interference level, or traffic load associated with the reserved communication link being at least equal to the respective latency threshold, interference threshold, or traffic load threshold. In some aspects for which STA1 is associated with latency-sensitive traffic, the AP MLD 1010 may switch communications between the AP MLD 1010 and one or more other STAs (not shown for simplicity) from the reserved communication link to one or more other communication links of the AP MLD 1010 based on the indication. In this way, STA1 remains on the reserved communication link, and the AP MLD 1010 reduces latencies and traffic loads on the reserved communication link by moving the one or more other STAs from the reserved communication link to one or more other communication links.

FIG. 10B shows a sequence diagram depicting another example wireless communication 1000 that supports selective provisioning of the communication links of an AP MLD to one or more associated STAs, according to some implementations. The wireless communication 1000 may be performed between the AP MLD 1010 and STA1 described with reference to FIG. 10A. As discussed, the AP MLD 1010 may obtain one or more link metrics for each of Link1-Link3, and may also obtain one or more SLA parameters associated with traffic flows on Link1-Link3. In some instances, the AP MLD 1010 may use at least one of the link metrics when provisioning communication links to STA1 (and to one or more other associated STAs, not shown for simplicity).

In some implementations, one or more of the latency threshold, the interference threshold, or the traffic load threshold may be obtained from a network entity, for example, via the cloud operator 710 of FIGS. 7-8. In some instances, the network entity may dynamically adjust or re-configure one or more of the latency threshold, the interference threshold, or the traffic load threshold. In this way, the network entity can dynamically adjust the conditions (or parameters) under which the AP MLD 1110 provisions either a single communication link or multiple communication links to STA1.

In the example of FIG. 10B, STA1 sends a request for association to the AP MLD 1010 on Link1. The request may indicate whether STA1 supports operation on each of Link1-Link3, and may indicate whether the STA operates as an EMLMR device or an EMLSR device (or an NSTR device). In some aspects, the request may be included in a multi-link association request frame or a multi-link probe request frame. The multi-link association request frames and multi-link probe request frames may include MILD capabilities, operating channels, operating parameters, and other multi-link information pertaining to STA1. In the example of FIG. 10B, STA1 requests association with the AP MLD 1010 on all of Link1-Link3.

The AP MLD 1010 receives the request, and determines which of Link1-Link3 are supported by STA1. As discussed, the AP MLD 1010 may use at least one of the latency, interference level, or traffic load associated with each of Link1-Link3 to determine whether to provision a single communication link or multiple communication links to STA1 for communicating with the AP MLD 1010. In the example of FIG. 10B, the AP MLD 1010 provisions Link1 and Link2 as the multiple communication links for STA1 to communicate with the AP MLD 1010. The AP MLD 1010 may determine or obtain the TIDs of traffic flows associated with STA1, and map the TIDs of the traffic flows to each of Link1 and Link2. The AP MLD 1010 may also determine or obtain the TIDs of traffic flows to or from one or more other STAs (not shown for simplicity), and map the TIDs of the traffic flows to one or more respective communication links provisioned by the AP MLD 1010. In some instances, the AP MLD 1010 generates a T2LM element indicating which of Link1-Link3 are available for transmitting (or receiving) traffic flows associated with each of the TIDs.

In some implementations, the AP MLD 1010 generates a first frame indicating that multiple communication links (Link1 and Link2) of the AP MLD 1010 are provisioned to STA1. The first frame may include a T2LM element indicating that the TIDs of traffic flows associated with STA1 are mapped to each of Link1 and Link2. In some aspects, the T2LM element may also indicate the specific communication links to which each of a plurality of TIDs associated with other traffic flows are mapped. In some instances, the first frame may be a multi-link association response frame responsive to an association request frame obtained from STA1, or may be a multi-link probe response frame responsive to a probe request frame obtained from STA1. The multi-link association response frame and the multi-link probe response frame may include MLD capabilities, operating channels, operating parameters, and other discovery information for establishing multi-link operation with the AP MLD 1010. In some aspects, the first frame may be a directed action frame indicating the TID mappings for STA1.

The AP MLD 1010 transmits the first frame to STA1 on Link1. STA1 receives the first frame, decodes the T2LM element included in the first frame, and determines that the TIDs of traffic flows associated with STA1 are mapped to Link1 and Link2 (thereby provisioning Link1 and Link2 to STA1 for communications with the AP MLD 1010). As discussed, STA1 may use discovery information, MLD capabilities, MLD parameters, and other multi-link information included in the first frame to associate and authenticate with the AP MLD 1010 on Link1 and Link2. In this way, STA1 may establish a multi-link association with the AP MLD 1010 on Link1 and Link2.

In the example of FIG. 10B, the AP MLD 1010 obtains an indication of at least one of the latency, interference level, or traffic load associated with one or both of Link1 and Link2 being at least equal to the respective latency threshold, interference threshold, or traffic load threshold. In some instances, the indication may signal that Link1 and Link2 are associated with higher latencies and/or lower throughput than Link3. As such, in some aspects, the AP MLD 1010 may switch STA1 from multi-link communications to single-link communications based on the indication. In this way, aspects of the present disclosure may reduce latencies and increase throughput of traffic flows associated with STA1.

In the example of FIG. 10B, the AP MLD 1010 provisions Link3 to STA1 based on the indication. Specifically, the AP MLD 1010 re-maps the TIDs of traffic flows associated with STA1 from the multi-link operation on Link1-Link2 to a single-link operation on Link3, and updates the T2LM element. In some instances, the AP MLD 1010 generates a second frame that includes the updated T2LM element, and transmits the second frame to STA1 on one or both of Link1 and Link2. In some aspects, the second frame may be a directed action frame indicating the TID re-mappings for STA1. STA1 receives the second frame, decodes the T2LM element, and switches from multi-link operation on Link1 and Link2 to single-link operation on Link3 based on the T2LM element included in the second frame. In this way, the AP MLD 1010 may switch communications with STA1 from multiple communication links to a single communication link without disassociating from or reassociating with STA1.

In some implementations, the AP MLD 1010 may reserve one of Link1-Link3 for latency-sensitive traffic. For example, in some instances, the AP MLD 1010 reserves Link3, which occupies one or more wireless channels in the 6 GHz frequency band, for latency-sensitive traffic. In some aspects, the AP MILD 1010 maintains latencies, interference levels, and traffic loads associated with the reserved Link3 below the respective latency threshold, interference threshold, and traffic load threshold. In some other aspects, the AP MLD 1010 ensures that at least a certain capacity or bandwidth of Link3 remains available for latency-sensitive traffic. In this way, the AP MLD 1010 may advertise Link3 as a premium or pristine communication link on which latency-sensitive traffic can be transmitted without violating the strict end-to-end latency and throughput requirements associated with such latency-sensitive traffic.

In some instances, the AP MLD 1010 may obtain an indication of at least one of the latency, interference level, or traffic load associated with the reserved communication link being at least equal to the respective latency threshold, interference threshold, or traffic load threshold. In some aspects for which STA1 is associated with latency-sensitive traffic, the AP MLD 1010 may switch communications between the AP MLD 1010 and one or more other STAs (not shown for simplicity) from the reserved communication link to one or more other communication links of the AP MLD 1010 based on the indication. In this way, STA1 remains on the reserved communication link, and the AP MLD 1010 reduces latencies and traffic loads on the reserved communication link by moving the one or more other STAs from the reserved communication link to one or more other communication links.

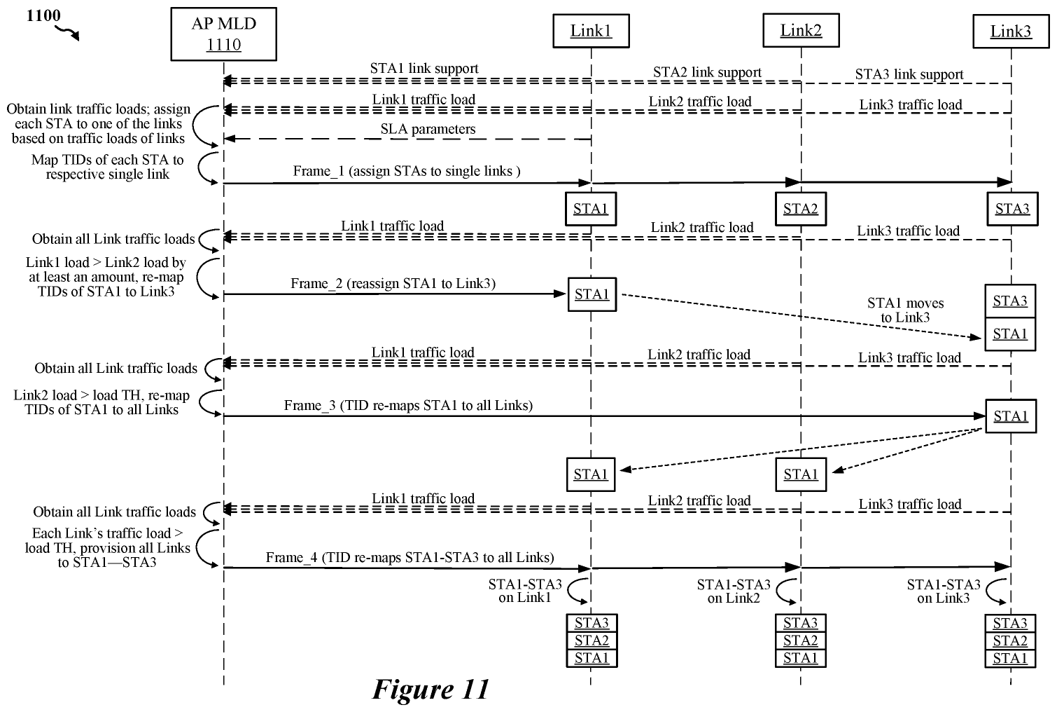

FIG. 11 shows a sequence diagram depicting an example wireless communication 1100 that supports the selective assignment (and re-assignment) of one or more STAs to communication links associated with an MILD, according to some implementations. The example wireless communication 1100 may be performed between an AP MLD 1110 and stations STA1-STA3. In some instances, the AP MLD 1100 may be one example of the AP MLD 610 of FIG. 6 or the AP MLD 720 of FIG. 7. In some other instances, the AP MLD 1100 may be an example of the AP MLD 1010 of FIG. 10A or FIG. 10B. In the example of FIG. 11, the AP MLD 1110 is associated with Link1, Link2, and Link3, as described with reference to FIG. 10A. The stations STA1-STA3 may be any suitable wireless station, client device, UE, or apparatus that implements the STA. In some instances, the stations STA1-STA3 may be examples of the STAs 104 of FIG. 1, the wireless communication device 400 of FIG. 4, or the STA 504 of FIG. 5B. In some other instances, the stations STA1-STA3 may be an example of the non-AP MLD 620 of FIG. 6. For example, in some aspects, each of the stations STA1-STA3 may be included in a respective non-AP MILD that also includes one or more other STAs that may be associated with one or more communication links of the AP MLD 1110. Although the example of FIG. 11 shows three stations STA1-STA3 in communication with the AP MLD 1110, in other implementations, the AP MLD 1110 may communicate with other numbers of STAs.

As discussed, the AP MLD 1110 may obtain one or more link metrics for each of Link1-Link3, and may also obtain one or more SLA parameters associated with traffic flows on Link1-Link3. In some instances, the AP MLD 1110 may use at least one of the link metrics when assigning each of STA1-STA3 to one or more communication links of the AP MLD 1110. In some implementations, the AP MLD 1110 may obtain, from each of STA1-STA3 (and other associated STAs, not shown for simplicity), an indication of whether the respective STA supports operation on each of Link1-Link3.

In some aspects, the AP MLD 1110 may use the indications of link support when assigning each of STA1-STA3 to one or more of the communication links. For example, if STA1 indicates support for operation in the 2.4 GHz and 5 GHz frequency bands, and does not indicate support for operation in the 6 GHz frequency band, the AP MLD 1110 may not assign STA1 to Link3 (which includes one or more wireless channels in the 6 GHz frequency band, as discussed with reference to FIG. 10A). For another example, if STA2 indicates support for each of Link1-Link3, then AP MLD 1110 may assign STA2 to any one or more of Link1-Link3. In some instances, the indications may be included in multi-link association request frames or multi-link probe request frames transmitted to the AP MLD 1110. As discussed, multi-link association request frames and multi-link probe request frames may include MLD capabilities, operating channels, operating parameters, and other multi-link information pertaining to respective stations STA1-STA3.

In the example of FIG. 11, the AP MLD 1110 assigns each of STA1-STA3 to a single communication link based at least in part on the amount of traffic on each of the communication links. Specifically, the AP MLD 1110 assigns STA1 to Link1, assigns STA2 to Link2, and assigns STA3 to Link3. The AP MLD 1110 may map one or more TIDs of traffic flows associated with each of STA1-STA3 to Link1-Link3, respectively. The MLD 1110 generates a first frame, for each of STA1-STA3, indicating the assigned communication link and TID mappings, and transmits the first frames to STA1-STA3 on Link1-Link3, respectively. Each of the first frames may include a T2LM element indicating the TID mappings for a respective one of STA1-STA3. In some instances, the first frames may be multi-link association response frames transmitted in response to association request frames obtained from respective stations STA1-STA3. In other instances, the first frames may be multi-link probe response frames transmitted in response to probe request frames obtained from respective stations STA1-STA3. In some aspects, the first frames may be directed action frames indicating the TID re-mappings for the respective stations STA1-STA3.

Each of STA1-STA3 receives a respective first frame, decodes the T2LM element included in the respective first frame, and uses the decoded T2LM element to determine the communication link to which the respective STA is assigned. As discussed, STA1 is assigned to Link1, STA2 is assigned to Link2, and STA3 is assigned to Link3. The stations STA1-STA3 may use discovery information, MLD capabilities, MLD parameters, and other multi-link information included in the respective first frames to associate and authenticate with the AP MLD 1110 on Link1-Link3, respectively. Thereafter, STA1 may communicate with the AP MLD 1110 on Link1, STA2 may communicate with the AP MLD 1110 on Link2, and STA3 may communicate with the AP MLD 1110 on Link3.

In some implementations, the AP MLD 1110 may continuously or periodically obtain link metrics associated with each of Link1-Link3. In the example of FIG. 11, the AP MLD 1110 obtains a first indication of the traffic load on Link1 being greater than the traffic load on Link3 by at least a threshold amount. The threshold amount may correspond to a certain loading imbalance between Link1 and Link3, may correspond to a certain latency or interference level of Link1 relative to Link3, or may be any other suitable amount or value. In some instances, the threshold amount may be obtained from a network entity, for example, via the cloud operator 710 of FIGS. 7-8. In this way, the network entity can dynamically adjust the conditions (or parameters) under which the AP MLD 1110 re-assigns STAs from one communication link to another communication link.

In the example of FIG. 11, the AP MLD 1110 re-assigns STA1 from Link1 to Link3 based on the first indication. Specifically, the AP MLD 1110 re-maps the TIDs of traffic flows associated with STA1 from Link1 to Link3, updates the T2LM element to include the TID mappings to Link3, and generates a second frame that includes the updated T2LM element. Although not shown for simplicity, the AP MLD 1110 may also re-assign one or more other STAs from Link1 to Link3 (or Link2), remap their respective TIDs to Link3 (or Link2), and generate one or more other second frames including the respective updated T2LM elements. The AP MLD 1110 transmits the second frame to STA1 on Link1. In some instances, the second frame may be a directed action frame indicating the TID re-mapping for STA1.

STA1 receives the second frame, decodes the T2LM element included in the second frame, and determines that the TIDs of traffic flows associated with STA1 are re-mapped from Link1 to Link3 (thereby re-assigning STA1 from Link1 to Link3). STA1 switches operation from Link1 to Link3, and thereafter communicates with the AP MLD 1110 on Link3.

As discussed with reference to FIG. 10B, the AP MLD 1110 may reserve Link3, which occupies one or more wireless channels in the 6 GHz frequency band, for latency-sensitive traffic. In some implementations, the AP MLD 1110 maintains latencies, interference levels, and traffic loads associated with the reserved Link3 below the respective latency threshold, interference threshold, and traffic load threshold. In some instances, the AP MLD 1110 may ensure that at least a certain capacity or bandwidth of Link3 remains available for latency-sensitive traffic. For example, in some aspects, the AP MLD 1110 maintains STAs associated with latency-sensitive traffic on Link3 while switching communications with non-latency-sensitive STAs from Link3 to Link1 or Link2. In this way, the AP MLD 1110 may maintain Link3 as a premium or pristine communication link on which latency-sensitive traffic can be transmitted without violating the strict end-to-end latency and throughput requirements associated with such latency-sensitive traffic.

In the example of FIG. 11, the AP MLD 1110 obtains a second indication that the traffic load on Link3 is at least equal to a load threshold. The load threshold may correspond to a certain loading imbalance between Link3 and one or both of Link1-Link2, may correspond to a certain latency or interference level of Link1 relative to one or both of Link1-Link2, or may be any other suitable amount or value. In some instances, the load threshold may be obtained from a network entity, for example, via the cloud operator 710 of FIGS. 7-8. In this way, the network entity can dynamically adjust the conditions (or parameters) under which the AP MLD 1110 re-assigns STAs from one communication link to another communication link.

In some implementations, the AP MLD 1110 may provision all of Link1-Link3 to at least some of the STAs initially assigned to Link3 based on the second indication. In some instances, the AP MLD 1110 provisions all of Link1-Link3 to each STA on Link3 having a throughput that is less than a first threshold or associated with a traffic load that is at least equal to a second threshold. In other instances, the AP MLD 1110 may form a group of STAs operating on Link3 based on the combined throughput of the grouped STAs, and provision all of Link1-Link3 to each STA in the group. In some other instances, the AP MLD 1110 may form a group of STAs operating on Link3 based on the combined load of the grouped STAs, and provision all of Link1-Link3 to each STA in the group.

In the example of FIG. 11, the AP MLD 1110 provisions each of Link1-Link3 to STA1, for example, by re-assigning STA1 from Link3 to each of Link1-Link3 based on the second indication. Specifically, the AP MLD 1110 re-maps the TIDs of traffic flows associated with STA1 from Link3 to each of Link1-Link3, updates the T2LM element to include the TID mappings to each of Link1-Link3, and generates a third frame that includes the updated T2LM element. Although not shown for simplicity, the AP MLD 1110 may also re-assign one or more other STAs from Link3 to each of Link1-Link3 based on the second indication. The AP MLD 1110 transmits the third frame to STA1 on Link3. In some instances, the third frame may be a directed action frame indicating the TID re-mappings for STA1.

STA1 receives the third frame, decodes the T2LM element included in the third frame, and determines that the TIDs of traffic flows associated with STA1 are re-mapped from Link3 to each of Link1-Link3 (thereby re-assigning STA1 to each of Link1-Link3). STA1 switches operation from Link3 to all of Link1-Link3, and may thereafter communicate with the AP MLD 1110 on any one or more of Link1-Link3.

In the example of FIG. 11, the AP MLD 1110 obtains a third indication that the traffic load on each of the communication links is at least equal to the load threshold, and provisions all of the communication links to each STA associated with the AP MLD 1110. Specifically, the AP MLD 1110 re-maps the TIDs of traffic flows associated with STA2 from Link2 to each of Link1-Link3, and re-maps the TIDs of traffic flows associated with STA3 from Link3 to each of Link1-Link3. The AP MLD 1110 updates the T2LM elements associated with STA2 and STA3 to include their respective TID re-mappings to each of Link1-Link3, and generates corresponding fourth frames that include the respective updated T2LM elements. Although not shown for simplicity, the AP MLD 1110 may also re-assign other associated STAs from Link3 to each of Link1-Link3 based on the third indication. The AP MLD 1110 transmits the fourth frames to STA2 and STA3 on Link2 and Link3, respectively. In some instances, the fourth frames may be directed action frames indicating the respective TID re-mappings for STA2 and STA3.

STA2 receives the fourth frame on Link2, decodes the T2LM element included in the fourth frame, and determines that the TIDs of traffic flows associated with STA2 are re-mapped from Link2 to each of Link1-Link3 (thereby re-assigning STA2 to each of Link1-Link3). STA2 switches operation from Link2 to all of Link1-Link3, and may thereafter communicate with the AP MLD 1110 on any one or more of Link1-Link3. Similarly, STA3 receives the fourth frame on Link3, decodes the T2LM element included in the fourth frame, and determines that the TIDs of traffic flows associated with STA3 are re-mapped from Link3 to each of Link1-Link3 (thereby re-assigning STA3 to each of Link1-Link3). STA3 switches operation from Link3 to all of Link1-Link3, and may thereafter communicate with the AP MLD 1110 on any one or more of Link1-Link3.

In some other implementations, the AP MLD 1110 may obtain an indication of a violation of one or more SLA parameters by at least one STA assigned to the reserved Link3. In some instances, the AP MLD 1110 re-assigns one or more other STAs from Link3 to one or both of Link1 or Link2 based on the indicated SLA violation. For example, the AP MLD 1110 may obtain an indication that STA1 violated a latency or throughput requirement of an associated SLA, and re-assign STA3 from Link3 to Link2 based on the indication. Specifically, the AP MLD 1110 re-maps the TIDs of traffic flows associated with STA3 from Link3 to Link2, updates the T2LM element to include the TID mappings to Link2, and generates a fifth frame (not shown for simplicity) that includes the updated T2LM element. The AP MLD 1110 transmits the fifth frame to STA3 on Link3, and STA3 switches operation from Link3 to Link2. In some instances, the fifth frame may be a directed action frame indicating the TID re-mappings for STA3. By moving traffic associated with STA3 from Link3 to Link2, the AP MLD 1110 may reduce traffic on Link3, which in turn may decrease the latencies and/or increase the throughput associated with STA1.

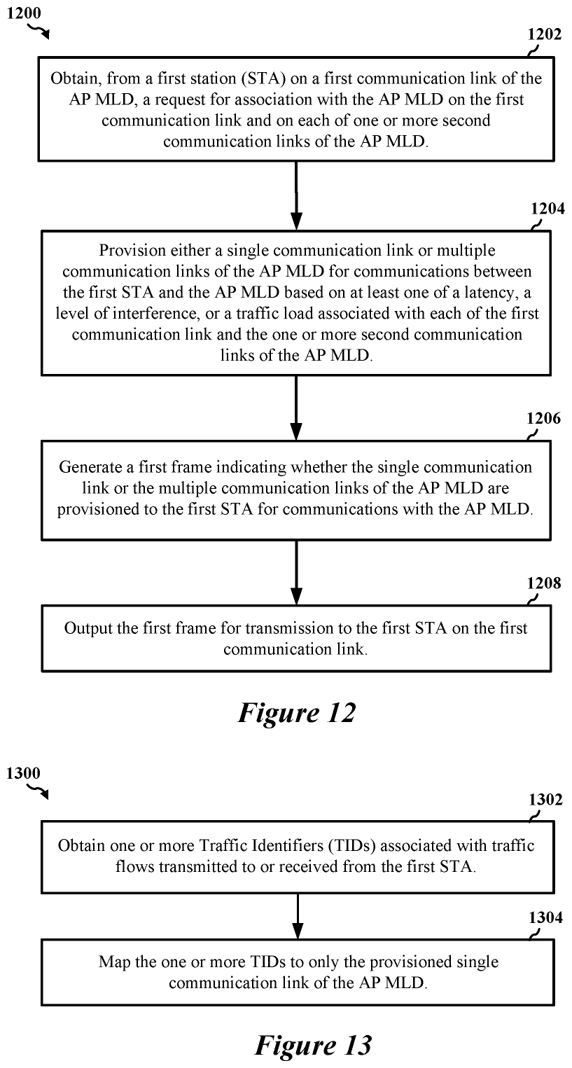

FIG. 12 shows a flowchart illustrating an example operation 1200 for wireless communication that supports selectively provisioning the communication links of an AP MLD to one or more associated STAs, according to some implementations. The operation 1200 may be performed by an apparatus such as the wireless communication device 400 described with reference to FIG. 4. In some implementations, the operation 1200 may be performed by an AP MLD such as the AP MLD 610 of FIG. 6 or the AP MLD 720 of FIG. 7.

For example, at 1202, the AP MLD obtains, from a first station (STA) on a first communication link of the AP MILD, a request for association with the AP MLD on the first communication link and on each of one or more second communication links of the AP MILD. At 1204, the AP MLD provisions either a single communication link or multiple communication links of the AP MLD for communications between the first STA and the AP MLD based on at least one of a latency, a level of interference, or a traffic load associated with each of the first communication link and the one or more second communication links of the AP MLD. At 1206, the AP MLD generates a first frame indicating whether the single communication link or the multiple communication links of the AP MLD are provisioned to the first STA for communications with the AP MLD. At 1208, the AP MLD outputs the first frame for transmission to the first STA on the first communication link.

In various implementations, the first communication link is associated with a first AP of the AP MLD, the one or more second communication links are associated with one or more respective second APs of the AP MLD, and the first STA is associated with a STA MLD including one or more second STAs associated with the one or more respective second communication links of the AP MLD. In some instances, the first frame further indicates whether the single communication link or the multiple communication links of the AP MLD are provisioned to the one or more second STAs of the STA MLD for communications with the AP MLD.

In some instances, the request is obtained via a multi-link association request frame or a multi-link probe request frame, and the first frame includes a multi-link association response frame responsive to the multi-link association request frame or a multi-link probe response frame responsive to the multi-link probe request frame. In some aspects, the first frame includes a T2LM element indicating, for a respective TID of a plurality of TIDs, one or more communication links of the AP MLD allocated for traffic associated with the respective TID.

FIG. 13 shows a flowchart illustrating another example operation 1300 for wireless communication that supports selectively provisioning the communication links of an AP MLD to one or more associated STAs, according to some implementations. The operation 1300 may be performed by an apparatus such as the wireless communication device 400 described with reference to FIG. 4. In some implementations, the operation 1300 may be performed by an AP MLD such as the AP MLD 610 of FIG. 6 or the AP MLD 720 of FIG. 7. In some instances, the operation 1300 may be performed after the AP MLD provisions the single communication link to the first STA for communications with the AP MLD at 1204 of FIG. 12. For example, at 1302, the AP MLD obtains one or more TIDs associated with traffic flows transmitted to or received from the first STA. At 1304, the AP MLD maps the one or more TIDs to only the provisioned single communication link of the AP MLD.

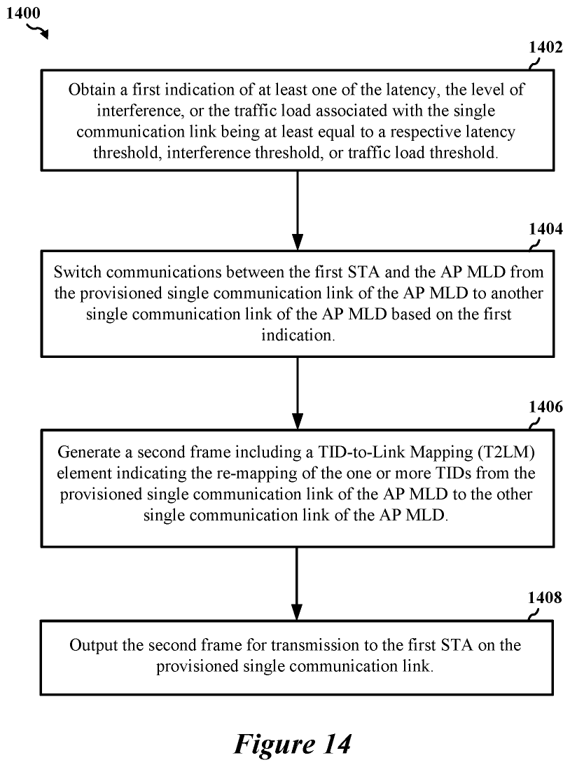

FIG. 14 shows a flowchart illustrating another example operation 1400 for wireless communication that supports selectively provisioning the communication links of an AP MLD to one or more associated STAs, according to some implementations. The operation 1400 may be performed by an apparatus such as the wireless communication device 400 described with reference to FIG. 4. In some implementations, the operation 1400 may be performed by an AP MLD such as the AP MLD 610 of FIG. 6 or the AP MLD 720 of FIG. 7. In some instances, the operation 1400 may be performed after the provisioning at 1204 of FIG. 12. For example, at 1402, the AP MLD obtains a first indication of at least one of the latency, the level of interference, or the traffic load associated with the single communication link being at least equal to a respective latency threshold, interference threshold, or traffic load threshold. At 1404, the AP MLD switches communications between the first STA and the AP MLD from the provisioned single communication link of the AP MLD to another single communication link of the AP MLD based on the first indication.

In some implementations, switching the communications includes re-mapping the one or more TIDs from the provisioned single communication link of the AP MLD to the other single communication link of the AP MILD. In some instances, the operation 1400 continues at 1406, where the AP MLD generates a second frame including a TID-to-Link Mapping (T2LM) element indicating the re-mapping of the one or more TIDs from the provisioned single communication link of the AP MLD to the other single communication link of the AP MLD. At 1408, the AP MLD outputs the second frame for transmission to the first STA on the provisioned single communication link.

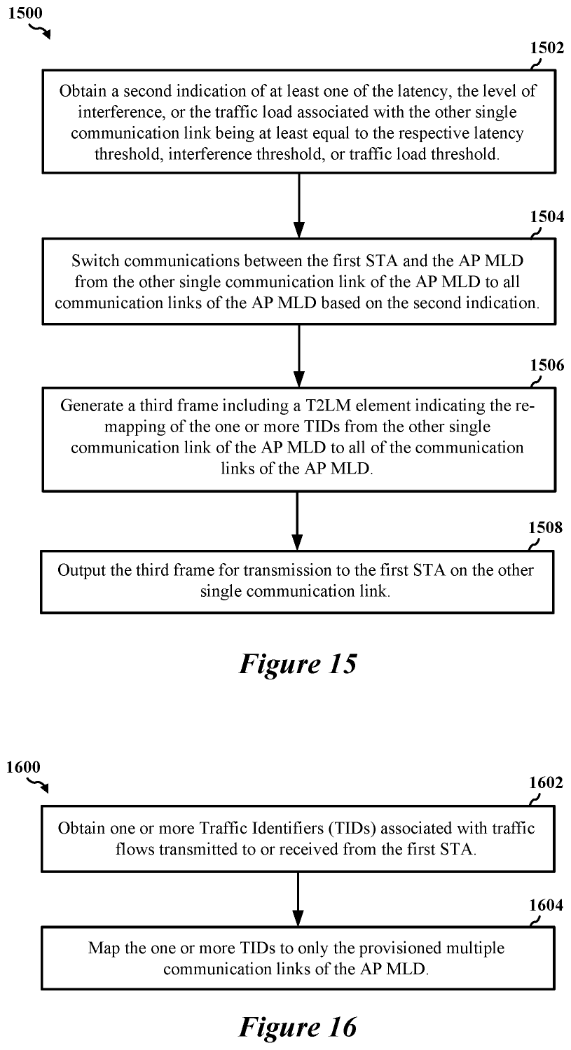

FIG. 15 shows a flowchart illustrating another example operation 1500 for wireless communication that supports selectively provisioning the communication links of an AP MLD to one or more associated STAs, according to some implementations. The operation 1500 may be performed by an apparatus such as the wireless communication device 400 described with reference to FIG. 4. In some implementations, the operation 1500 may be performed by an AP MLD such as the AP MLD 610 of FIG. 6 or the AP MLD 720 of FIG. 7. In some instances, the operation 1500 may be performed after switching the communications at 1404 of FIG. 14. For example, at 1502, the AP MLD obtains a second indication of at least one of the latency, the level of interference, or the traffic load associated with the other single communication link being at least equal to the respective latency threshold, interference threshold, or traffic load threshold. At 1504, the AP MLD switches communications between the first STA and the AP MLD from the other single communication link of the AP MLD to all communication links of the AP MLD based on the second indication.

In some implementations, switching the communications includes re-mapping the one or more TIDs from the other single communication link of the AP MLD to all of the communication links of the AP MLD. In some instances, the operation 1500 continues at 1506, where the AP MLD generates a third frame including a T2LM element indicating the re-mapping of the one or more TIDs from the other single communication link of the AP MLD to all of the communication links of the AP MLD. At 1508, the AP MLD outputs the third frame for transmission to the first STA on the other single communication link.

FIG. 16 shows a flowchart illustrating another example operation 1600 for wireless communication that supports selectively provisioning the communication links of an AP MLD to one or more associated STAs, according to some implementations. The operation 1600 may be performed by an apparatus such as the wireless communication device 400 described with reference to FIG. 4. In some implementations, the operation 1600 may be performed by an AP MLD such as the AP MLD 610 of FIG. 6 or the AP MLD 720 of FIG. 7. In some instances, the operation 1600 may be performed after the AP MLD provisions the multiple communication links to the first STA at 1204 of FIG. 12. For example, at 1602, the AP MLD obtains one or more Traffic Identifiers (TIDs) associated with traffic flows transmitted to or received from the first STA. At 1604, the AP MLD maps the one or more TIDs to only the provisioned single communication link of the AP MLD.

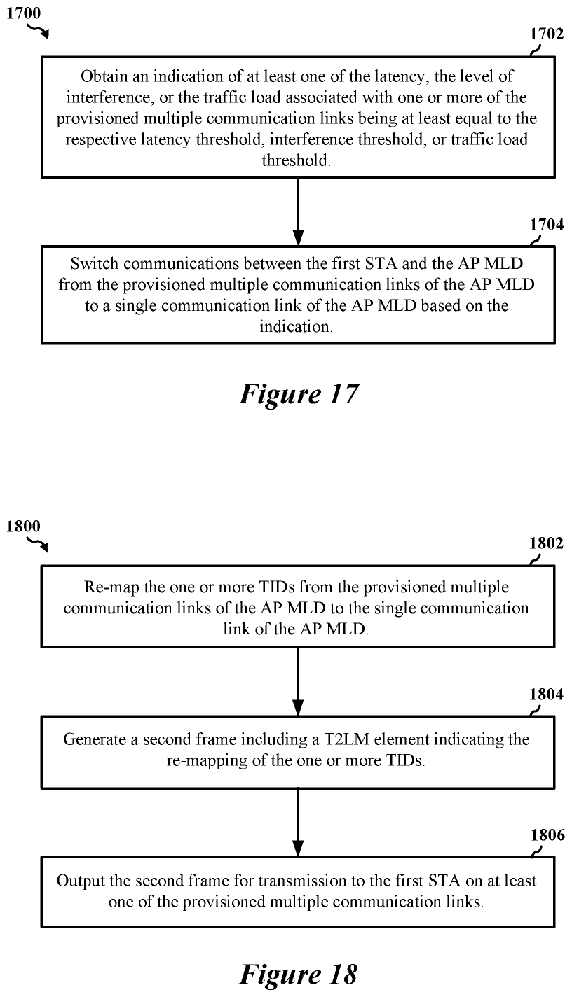

FIG. 17 shows a flowchart illustrating another example operation 1700 for wireless communication that supports selectively provisioning the communication links of an AP MLD to one or more associated STAs, according to some implementations. The operation 1700 may be performed by an apparatus such as the wireless communication device 400 described with reference to FIG. 4. In some implementations, the operation 1700 may be performed by an AP MLD such as the AP MLD 610 of FIG. 6 or the AP MLD 720 of FIG. 7. In some instances, the operation 1700 may be one example of the provisioning at 1204 of FIG. 12.

For example, at 1702, the AP MLD obtains an indication of at least one of the latency, the level of interference, or the traffic load associated with one or more of the provisioned multiple communication links being at least equal to the respective latency threshold, interference threshold, or traffic load threshold. At 1704, the AP MLD switches communications between the first STA and the AP MLD from the provisioned multiple communication links of the AP MLD to a single communication link of the AP MLD based on the indication. In some instances, the single communication link of the AP MLD is different from the provisioned multiple communication links of the AP MLD. In some other instances, the single communication link of the AP MLD also may be one of the multiple communication links provisioned by the AP MLD.

FIG. 18 shows a flowchart illustrating another example operation 1800 for wireless communication that supports selectively provisioning the communication links of an AP MLD to one or more associated STAs, according to some implementations. The operation 1800 may be performed by an apparatus such as the wireless communication device 400 described with reference to FIG. 4. In some implementations, the operation 1800 may be performed by an AP MLD such as the AP MLD 610 of FIG. 6 or the AP MLD 720 of FIG. 7. In some instances, the operation 1800 may be one example of switching communications at 1704 of FIG. 17. For example, at 1802, the AP MLD re-maps the one or more TIDs from the provisioned multiple communication links of the AP MLD to the single communication link of the AP MLD. At 1804, the AP MLD generates a second frame including a TID-to-Link Mapping (T2LM) element indicating the re-mapping of the one or more TIDs from the provisioned multiple communication links of the AP MLD to the single communication link of the AP MLD. At 1806, the AP MLD outputs the second frame for transmission to the first STA on at least one of the provisioned multiple communication links.

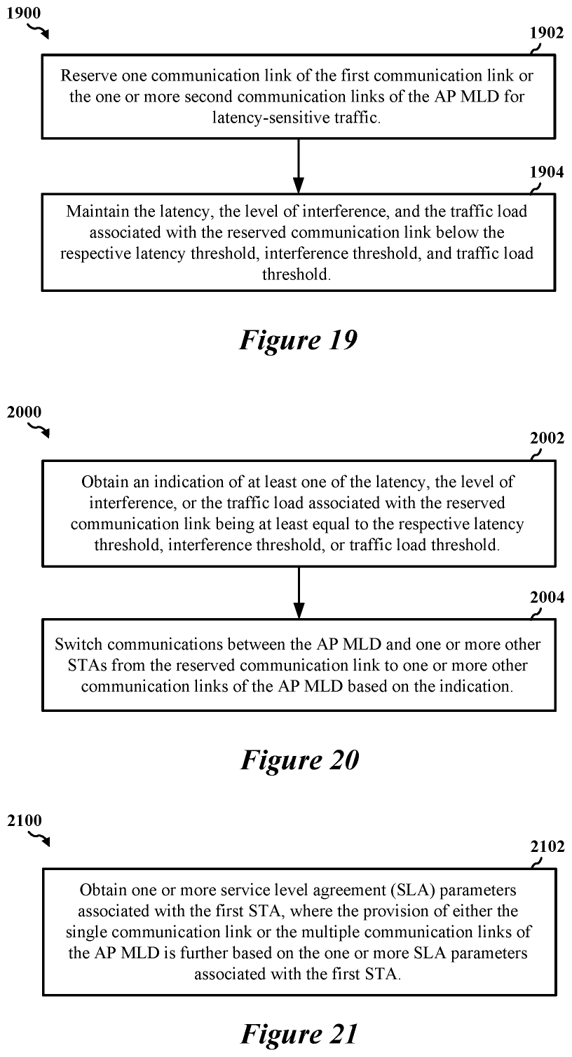

FIG. 19 shows a flowchart illustrating another example operation 1900 for wireless communication that supports selectively provisioning the communication links of an AP MLD to one or more associated STAs, according to some implementations. The operation 1900 may be performed by an apparatus such as the wireless communication device 400 described with reference to FIG. 4. In some implementations, the operation 1900 may be performed by an AP MLD such as the AP MLD 610 of FIG. 6 or the AP MLD 720 of FIG. 7. In some instances, the operation 1900 may be performed before, during, or after the example operation 1200 of FIG. 12. For example, at 1902, the AP MLD reserves one communication link of the first communication link or the one or more second communication links of the AP MLD for latency-sensitive traffic. At 1904, the AP MLD maintains the latency, the level of interference, and the traffic load associated with the reserved communication link below the respective latency threshold, interference threshold, and traffic load threshold.

FIG. 20 shows a flowchart illustrating another example operation 2000 for wireless communication that supports selectively provisioning the communication links of an AP MLD to one or more associated STAs, according to some implementations. The operation 2000 may be performed by an apparatus such as the wireless communication device 400 described with reference to FIG. 4. In some implementations, the operation 2000 may be performed by an AP MLD such as the AP MLD 610 of FIG. 6 or the AP MLD 720 of FIG. 7. In some instances, the operation 2000 may be one example of maintaining the latency, the level of interference, and the traffic load associated with the reserved communication link at 1904 of FIG. 19. For example, at 2002, the AP MLD obtains an indication of at least one of the latency, the level of interference, or the traffic load associated with the reserved communication link being at least equal to the respective latency threshold, interference threshold, or traffic load threshold. At 2004, the AP MLD switches communications between the AP MLD and one or more other STAs from the reserved communication link to one or more other communication links of the AP MLD based on the indication.

FIG. 21 shows a flowchart illustrating another example operation 2100 for wireless communication that supports selectively provisioning the communication links of an AP MLD to one or more associated STAs, according to some implementations. The operation 2100 may be performed by an apparatus such as the wireless communication device 400 described with reference to FIG. 4. In some implementations, the operation 2100 may be performed by an AP MLD such as the AP MLD 610 of FIG. 6 or the AP MLD 720 of FIG. 7. In some instances, the operation 2100 may be performed in conjunction with the example operation 1200 of FIG. 12. For example, at 2102, the AP MLD obtains one or more service level agreement (SLA) parameters associated with the first STA, where the provision of either the single communication link or the multiple communication links of the AP MLD is further based on the one or more SLA parameters associated with the first STA.

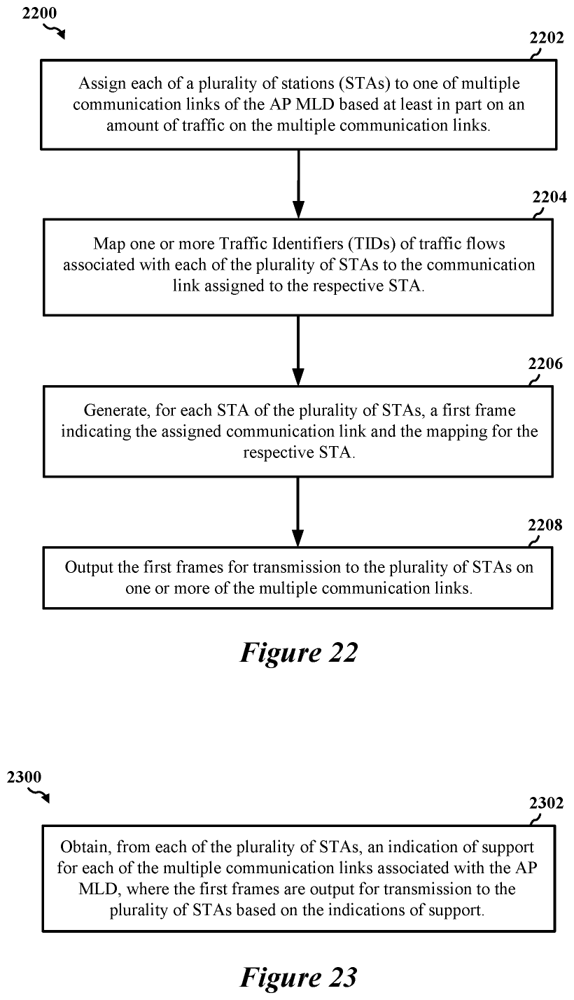

FIG. 22 shows a flowchart illustrating an example 2200 operation for wireless communication that supports selectively assigning STAs to the communication links of an AP MLD, according to some implementations. The operation 2200 may be performed by an apparatus such as the wireless communication device 400 described with reference to FIG. 4. In some implementations, the operation 2200 may be performed by an AP MLD such as the AP MLD 610 of FIG. 6 or the AP MLD 720 of FIG. 7.

For example, at 2202, the AP MLD assigns each of a plurality of stations (STAs) to one of multiple communication links of the AP MLD based at least in part on an amount of traffic on the multiple communication links. At 2204, the AP MLD maps one or more Traffic Identifiers (TIDs) of traffic flows associated with each of the plurality of STAs to the communication link assigned to the respective STA. At 2206, the AP MLD generates, for each STA of the plurality of STAs, a first frame indicating the assigned communication link and the mapping for the respective STA. At 2208, the AP MLD outputs the first frames for transmission to the plurality of STAs on one or more of the multiple communication links. In various implementations, the first frames include a TID-to-Link Mapping (T2LM) element indicating the mappings for the respective plurality of STAs. In some instances, each of the multiple communication links is associated with a respective AP of the AP MLD and occupies one of a 2.4 GHz frequency band, a 5 GHz frequency band, a 6 GHz frequency band, or a 60 GHz frequency band.

FIG. 23 shows a flowchart illustrating another example operation 2300 for wireless communication that supports selectively assigning STAs to the communication links of an AP MLD, according to some implementations. The operation 2300 may be performed by an apparatus such as the wireless communication device 400 described with reference to FIG. 4. In some implementations, the operation 2300 may be performed by an AP MLD such as the AP MLD 610 of FIG. 6 or the AP MLD 720 of FIG. 7. In some instances, the operation 2300 may be performed in conjunction with the example operation 2200 of FIG. 22.

For example, at 2302, the AP MLD obtains, from each of the plurality of STAs, an indication of support for each of the multiple communication links associated with the AP MLD, where the first frames are output for transmission to the plurality of STAs based on the indications of support. In some implementations, the indications of support are obtained via association request frames or probe request frames, and the first frames are multi-link association response frames responsive to the respective association request frames or multi-link probe response frames responsive to the respective probe request frames.

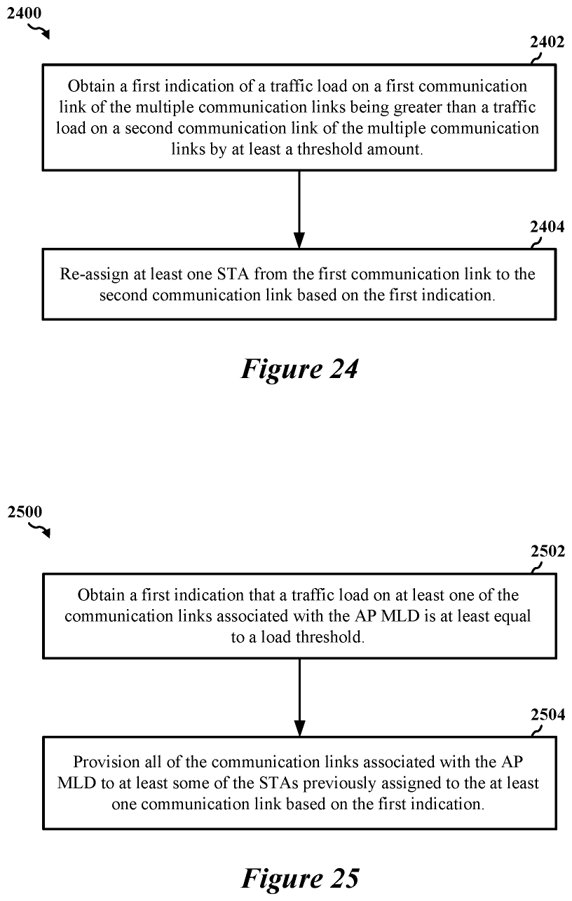

FIG. 24 shows a flowchart illustrating another example operation 2400 for wireless communication that supports selectively assigning STAs to the communication links of an AP MLD, according to some implementations. The operation 2400 may be performed by an apparatus such as the wireless communication device 400 described with reference to FIG. 4. In some implementations, the operation 2400 may be performed by an AP MLD such as the AP MLD 610 of FIG. 6 or the AP MLD 720 of FIG. 7. In some instances, the operation 2400 may be performed after assigning the STAs at 2202 of FIG. 22.

For example, at 2402, the AP MLD obtains a first indication of a traffic load on a first communication link of the multiple communication links being greater than a traffic load on a second communication link of the multiple communication links by at least a threshold amount. At 2404, the AP MLD re-assigns at least one STA from the first communication link to the second communication link based on the first indication. In some implementations, the first communication link is reserved for latency-sensitive traffic. The at least one STA may be associated with at least one of a throughput of the at least one STA being less than a first threshold or a load associated with the at least one STA being at least equal to a second threshold. In some instances, the AP MILD maintains STAs associated with latency-sensitive traffic on the first communication link while switching communications with non-latency-sensitive STAs from the first communication link to the second communication link.

FIG. 25 shows a flowchart illustrating another example operation 2500 for wireless communication that supports selectively assigning STAs to the communication links of an AP MLD, according to some implementations. The operation 2500 may be performed by an apparatus such as the wireless communication device 400 described with reference to FIG. 4. In some implementations, the operation 2500 may be performed by an AP MLD such as the AP MLD 610 of FIG. 6 or the AP MLD 720 of FIG. 7. In some instances, the operation 2500 may be performed after assigning the STAs at 2202 of FIG. 22.

For example, at 2502, the AP MLD obtains a first indication that a traffic load on at least one of the communication links associated with the AP MLD is at least equal to a load threshold. At 2504, the AP MLD provisions all of the communication links associated with the AP MLD to at least some of the STAs previously assigned to the at least one communication link based on the first indication.

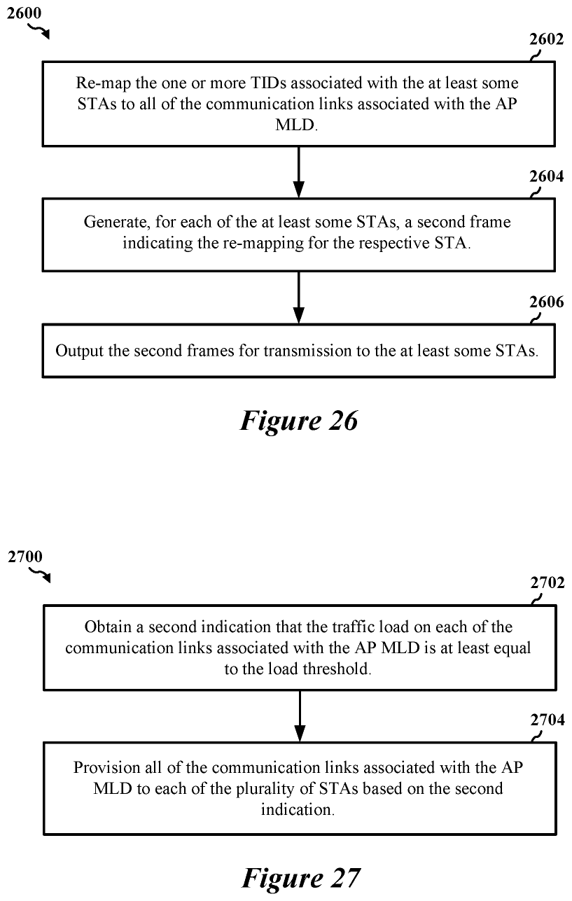

FIG. 26 shows a flowchart illustrating another example operation 2600 for wireless communication that supports selectively assigning STAs to the communication links of an AP MLD, according to some implementations. The operation 2600 may be performed by an apparatus such as the wireless communication device 400 described with reference to FIG. 4. In some implementations, the operation 2600 may be performed by an AP MLD such as the AP MLD 610 of FIG. 6 or the AP MLD 720 of FIG. 7. In some instances, the operation 2600 may be performed after assigning the STAs at 2202 of FIG. 22. For example, at 2602, the AP MLD re-maps the one or more TIDs associated with the at least some STAs to all of the communication links associated with the AP MLD. At 2604, the AP MLD generates, for each of the at least some STAs, a second frame indicating the re-mapping for the respective STA. At 2606, the AP MLD outputs the second frames for transmission to the at least some STAs. In some instances, each of the second frames may be a directed action frame indicating the re-mapping for the respective STA.

In some implementations, each of the at least some STAs is associated with at least one of a throughput of the respective STA being less than a first threshold or a load associated with the respective STA being at least equal to a second threshold. In some other implementations, each of the at least some STAs is associated with a group of STAs based on at least one of a combined throughput or a combined load of the group of STAs. In some aspects, the load threshold may be a configured parameter obtained from a network entity.

FIG. 27 shows a flowchart illustrating another example operation 2700 for wireless communication that supports selectively assigning STAs to the communication links of an AP MLD, according to some implementations. The operation 2700 may be performed by an apparatus such as the wireless communication device 400 described with reference to FIG. 4. In some implementations, the operation 2700 may be performed by an AP MLD such as the AP MLD 610 of FIG. 6 or the AP MLD 720 of FIG. 7. In some instances, the operation 2700 may be performed after assigning the STAs at 2202 of FIG. 22. For example, at 2702, the AP MLD obtains a second indication that the traffic load on each of the communication links associated with the AP MLD is at least equal to the load threshold. At 2704, the AP MLD provisions all of the communication links associated with the AP MLD to each of the plurality of STAs based on the second indication.

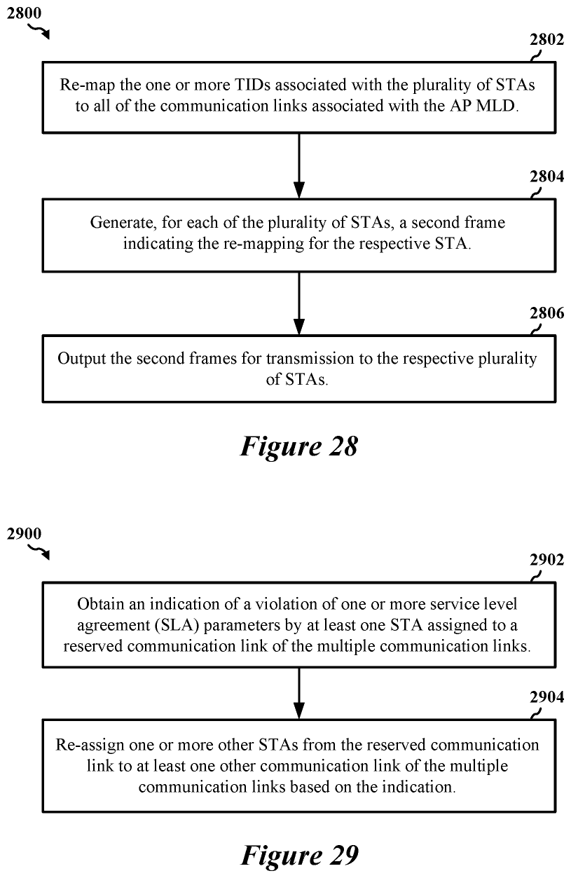

FIG. 28 shows a flowchart illustrating another example operation 2800 for wireless communication that supports selectively assigning STAs to the communication links of an AP MLD, according to some implementations. The operation 2800 may be performed by an apparatus such as the wireless communication device 400 described with reference to FIG. 4. In some implementations, the operation 2800 may be performed by an AP MLD such as the AP MLD 610 of FIG. 6 or the AP MLD 720 of FIG. 7. In some instances, the operation 2800 may be performed after the example operation 2700 of FIG. 27. For example, at 2802, the AP MLD re-maps the one or more TIDs associated with the plurality of STAs to all of the communication links associated with the AP MLD. At 2804, the AP MLD generates, for each of the plurality of STAs, a second frame indicating the re-mapping for the respective STA. At 2806, the AP MLD outputs the second frames for transmission to the respective plurality of STAs.

FIG. 29 shows a flowchart illustrating another example operation 2900 for wireless communication that supports selectively assigning STAs to the communication links of an AP MLD, according to some implementations. The operation 2900 may be performed by an apparatus such as the wireless communication device 400 described with reference to FIG. 4. In some implementations, the operation 2900 may be performed by an AP MLD such as the AP MLD 610 of FIG. 6 or the AP MLD 720 of FIG. 7. In some instances, the operation 2900 may be performed after the example operation 2200 of FIG. 22. For example, at 2902, the AP MLD obtains an indication of a violation of one or more service level agreement (SLA) parameters by at least one STA assigned to a reserved communication link of the multiple communication links. At 2904, the AP MLD re-assigns one or more other STAs from the reserved communication link to at least one other communication link of the multiple communication links based on the indication.

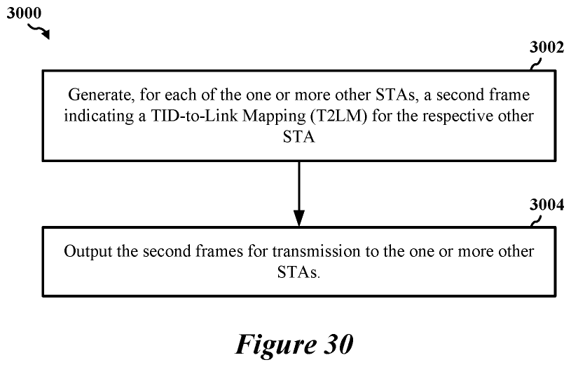

FIG. 30 shows a flowchart illustrating another example operation 3000 for wireless communication that supports selectively assigning STAs to the communication links of an AP MLD, according to some implementations. The operation 3000 may be performed by an apparatus such as the wireless communication device 400 described with reference to FIG. 4. In some implementations, the operation 3000 may be performed by an AP MLD such as the AP MLD 610 of FIG. 6 or the AP MLD 720 of FIG. 7. In some instances, the operation 3000 may be performed after the example operation 2900 of FIG. 29. For example, at 3002, the AP MLD generates, for each of the one or more other STAs, a second frame indicating a TID-to-Link Mapping (T2LM) for a respective STA of the one or more other STAs. At 3004, the AP MLD outputs the second frames for transmission to the one or more other STAs.

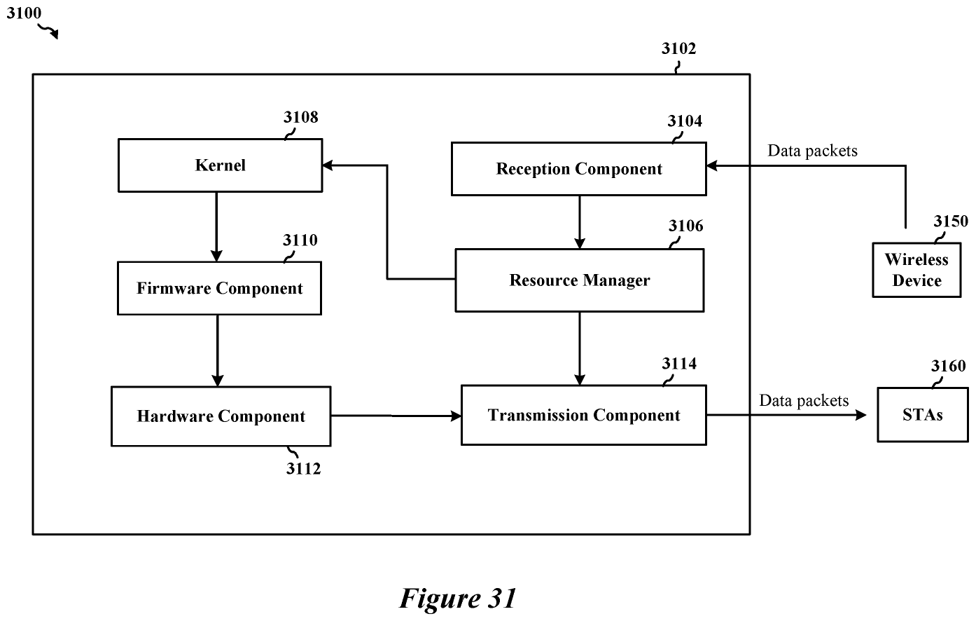

FIG. 31 is a conceptual data flow diagram 3100 illustrating the data flow between different means and/or components of an example apparatus 3102. In some implementations, the apparatus 3102 may be implemented within an AP MILD. The apparatus 3102 includes a reception component 3104 that receives data packets from other wireless devices 3150. In some aspects, the reception component 3104 may also receive or obtain requests for association with the AP MLD from one or more nearby STAs, one or more TIDs associated with traffic flows transmitted to or received from a respective STA, one or more SLA parameters associated with the respective STA, and one or more link metrics for each of the communication links associated with the AP MLD. The apparatus 3102 also includes a resource manager 3106, a kernel 3108, a firmware component 3110, a hardware component 3112, and a transmission component 3114.

In some implementations, the resource manager 3106 may determine whether to provision, for a respective STA, either a single communication link or multiple communication links of the AP MLD for communications between the respective STA and the AP MLD based on at least one link metric associated with each of the communication links of the AP MHLD, where the link metrics include a latency, a level of interference, or a traffic load associated with a respective communication link, among other examples. In some aspects, at least some of the link metrics may be provided by an operator cloud based on the slow control loop 706 described with reference to FIG. 7. In other implementations, the resource manager 3106 may assign each of a plurality of STAs to a single communication link associated with the AP MLD based at least in part on an amount of traffic on all of the communication links associated with the AP MLD.

The kernel 3108 may facilitate interactions between hardware and software components of the apparatus 3102. In some implementations, the firmware component 3110 may generate a frame indicating whether the single communication link or the multiple communication links of the AP MLD are provisioned to the respective STA for communications with the AP MLD. In other implementations, the firmware component 3110 may generate a frame indicating the assigned communication link and the mapping for the respective STA.

The hardware component 3112 may include processing and communication cores that control various aspects of the transmission component 3114. In some aspects, the hardware component 3112 may be based on the fast control loop 702 described with reference to FIG. 7.

The transmission component 3114 is coupled to the resource manager 3106 and the hardware component 3112, may be used to transmit frames or packets provided by the hardware component 3112 to other wireless communication devices such as STAs 3160. The transmission component 3114 may include PHY components, such as transceivers, which are responsible for transmitting packets of the traffic flows over the wireless medium to their intended receiving devices. In some implementations, the transmission component 3114 may transmit the frame indicating whether the single communication link or the multiple communication links of the AP MLD are provisioned to the respective STA for communications with the AP MLD. In other instances, the transmission component 3114 may transmit the frame indicating whether the single communication link or the multiple communication links of the AP MLD are provisioned to the respective STA for communications with the AP MLD.

In some implementations, the apparatus 3102 may include additional components that perform each of the blocks of the operations described with reference to FIGS. 12-22. As such, each block in the flowcharts of FIGS. 12-22 may be performed by a component, and the apparatus 3102 may include one or more of those components. In other implementations, the apparatus 3102 may include additional components that perform each of the blocks of the operations described with reference to FIGS. 23-30. As such, each block in the flowcharts of FIGS. 23-30 may be performed by a component, and the apparatus 3102 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

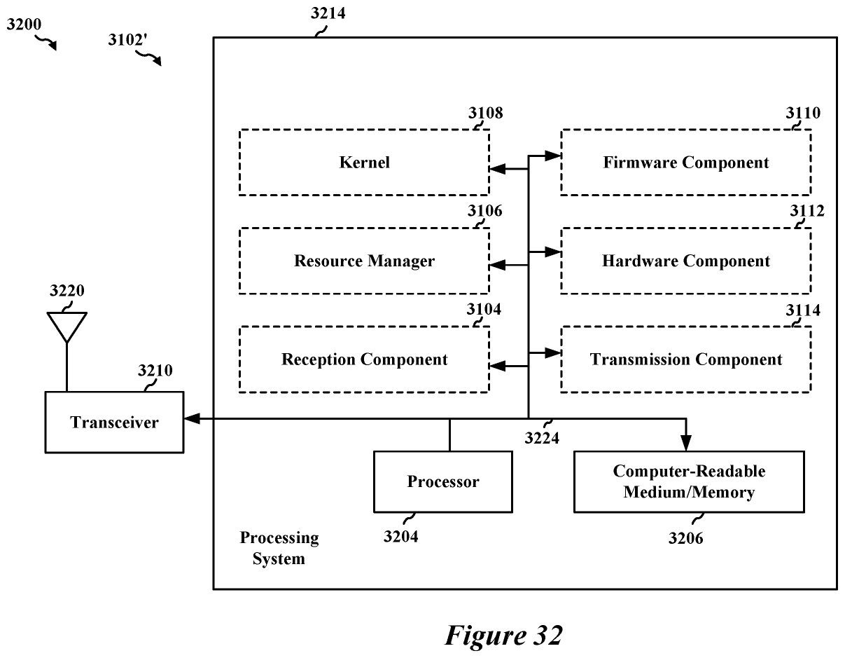

FIG. 32 is a diagram 3200 illustrating an example of a hardware implementation for an apparatus 3102′ employing a processing system 3214. The processing system 3214 may be implemented with a bus architecture, represented generally by the bus 3224. The bus 3224 may include any number of interconnecting buses and bridges depending on the specific application of the processing system 3214 and the overall design constraints. The bus 3224 links together various circuits including one or more processors and/or hardware components, represented by the processor 3204, the components 3104, 3106, 3108, 3110, 3112, and 3114, and the computer-readable medium/memory 3206. The bus 3224 may also link various other circuits such as timing sources, peripherals, voltage regulators, and power management circuits, which are well known in the art, and therefore, will not be described any further.

The processing system 3214 may be coupled to a transceiver 3210. The transceiver 3210 is coupled to one or more antennas 3220. The transceiver 3210 provides a means for communicating with various other apparatus over a transmission medium. The transceiver 3210 receives a signal from the one or more antennas 3220, extracts information from the received signal, and provides the extracted information to the processing system 3214, specifically the reception component 3104. In addition, the transceiver 3210 receives information from the processing system 3214, specifically the transmission component 3114, and based on the received information, generates a signal to be applied to the one or more antennas 3220. The processing system 3214 includes a processor 3204 coupled to a computer-readable medium/memory 3206. The processor 3204 is responsible for general processing, including the execution of software stored on the computer-readable medium/memory 3206. The software, when executed by the processor 3204, causes the processing system 3214 to perform the various functions described supra for any particular apparatus. The computer-readable medium/memory 3206 may also be used for storing data that is manipulated by the processor 3204 when executing software. The processing system 3214 further includes at least one of the components 3104, 3106, 3108, 3110, and 3112. The components may be software components running in the processor 3204, resident/stored in the computer readable medium/memory 3206, one or more hardware components coupled to the processor 3204, or some combination thereof.

In certain configurations, the apparatus 3102/3102′ for wireless communication may include means for all means limitations described herein. The aforementioned means may be the modem 402, the radio 404, the processor(s) 406, the memory 408, and one or more of the aforementioned components of the apparatus 3102 and/or the processing system 3214 of the apparatus 3102′ configured to perform the functions recited by the aforementioned means. The aforementioned means may be one or more of the aforementioned components of the apparatus 3202 and/or the processing system 3214 of the apparatus 3102′ configured to perform the functions recited by the aforementioned means. As described supra, the processing system 3214 may include modem 402, the radio 404, the processor(s) 406, the memory 408 of FIG. 4.

In some examples, means for obtaining, from a first STA on a first communication link of the AP MLD, a request for association with the AP MLD on the first communication link and on each of one or more second communication links may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for provisioning either a single communication link or multiple communication links of the AP MILD for communications between the first STA and the AP MLD based on at least one of a latency, a level of interference, or a traffic load associated with each of the first communication link and the one or more second communication links of the AP MLD may include the processor 406 and the memory 408 of FIG. 4, the wireless communication device 510 and antennas 520 of FIG. 5A, the resource manager 722 of FIG. 7, the resource manager 820 of FIG. 8, or the processor 3204 and the computer readable medium/memory 3206 of FIG. 32.

In some examples, means for generating a first frame indicating whether the single communication link or the multiple communication links of the AP MLD are provisioned to the first STA for communications with the AP MLD may include the processor 406 and the memory 408 of FIG. 4, the wireless communication device 510 and antennas 520 of FIG. 5A, the firmware 726 of FIG. 7, the firmware/hardware 830 of FIG. 8, or the processor 3204 and the computer readable medium/memory 3206 of FIG. 32.

In some examples, means for outputting the first frame for transmission to the first STA on the first communication link may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for obtaining the one or more TIDs may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for mapping the one or more TIDs to only the provisioned single communication link may include the processor 406 and the memory 408 of FIG. 4, the wireless communication device 510 and antennas 520 of FIG. 5A, the resource manager 722 of FIG. 7, the resource manager 820 of FIG. 8, or the processor 3204 and the computer readable medium/memory 3206 of FIG. 32.

In some examples, means for obtaining a first indication of at least one of the latency, the level of interference, or the traffic load associated with the single communication link may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for switching communications from the provisioned single communication link of the AP MLD to another single communication link may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for obtaining an indication of at least one of the latency, the level of interference, or the traffic load associated with one or more of the provisioned multiple communication links may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for switching communications from the other single communication link of the AP MLD to all communication links may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for re-mapping the one or more TIDs from the other single communication link of the AP MLD to all of the communication links may include the processor 406 and the memory 408 of FIG. 4, the wireless communication device 510 and antennas 520 of FIG. 5A, the resource manager 722 of FIG. 7, the resource manager 820 of FIG. 8, or the processor 3204 and the computer readable medium/memory 3206 of FIG. 32.

In some examples, means for outputting for transmission a second frame including a TID-to-Link Mapping (T2LM) element indicating the re-mapping of the one or more TIDs may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for outputting for transmission a third frame including a T2LM element indicating the re-mapping of the one or more TIDs may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In some examples, means for reserving one communication link may include the processor 406 and the memory 408 of FIG. 4, the wireless communication device 510 and antennas 520 of FIG. 5A, the resource manager 722 of FIG. 7, the resource manager 820 of FIG. 8, or the processor 3204 and the computer readable medium/memory 3206 of FIG. 32.

In some examples, means for switching communications between the AP MLD and one or more other STAs from the reserved communication link to one or more other communication links may include the modem 402 and radio 404 of FIG. 4, the wireless communication device 510 and antennas 520 of FIG. 5A, the hardware 728 of FIG. 7, the hardware/firmware 830 of FIG. 8, or the transceiver 3210 and antennas 3220 of FIG. 32.

In other examples, means for assigning each of a plurality of STAs to one of multiple communication links associated with an AP MLD based at least in part on an amount of traffic on the multiple communication links may include the processor 406 and the memory 408 of FIG. 4, the wireless communication device 510 and antennas 520 of FIG. 5A, the resource manager 722 of FIG. 7, the resource manager 820 of FIG. 8, or the processor 3204 and the computer readable medium/memory 3206 of FIG. 32.

In other examples, means for mapping one or more TIDs of traffic flows associated with each of the plurality of STAs may include the modem 402 and radio 404 of FIG. 4, the wireless communication device 510 and antennas 520 of FIG. 5A, the hardware 728 of FIG. 7, the firmware/hardware 830 of FIG. 8, or the transceiver 3210 and antennas 3220 of FIG. 32.

In other examples, means for generating a first frame indicating the assigned communication link and the mapping for the respective STA may include the processor 406 and the memory 408 of FIG. 4, the wireless communication device 510 and antennas 520 of FIG. 5A, the firmware 726 of FIG. 7, the firmware/hardware 830 of FIG. 8, or the processor 3204 and the computer readable medium/memory 3206 of FIG. 32.

In other examples, means for outputting the first frames for transmission to the plurality of STAs may include the modem 402 and radio 404 of FIG. 4, the wireless communication device 510 and antennas 520 of FIG. 5A, the hardware 728 of FIG. 7, the firmware/hardware 830 of FIG. 8, or the transceiver 3210 and antennas 3220 of FIG. 32.

In other examples, means for obtaining a first indication of a traffic load on a first communication link may include the modem 402 and radio 404 of FIG. 4, the wireless communication device 510 and antennas 520 of FIG. 5A, the hardware 728 of FIG. 7, the firmware/hardware 830 of FIG. 8, or the transceiver 3210 and antennas 3220 of FIG. 32.

In other examples, means for re-assigning at least one STA from the first communication link to the second communication link may include the processor 406 and the memory 408 of FIG. 4, the wireless communication device 510 and antennas 520 of FIG. 5A, the firmware 726 of FIG. 7, the firmware/hardware 830 of FIG. 8, or the processor 3204 and the computer readable medium/memory 3206 of FIG. 32.

In other examples, means for provisioning all of the communication links associated with the AP MLD to at least some of the STAs previously assigned to the at least one communication link may include the processor 406 and the memory 408 of FIG. 4, the wireless communication device 510 and antennas 520 of FIG. 5A, the firmware 726 of FIG. 7, the firmware/hardware 830 of FIG. 8, or the processor 3204 and the computer readable medium/memory 3206 of FIG. 32.

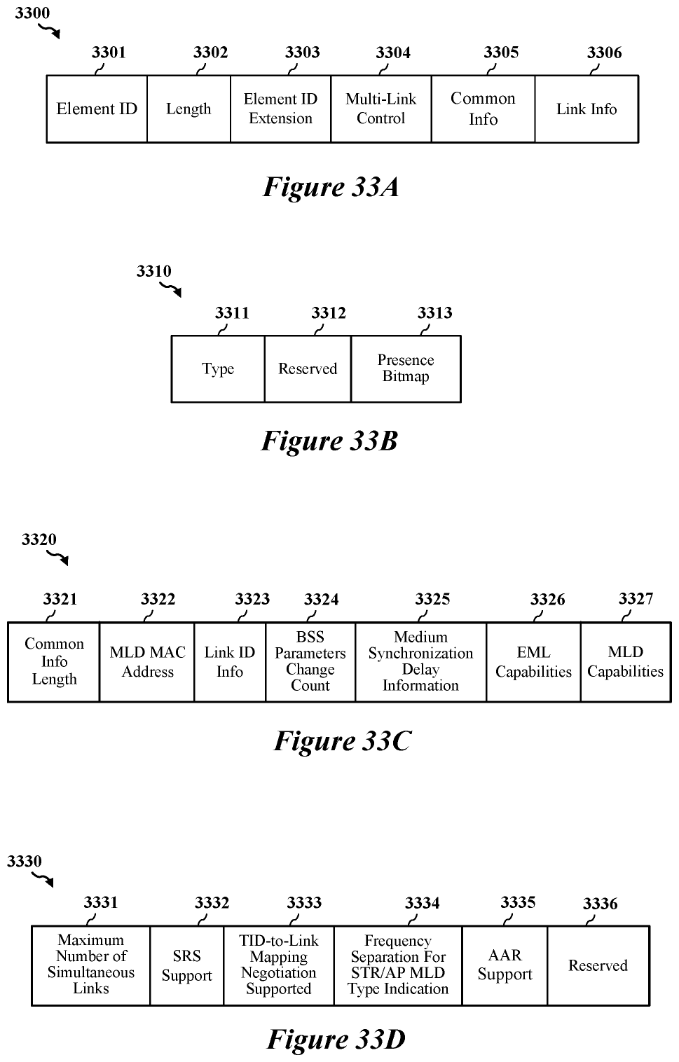

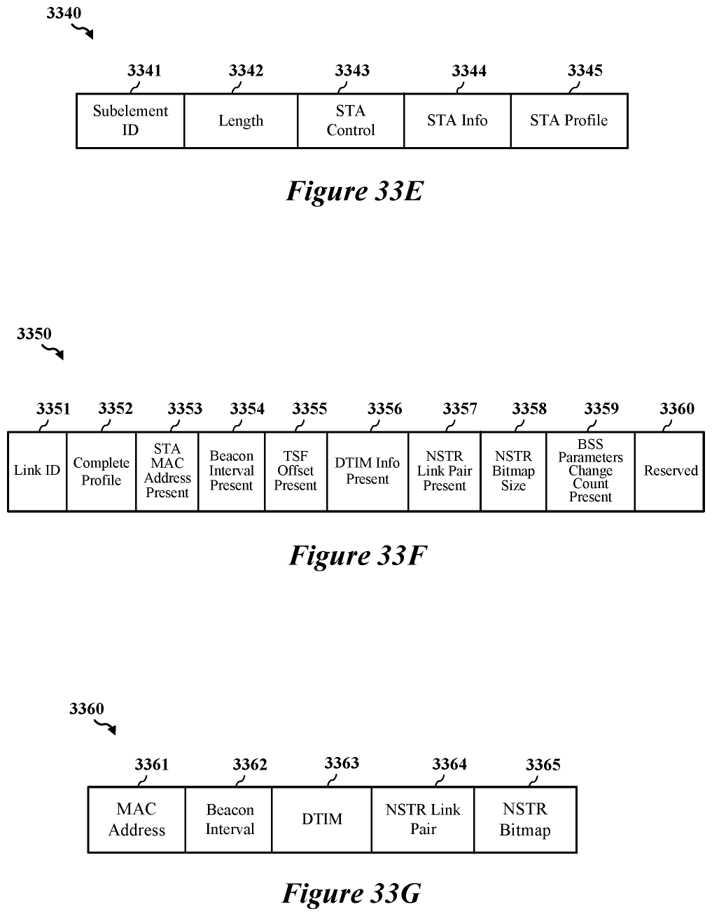

FIG. 33A shows an example Multi-Link element 3300 usable for multi-link communications. In some implementations, the Multi-Link element 3300 may be an example implementation of the basic Multi-Link element 1040 described with reference to FIGS. 10A-10B. In some instances, the Multi-Link element 3300 may be included in a frame such as (but not limited to) a beacon frame, a probe response frame, an association response frame, or a re-association response frame transmitted from an NSTR softAP MLD. For ease of explanation, some information elements of the Multi-Link element 3300 may be referred to as a “field,” a “subfield,” an “element,” or a “subelement,” which may be considered interchangeable terms for purposes of discussion herein.

The Multi-Link element 3300 includes an Element ID field 3301, a Length field 3302, an Element ID Extension field 3303, a Multi-Link Control field 3304, a Common Info field 3305, and a Link Info field 3306. The Element ID field 3301 and the Element ID Extension field 3303 carry values indicating that the element 3300 is an Multi-Link element and indicating the type of Multi-Link element. The Length field 3302 carries a value indicating the length of the Multi-Link element 3300. The Multi-Link Control field 3304 carries information indicating the presence of various fields and subfields in the Common Info field 3305. The Common Info field 3305 carries information common to one or more non-primary links associated with an AP MLD. The Link Info field 3306 carries information specific to each of the non-primary links associated with the AP MLD. In some instances, the Link Info field 3306 includes one or more Per-STA Profile subelements that can carry or indicate the complete profiles of one or more corresponding non-primary links of an AP MLD such as an NSTR softAP MLD.

FIG. 33B shows an example Multi-Link Control field 3310. In some instances, the Multi-Link Control field 3310 may be one implementation of the Multi-Link Control field 3304 of the Multi-Link element 3300 of FIG. 33A. As shown, the Multi-Link Control field 3310 includes a Type field 3311, a reserved field 3312, and a Presence Bitmap field 3313. The Type field 3311 is used to differentiate between variants of the Multi-Link element 3300 (such as a Basic Multi-Link element and a Probe Request Multi-Link element). The reserved field 3312 includes one or more reserved or unused bits. The Presence Bitmap field 3313 is used to indicate the presence of various subfields in the Common Info field 3305 of the Multi-Link element 3300. For example, the Presence Bitmap field 3313 may indicate the presence of an MLD MAC address field, a Link ID Info field, a BSS Parameters Change Count field 3323, a Medium Synchronization Delay Information field, an enhanced Multi-Link (EML) Capabilities field, and an MLD Capabilities field in the Common Info field 3305 of the Multi-Link element 3300.

FIG. 33C shows an example Common Info field 3320. In some instances, the Common Info field 3320 may be one implementation of the Common Info field 3305 of the Multi-link Element 3300 of FIG. 33A. As shown, the Common Info field 3320 includes a Common Info subfield 3321, an MLD MAC Address subfield 3322, a Link ID Info subfield 3323, a BSS Parameters Change Count subfield 3324, a Medium Synchronization Delay Information subfield 3325, an enhanced Multi-Link (EML) Capabilities subfield 3326, and an MLD Capabilities subfield 3327. The Common Info subfield 3321 carries a value indicating a length of the Common Info field 3320. The MLD MAC Address subfield 3322 carries the MAC address of the MLD (such as the NSTR softAP MLD). The Link ID Info subfield 3323 includes a Link ID subfield that carries the link identifier of the AP that transmits the Multi-link element 3300. The BSS Parameters Change Count subfield 3324 carries an unsigned integer, initialized to 0, that increments when a critical update occurs to the operational parameters for the AP that transmits the Basic Multi-link element. The Link ID Info subfield 3323 and the BSS Parameters Change Count subfield 3324 are present in the Common Info field 3320 of Basic Multi-link elements carried in Beacon frames, Probe Response frames, and (Re)Association Response frames.

The Medium Synchronization Delay Information subfield 3325 carries a value indicating the duration of the MediumSyncDelay timer. The EML Capabilities subfield 3326 contains a number of subfields that are used to advertise the capabilities for EML Single-Radio (SR) operation and EML Multiple-Radio (MR) operation. The MLD Capabilities subfield 3327 indicates various capabilities of the MLD. In some instances, the MLD Capabilities subfield 3327 may indicate the maximum number of links that support the simultaneous transmission or reception of frames, whether the MLD supports the reception of frames that carry an SRS control subfield, whether the MLD supports TID-to-Link mapping negotiation, and the minimum frequency gap between any two links that is recommended by the non-AP MLD for STR operation.

FIG. 33D shows an example MLD Capabilities subfield 3330. In some instances, the MLD Capabilities subfield 3330 may be one implementation of the MLD Capabilities subfield 3330 of the Common Info field 3320 of FIG. 33C. As shown, the MLD Capabilities subfield 3330 includes a Maximum Number of Simultaneous Links subfield 3331, an SRS subfield 3332, a TID-to-Link Mapping (T2LM) subfield 3333, a Frequency Separation for STR/AP MLD Type Indication subfield 3334, an AAR Support subfield 3335, and a Reserved subfield 3336. The Maximum Number of Simultaneous Links subfield 3331 indicates the maximum number of STAs affiliated with the MLD that support simultaneous transmission or reception of frames on the respective links. The SRS subfield 3332 indicates support for the reception of a frame that carries an SRS Control subfield. The TID-to-Link Mapping (T2LM) subfield 3333 support for TID-to-link mapping negotiation. The Frequency Separation for STR/AP MLD Type Indication subfield 3334 indicates the minimum frequency gap between any two links that is recommended by the non-AP MLD for STR operation. The AAR Support subfield 3335 indicates support for receiving a frame with an AAR Control subfield.

FIG. 33E shows an example Per-STA Profile subelement 3340. In some instances, the Per-STA Profile subelement 3340 may be one implementation of the Per-STA Profile subelements carried in the Link Info field 3306 of the Multi-link element 3300 of FIG. 33A. As shown, the Per-STA Profile subelement 3340 may include a Subelement ID field 3341, a Length field 3342, a STA Control field 3343, a STA Info field 3344, and a STA Profile field 3345. The Subelement ID field 3341 carries a value indicating the type of the Per-STA Profile subelement 3340. The Length field 3342 carries a value indicating the length of the Per-STA Profile subelement 3340. The STA Control field 3343 carries information indicating the presence (or absence) of various fields and subfields in the STA Profile field 3345. The STA Info field 3344 carries information pertaining to the AP corresponding to the Per-STA Profile subelement 3340. The STA Profile field 3345 carries information indicating the complete profile of the AP corresponding to the Per-STA Profile subelement 3340.

FIG. 33F shows an example STA Control field 3350. In some instances, the STA Control field 3350 may be an example of the STA Control field 3343 of the Per-STA Profile subelement 3340 of FIG. 33E. As shown, the STA Control field 3350 includes a Link ID subfield 3351, a Complete Profile subfield 3352, a STA MAC Address Present subfield 3353, a Beacon Interval Present subfield 3354, a TSF Offset Present subfield 3355, a DTIM Info Present subfield 3356, an NSTR Link Pair Present subfield 3357, an NSTR Bitmap Size subfield 3358, a BSS Parameters Change Count Present subfield 3359, and a Reserved subfield 3360. The Link ID subfield 3351 carries a value that uniquely identifies the communication link associated with the AP corresponding to the Per-STA Profile subelement 3340. The Complete Profile subfield 3352 carries a value indicating whether the Per-STA Profile subelement 3340 carries the complete profile or a partial profile of the corresponding AP.

The STA MAC Address Present subfield 3353 indicates the presence of the STA MAC Address subfield in the STA Info field 3344 of the Multi-link element 3300, and is set to 1 if the STA MAC Address subfield is present in the STA Info field, otherwise the STA MAC Address Present subfield 3353 is set to 0. A STA sets the STA MAC Address Present subfield 3353 to 1 when the Multi-link element 3300 carries the complete profile of a corresponding communication link.

The Beacon Interval Present subfield 3354 indicates the presence of the Beacon Interval subfield in the STA Info field 3344 and is set to 1 if the Beacon Interval subfield is present in the STA Info field 3344, otherwise the Beacon Interval Present subfield 3354 is set to 0. A non-AP STA sets the Beacon Interval Present subfield to 0 in the transmitted Basic Multi-Link element. An AP sets the Beacon Interval Present subfield 3354 to 1 when the Multi-link element 3300 carries the complete profile of a corresponding communication link. An AP affiliated with an NSTR mobile AP MLD and that is operating on nonprimary links sets the Beacon Interval Present subfield 3354 to 0.

The TSF Offset Present subfield 3355 indicates the presence of the TSF Offset subfield in the STA Info field 3344 and is set to 1 if the TSF Offset subfield is present in the STA Info field, otherwise the TSF Offset Present subfield 3355 is set to 0. A non-AP STA sets the TSF Offset Present subfield to 0 in the transmitted Basic Multi-Link element. An AP sets the TSF Offset Present subfield 3355 to 1 when the Multi-link element 3300 carries the complete profile of a corresponding communication link.

The DTIM Info Present subfield 3356 indicates the presence of the DTIM Info subfield in the STA Info field 3344 and is set to 1 if the DTIM Info subfield is present in the STA Info field 3344, otherwise the DTIM Info Present subfield 3356 is set to 0. A non-AP STA sets the DTIM Info Present subfield to 0 in the transmitted Basic Multi-Link element. An AP sets the DTIM Info Present subfield 3356 to 1 when the Multi-link element 3300 carries the complete profile of a corresponding communication link. An AP affiliated with an NSTR mobile AP MLD and that is operating on the nonprimary link set the DTIM Info Present subfield 3356 to 0.

The NSTR Link Pair Present subfield 3357 carries a value indicating whether the Per-STA Profile subelement 3340 carries information pertaining to a pair of communication links associated with an NSTR softAP MLD. The NSTR Bitmap Size subfield 3358 carries a value indicating the size of an NSTR Indication Bitmap field included in the Per-STA Profile subelement 3340 of FIG. 33E.

The BSS Parameters Change Count Present subfield 3359 indicates the presence of the BSS Parameters Change Count subfield in the STA Info field and is set to 1 if the BSS Parameters Change Count subfield is present in the STA Info field, otherwise the BSS Parameters Change Count Present subfield 3359 is set to 0. A non-AP STA sets the BSS Parameters Change Count Present subfield to 0 in the transmitted Basic Multi-Link element. If the Basic Multi-Link element carries the complete profile and is carried in the (Re)Association Response frame, an AP sets the BSS Parameters Change Count Present subfield 3359 to 1. Otherwise, an AP sets the BSS Parameters Change Count Present subfield 3359 to 0.

FIG. 33G shows an example STA Info field 3360. In some instances, the STA Info field 3360 may be one implementation of the STA Info field 3344 of the Per-STA Profile subelement 3340 of FIG. 33E. As shown, the STA Info field 3360 includes a MAC Address field 3361, a Beacon Interval field 3362, a DTIM field 3363, an NSTR Link Pair field 3364, and an NSTR Bitmap field 3365. The MAC Address field 3361 carries the MAC address of the AP corresponding to the Per-STA Profile subelement 3340. The Beacon Interval field 3362 carries information indicating the beacon interval of the AP corresponding to the Per-STA Profile subelement 3340. The DTIM field 3363 carries information indicating the DTIM count and the DTIM period of the AP corresponding to the Per-STA Profile subelement 3340. The NSTR Link Pair field 3364 carries information identifying the pair of communication links associated with the AP corresponding to the Per-STA Profile subelement 3340. The NSTR Bitmap field 3365 carries an NSTR bitmap of the AP corresponding to the Per-STA Profile subelement 3340.

### EXAMPLE ASPECTS

Aspect 1: A method for wireless communication at an access point (AP) multi-link device (MLD), including obtaining, from a first station (STA) on a first communication link of the AP MLD, a request for association with the AP MLD on the first communication link and on each of one or more second communication links; provisioning either a single communication link or multiple communication links of the AP MLD for communications between the first STA and the AP MLD based on at least one of a latency, a level of interference, or a traffic load associated with each of the first communication link and the one or more second communication links of the AP MLD; generating a first frame indicating whether the single communication link or the multiple communication links of the AP MLD are provisioned to the first STA for communications with the AP MLD, and outputting the first frame for transmission to the first STA on the first communication link.

Aspect 2: The method of Aspect 1, where the first communication link is associated with a first AP of the AP MLD, the one or more second communication links are associated with one or more respective second APs of the AP MHLD, and the first STA is associated with a STA MLD including one or more second STAs associated with the one or more respective second communication links of the AP MLD.

Aspect 3: The method of any one or more of Aspects 1-3, where the first frame further indicates whether the single communication link or the multiple communication links of the AP MLD are provisioned to the one or more second STAs of the STA MLD for communications with the AP MLD.

Aspect 4: The method of any one or more of Aspects 1-3, where the request is obtained via a multi-link association request frame or a multi-link probe request frame; and the first frame includes a multi-link association response frame responsive to the multi-link association request frame or a multi-link probe response frame responsive to the multi-link probe request frame.

Aspect 5: The method of any one or more of Aspects 1-4, where the first frame includes a Traffic Identifier (TID)-to-Link Mapping (T2LM) element indicating, for a respective TID of a plurality of TIDs, one or more communication links of the AP MLD allocated for traffic associated with the respective TID.

Aspect 6: The method of any one or more of Aspects 1-5, where the first frame indicates that the single communication link of the AP MLD is provisioned to the first STA for communications with the AP MLD, the method further including obtaining one or more Traffic Identifiers (TIDs) associated with traffic flows transmitted to or received from the first STA; and mapping the one or more TIDs to only the provisioned single communication link of the AP MILD.

Aspect 7: The method of Aspect 6, further including obtaining a first indication of at least one of the latency, the level of interference, or the traffic load associated with the single communication link being at least equal to a respective latency threshold, interference threshold, or traffic load threshold; and switching communications between the first STA and the AP MLD from the provisioned single communication link of the AP MLD to another single communication link of the AP MLD based on the first indication.

Aspect 8: The method of Aspect 7, where switching the communications includes re-mapping the one or more TIDs from the provisioned single communication link of the AP MLD to the other single communication link of the AP MLD.

Aspect 9: The method of Aspect 8, further including generating a second frame including a TID-to-Link Mapping (T2LM) element indicating the re-mapping of the one or more TIDs from the provisioned single communication link of the AP MLD to the other single communication link of the AP MLD; and outputting the second frame for transmission to the first STA on the provisioned single communication link.

Aspect 10: The method of any one or more of Aspects 7-8, further including obtaining a second indication of at least one of the latency, the level of interference, or the traffic load associated with the other single communication link being at least equal to the respective latency threshold, interference threshold, or traffic load threshold; and switching communications between the first STA and the AP MLD from the other single communication link of the AP MLD to all communication links of the AP MLD based on the second indication.

Aspect 11: The method of Aspect 10, where switching the communications includes re-mapping the one or more TIDs from the other single communication link of the AP MLD to all of the communication links of the AP MLD.

Aspect 12: The method of any one or more of Aspects 10-11, further including generating a third frame including a T2LM element indicating the re-mapping of the one or more TIDs from the other single communication link of the AP MLD to all of the communication links of the AP MLD; and outputting the third frame for transmission to the first STA on the other single communication link.

Aspect 13: The method of any one or more of Aspects 1-5, where the first frame indicates that the multiple communication links of the AP MLD are provisioned to the first STA for communications with the AP MILD, the method further including obtaining one or more Traffic Identifiers (TIDs) associated with traffic flows transmitted to or received from the first STA; and mapping the one or more TIDs to only the provisioned multiple communication links of the AP MLD.

Aspect 14: The method of Aspect 13, further including obtaining an indication of at least one of the latency, the level of interference, or the traffic load associated with one or more of the provisioned multiple communication links being at least equal to the respective latency threshold, interference threshold, or traffic load threshold; and switching communications between the first STA and the AP MLD from the provisioned multiple communication links of the AP MLD to a single communication link of the AP MLD based on the indication.

Aspect 15: The method of any one or more of Aspects 13-14, where the single communication link of the AP MLD is different from the provisioned multiple communication links of the AP MLD.

Aspect 16: The method of any one or more of Aspects 13-15, where switching the communications includes re-mapping the one or more TIDs from the provisioned multiple communication links of the AP MLD to the single communication link of the AP MLD.

Aspect 17: The method of Aspect 16, further including generating a second frame including a TID-to-Link Mapping (T2LM) element indicating the re-mapping of the one or more TIDs from the provisioned multiple communication links of the AP MLD to the single communication link of the AP MLD; and outputting the second frame for transmission to the first STA on at least one of the provisioned multiple communication links.

Aspect 18: The method of any one or more of Aspects 1-17, further including reserving one communication link of the first communication link and the one or more second communication links of the AP MLD for latency-sensitive traffic; and maintaining the latency, the level of interference, and the traffic load associated with the reserved communication link below the respective latency threshold, interference threshold, and traffic load threshold.

Aspect 19: The method of Aspect 18, where the maintaining includes obtaining an indication of at least one of the latency, the level of interference, or the traffic load associated with the reserved communication link being at least equal to the respective latency threshold, interference threshold, or traffic load threshold; and switching communications between the AP MLD and one or more other STAs from the reserved communication link to one or more other communication links of the AP MILD based on the indication.

Aspect 20: The method of any one or more of Aspects 1-19, further including obtaining one or more service level agreement (SLA) parameters associated with the first STA, where the provision of either the single communication link or the multiple communication links of the AP MLD is further based on the one or more SLA parameters associated with the first STA.

Aspect 21: An apparatus for wireless communications, including means for performing a method in accordance with any one of Aspects 1-20.

Aspect 22: A non-transitory computer-readable storage medium storing instructions that, when executed by one or more processors of an apparatus, cause the apparatus to perform one or more operations in accordance with any one of Aspects 1-20.

Aspect 23: An access point (AP) multi-link device (MLD) including at least one transceiver and a processing system including a memory and one or more processors. The processing system is configured to execute instructions stored in the memory and cause the AP MLD to perform a method in accordance with any one of Aspects 1-20, where the at least one transceiver is configured to transmit the first frame indicating whether a single communication link or multiple communication links of the AP MLD are provisioned to a STA for communications with the AP MLD.

Aspect 24: A method for wireless communication at an access point (AP) multi-link device (MLD), including assigning each of a plurality of stations (STAs) to one of multiple communication links of the AP MLD based at least in part on an amount of traffic on the multiple communication links; mapping one or more Traffic Identifiers (TIDs) of traffic flows associated with each of the plurality of STAs to the communication link assigned to the respective STA; generating, for each STA of the plurality of STAs, a first frame indicating the assigned communication link and the mapping for the respective STA; and outputting the first frames for transmission to the plurality of STAs on one or more of the multiple communication links.

Aspect 25: The method of Aspect 24, where each of the multiple communication links is associated with a respective AP of the AP MLD and occupies one of a 2.4 GHz frequency band, a 5 GHz frequency band, a 6 GHz frequency band, or a 60 GHz frequency band.

Aspect 26: The method of any one or more of Aspects 24-25, further including obtaining, from each of the plurality of STAs, an indication of support for each of the multiple communication links associated with the AP MLD, where the first frames are output for transmission to the plurality of STAs based on the indications of support.

Aspect 27: The method of Aspect 26, where the indications of support are obtained via association request frames or probe request frames; and the first frames include multi-link association response frames responsive to the respective association request frames or multi-link probe response frames responsive to the respective probe request frames.

Aspect 28: The method of any one or more of Aspects 24-27, where the first frames include a TID-to-Link Mapping (T2LM) element indicating the mappings for the respective plurality of STAs.

Aspect 29: The method of any one or more of Aspects 24-28, further including obtaining a first indication of a traffic load on a first communication link of the multiple communication links being greater than a traffic load on a second communication link of the multiple communication links by at least a threshold amount; and re-assigning at least one STA from the first communication link to the second communication link based on the first indication.

Aspect 30: The method of Aspect 29, where the first communication link is reserved for latency-sensitive traffic.

Aspect 31: The method of any one or more of Aspects 29-30, where the at least one STA is associated with at least one of a throughput of the at least one STA being less than a first threshold or a load associated with the at least one STA being at least equal to a second threshold.

Aspect 32: The method of any one or more of Aspects 29-31, further including maintaining STAs associated with latency-sensitive traffic on the first communication link while switching communications with non-latency-sensitive STAs from the first communication link to the second communication link.

Aspect 33: The method of any one or more of Aspects 24-28, further including obtaining a first indication that a traffic load on at least one of the communication links associated with the AP MLD is at least equal to a load threshold; and provisioning all of the communication links associated with the AP MILD to at least some of the STAs previously assigned to the at least one communication link based on the first indication.

Aspect 34: The method of Aspect 33, further including re-mapping the one or more TIDs associated with the at least some STAs to all of the communication links associated with the AP MILD; generating, for each of the at least some STAs, a second frame indicating the re-mapping for the respective STA; and outputting the second frames for transmission to the at least some STAs.

Aspect 35: The method of Aspect 34, where each of the second frames includes a directed action frame indicating the re-mapping for the respective STA.

Aspect 36: The method of any one or more of Aspects 34-35, where the load threshold is a configured parameter obtained from a network entity.

Aspect 37: The method of any one or more of Aspects 34-36, where each of the at least some STAs is associated with at least one of a throughput of the respective STA being less than a first threshold or a load associated with the respective STA being at least equal to a second threshold.

Aspect 38: The method of any one or more of Aspects 34-36, where each of the at least some STAs is associated with a group of STAs based on at least one of a combined throughput or a combined load of the group of STAs.

Aspect 39: The method of any one or more of Aspects 33-38, further including obtaining a second indication that the traffic load on each of the communication links associated with the AP MLD is at least equal to the load threshold; and provisioning all of the communication links associated with the AP MILD to each of the plurality of STAs based on the second indication.

Aspect 40: The method of Aspect 39, further including re-mapping the one or more TIDs associated with the plurality of STAs to all of the communication links associated with the AP MILD; generating, for each of the plurality of STAs, a second frame indicating the re-mapping for the respective STA; and outputting the second frames for transmission to the respective plurality of STAs.

Aspect 41: The method of any one or more of Aspects 24-40, further including obtaining an indication of a violation of one or more service level agreement (SLA) parameters by at least one STA assigned to a reserved communication link of the multiple communication links; re-assigning one or more other STAs from the reserved communication link to at least one other communication link of the multiple communication links based on the indication; and outputting second frames for transmission to the one or more other STAs, each of the second frames indicating a TID-to-Link Mapping (T2LM) for a respective STA of the one or more other STAs.

Aspect 42: The method of Aspect 41, further including generating, for each of the one or more other STAs, a second frame indicating a TID-to-Link Mapping (T2LM) for a respective STA of the one or more other STAs; and outputting the second frames for transmission to the one or more other STAs.

Aspect 43: The method of Aspect 42, where the reserved communication link is associated with latency-sensitive traffic, and the one or more other STAs are not associated with latency-sensitive traffic.

Aspect 44: An apparatus for wireless communications, including means for performing a method in accordance with any one of Aspects 24-43.

Aspect 45: A non-transitory computer-readable storage medium storing instructions that, when executed by one or more processors of an apparatus, cause the apparatus to perform one or more operations in accordance with any one of Aspects 24-43.

Aspect 46: An access point (AP) multi-link device (MLD) including at least one transceiver and a processing system including a memory and one or more processors. The processing system is configured to execute instructions stored in the memory and cause the AP MLD to perform a method in accordance with any one of Aspects 24-43, where the at least one transceiver is configured to transmit, to each of a plurality of STAs, a first frame indicating the assigned communication link and the TID-to-Link mapping for the respective STA.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c. As used herein, “based on” is intended to be interpreted in the inclusive sense, unless otherwise explicitly indicated. For example, “based on” may be used interchangeably with “based at least in part on,” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products.

1. An apparatus for wireless communications, comprising:
an interface configured to:
obtain, from a first station (STA) on a first communication link associated with an access point (AP) multi-link device (MLD), a request for association with the AP MLD on the first communication link and on each of one or more second communication links of the AP MLD; and
a processing system configured to:
provision either a single communication link or multiple communication links of the AP MLD for communications between the first STA and the AP MLD based on at least one of a latency, a level of interference, or a traffic load associated with each of the first communication link and the one or more second communication links of the AP MLD; and
generate a first frame indicating whether the single communication link or the multiple communication links of the AP MLD are provisioned to the first STA for communications with the AP MLD; and
the interface further configured to:
output the first frame for transmission to the first STA on the first communication link.

2. The apparatus of claim 1, wherein the first communication link is associated with a first AP of the AP MLD, the one or more second communication links are associated with one or more respective second APs of the AP MHLD, and the first STA is associated with a STA MLD including one or more second STAs associated with the one or more respective second communication links of the AP MLD.

3. The apparatus of claim 2, wherein the first frame further indicates whether the single communication link or the multiple communication links of the AP MLD are provisioned to the one or more second STAs of the STA MLD for communications with the AP MLD.

4. The apparatus of claim 1, wherein:
the request is obtained via a multi-link association request frame or a multi-link probe request frame; and
the first frame comprises a multi-link association response frame responsive to the multi-link association request frame or a multi-link probe response frame responsive to the multi-link probe request frame.

5. The apparatus of claim 1, wherein the first frame includes a Traffic Identifier (TID)-to-Link Mapping (T2LM) element indicating, for each TID of a plurality of TIDs, one or more communication links of the AP MLD allocated for traffic associated with the respective TID.

6. The apparatus of claim 1, wherein:
the first frame indicates that the single communication link of the AP MLD is provisioned to the first STA for communications with the AP MILD;
the interface is further configured to obtain one or more Traffic Identifiers (TIDs) associated with traffic flows transmitted to or received from the first STA; and
the processing system is further configured to map the one or more TIDs to only the provisioned single communication link of the AP MILD.

7. The apparatus of claim 6, wherein:
the interface is further configured to obtain a first indication of at least one of the latency, the level of interference, or the traffic load associated with the provisioned single communication link being at least equal to a respective latency threshold, interference threshold, or traffic load threshold; and
the processing system is further configured to switch communications between the first STA and the AP MLD from the provisioned single communication link of the AP MLD to another single communication link of the AP MLD based on the first indication.

8. The apparatus of claim 7, wherein switching the communications includes re-mapping the one or more TIDs from the provisioned single communication link of the AP MLD to the other single communication link of the AP MLD.

9. The apparatus of claim 8, wherein:
the processing system is further configured to generate a second frame including a TID-to-Link Mapping (T2LM) element indicating the re-mapping of the one or more TIDs from the provisioned single communication link of the AP MLD to the other single communication link of the AP MLD; and
the interface is further configured to output the second frame for transmission to the first STA on the provisioned single communication link.

10. The apparatus of claim 7, wherein:
the interface is further configured to obtain a second indication of at least one of the latency, the level of interference, or the traffic load associated with the other single communication link being at least equal to the respective latency threshold, interference threshold, or traffic load threshold; and
the processing system is further configured to switch communications between the first STA and the AP MLD from the other single communication link of the AP MLD to all communication links of the AP MLD based on the second indication.

11. The apparatus of claim 10, wherein switching the communications includes re-mapping the one or more TIDs from the other single communication link of the AP MLD to all of the communication links of the AP MILD.

12. The apparatus of claim 11, wherein:
the processing system is further configured to generate a third frame including a TID-to-Link Mapping (T2LM) element indicating the re-mapping of the one or more TIDs from the other single communication link of the AP MLD to all of the communication links of the AP MLD; and
the interface is further configured to output the third frame for transmission to the first STA on the other single communication link.

13. The apparatus of claim 1, wherein:
the first frame indicates that the multiple communication links of the AP MLD are provisioned to the first STA for communications with the AP MLD;
the interface is further configured to obtain one or more Traffic Identifiers (TIDs) associated with traffic flows transmitted to or received from the first STA; and
the processing system is further configured to map the one or more TIDs to only the provisioned multiple communication links of the AP MLD.

14. The apparatus of claim 13, wherein:
the interface is further configured to obtain an indication of at least one of the latency, the level of interference, or the traffic load associated with one or more of the provisioned multiple communication links being at least equal to a respective latency threshold, interference threshold, or traffic load threshold; and
the processing system is further configured to switch communications between the first STA and the AP MLD from the provisioned multiple communication links of the AP MLD to a single communication link of the AP MLD based on the indication.

15. The apparatus of claim 14, wherein the single communication link of the AP MLD is different from the provisioned multiple communication links of the AP MLD.

16. The apparatus of claim 14, wherein switching the communications includes re-mapping the one or more TIDs from the provisioned multiple communication links of the AP MLD to the single communication link of the AP MLD.

17. The apparatus of claim 16, wherein:
the processing system is further configured to generate a second frame including a TID-to-Link Mapping (T2LM) element indicating the re-mapping of the one or more TIDs from the provisioned multiple communication links of the AP MLD to the single communication link of the AP MLD; and
the interface is further configured to output the second frame for transmission to the first STA on at least one of the provisioned multiple communication links.

18. The apparatus of claim 1, wherein the processing system is further configured to:
reserve one communication link of the first communication link or the one or more second communication links of the AP MILD for latency-sensitive traffic; and
maintain the latency, the level of interference, and the traffic load associated with the reserved communication link below a respective latency threshold, interference threshold, and a traffic load threshold.

19. The apparatus of claim 18, wherein:
the interface is further configured to obtain an indication of at least one of the latency, the level of interference, or the traffic load associated with the reserved communication link being at least equal to the respective latency threshold, interference threshold, or traffic load threshold; and
the processing system is further configured to switch communications between the AP MLD and one or more other STAs from the reserved communication link to one or more other communication links of the AP MLD based on the indication.

20. The apparatus of claim 1, wherein the interface is further configured to:
obtain one or more service level agreement (SLA) parameters associated with the first STA, wherein the provision of either the single communication link or the multiple communication links of the AP MLD to the first STA is further based on the one or more SLA parameters associated with the first STA.

21. The apparatus of claim 1, further comprising a transceiver configured to receive the request and transmit the first frame, wherein the apparatus is configured as the AP MLD.

22-41. (canceled)

42. An apparatus for wireless communications, comprising:
a processing system configured to:
assign each of a plurality of stations (STAs) to one of multiple communication links associated with an access point (AP) multi-link device (MLD) based at least in part on an amount of traffic on the multiple communication links;
map one or more Traffic Identifiers (TIDs) of traffic flows associated with each of the plurality of STAs to the communication link assigned to the respective STA; and
generate, for each STA of the plurality of STAs, a first frame indicating the assigned communication link and the mapping for the respective STA; and
an interface configured to output the first frames for transmission to the plurality of STAs on one or more of the multiple communication links.

43-82. (canceled)
